(19) United States
(12) Patent Application Publication
(10) Pub. No.: US 2025/0000321 A1
(43) Pub. Date: Jan. 2, 2025

(54) CLEANING DEVICE AND CONTROL METHOD

(71) Applicant: TINECO INTELLIGENT TECHNOLOGY CO., LTD., Suzhou City, Jiangsu (CN)

(72) Inventors: Jian HUANG, Suzhou City (CN); Weidong LIU, Suzhou City (CN); Zhikang LIU, Suzhou City (CN); Xiaoyong WANG, Suzhou City (CN); Tao XU, Suzhou City (CN); Zhen CHEN, Suzhou City (CN); Rendi WU, Suzhou City (CN); Dehua ZHOU, Suzhou City (CN); Chunfeng ZHOU, Suzhou City (CN); Yin TANG, Suzhou City (CN); Hongbin JIANG, Suzhou City (CN); Yuan WANG, Suzhou City (CN)

(73) Assignee: TINECO INTELLIGENT TECHNOLOGY CO., LTD., Suzhou City, Jiangsu (CN)

(21) Appl. No.: 18/711,068

(22) PCT Filed: Nov. 14, 2022
(86) PCT No.: PCT/CN2022/131743

§ 371 Date: May 16, 2024

(30) Foreign Application Priority Data
Nov. 17, 2021 (CN) 202111364237.4
Nov. 17, 2021 (CN) 202111374759.2
Dec. 22, 2021 (CN) 202111579054.4
Dec. 24, 2021 (CN) 202111600008.8

(51) Int. Cl. A47L 11/40; A47L 11/34; B25J 11/00; G01N 27/04

(52) U.S. Cl. CPC A47L 11/4011; A47L 11/34; A47L 11/4002; A47L 11/4027; A47L 11/4033; B25J 11/0085; G01N 27/048

(57) ABSTRACT

Provided are a cleaning device and a control method, a cleaning device and a detection apparatus. The cleaning device includes a device body, which includes a cleaning module acting on an object to be cleaned (M); a humidity detection mechanism provided in the device body and in contact with the object to be cleaned (M), to detect a humidity of the object to be cleaned (M); and a control module provided in the device body and connected to the humidity detection mechanism to perform control processing according to humidity data detected and obtained by the humidity detection mechanism. The humidity detection for the object to be cleaned (M) is realized.

### CROSS-REFERENCE TO RELATED APPLICATIONS

The present disclosure claims the priorities of Chinese Patent Application No. 202111374759.2, filed on Nov. 17, 2021, entitled “Cleaning Device and Control Method”, Chinese Patent Application No. 202111364237.4, filed on Nov. 17, 2021, entitled “Cleaning Device and Detection Apparatus”, Chinese Patent Application No. 202111600008.8, filed on Dec. 24, 2021, entitled “Recycling bin State Detection Method, Processing System and Cleaning Device”, and Chinese Patent Application No. 202111579054.4, filed on Dec. 22, 2021, entitled “Cleaning Machine Drying Method and Apparatus, Cleaning Machine and Storage Medium”, which are hereby incorporated by reference in their entireties.

### FIELD

The present disclosure relates to the field of cleaning, and in particular to a cleaning device and a control method.

### BACKGROUND

Cleaning device is a device that can provide cleaning functions for object to be cleaned, which is widely used in daily life, such as cleaning machines for cleaning floors, carpet cleaning machines for cleaning carpets, etc. Taking a carpet cleaning machine as an example, during the cleaning operation, the device will continuously spray water onto the carpet for cleaning, and then dry the carpet. During the above-mentioned drying process, users usually cannot know whether the carpet has been dried. They need to manually touch the carpet to sense it, which results in a poor experience.

### SUMMARY

The embodiment of the present disclosure provides a cleaning device and a control method, which realizes the humidity detection for an object to be cleaned.

The embodiment of the present disclosure provides a cleaning device, including: a device body, comprising a cleaning module acting on an object to be cleaned;
a humidity detection mechanism, provided in the device body and in contact with the object to be cleaned, to detect a humidity of the object to be cleaned;
a control module, provided in the device body and connected to the humidity detection mechanism, to perform corresponding control processing according to humidity data detected and obtained by the humidity detection mechanism.

The embodiment of the present disclosure provides a control method, applied to cleaning device, where the cleaning device comprises a device body, comprising a cleaning module acting on an object to be cleaned, a humidity detection mechanism provided in the device body and in contact with the object to be cleaned, and a control module provided in the device body and connected to the humidity detection mechanism;
the method comprises:
   using the humidity detection mechanism to detect a humidity of the object to be cleaned; and
   performing corresponding control processing according to humidity data detected and obtained by the humidity detection mechanism.

In the embodiment of the present disclosure, the device body of the cleaning device is provided with a cleaning module and a control module, as well as a humidity detection mechanism in contact with the object to be cleaned. The humidity detection mechanism can detect the humidity of the object to be cleaned, the control module can also perform corresponding control processing according to the humidity data detected and obtained by the humidity detection module, thereby realizing the detection of the humidity of the object to be cleaned, without the need for the user to manually touch the object to be cleaned for perception, which improves the user experience.

The embodiment of the present disclosure also provides a cleaning device, comprising: a body (10);
an air duct, provided in the body (10) and comprising an air duct suction port and an air duct discharge port;
a detection apparatus, comprising a housing (11) and a detection component (12) located in a housing inner cavity (110); wherein the housing (11) has an air outlet (1110) and an air inlet (1120) facing a surface to be worked; and the air outlet (1110) of the housing (11) is communicated with the air duct;
the air duct is configured as forming a negative pressure in the housing inner cavity (110), so that the air inlet (1120) of the housing (11) sucks an airflow in an area of the surface to be worked;
the detection component (12) is configured as detecting a parameter of the airflow in the housing inner cavity (110).

The embodiment of the present disclosure also provides a detection apparatus, comprising a housing (11) and a detection component (12) located in an housing inner cavity (110); the housing (11) has an air outlet (1110) and an air inlet (1120); the air outlet (1110) of the housing (11) is configured as communicating with an air duct in the body; the air inlet (1120) is configured as facing the surface to be worked; and the detection component (12) is configured as detecting a parameter of an airflow in the housing inner cavity (110).

In the embodiment of the present disclosure, the body is provided with an air duct, including an air duct suction port and an air duct discharge port; the detection apparatus includes a housing and a detection component located in the housing inner cavity, the housing has an air outlet and an air inlet facing the surface to be worked, and the air outlet of the housing and the air duct on the body are communicated. The air duct is configured as forming a negative pressure in the housing inner cavity, so that the air inlet of the housing sucks the airflow in the area of the surface to be worked. The detection component is configured as detecting a parameter of the airflow in the housing inner cavity. The detection component detects the parameter of the airflow in the inner cavity of the housing in real time. The user can judge the dryness degree of the surface to be worked based on the parameter. There is no need to repeatedly bend over and use limbs to judge the dryness degree of the carpet, which greatly improves the user experience and comfort.

The embodiment of the present disclosure also provides a cleaning machine drying method, which is applied to the cleaning machine. The cleaning machine includes a main body, a motor, a humidity sensor, a heating element, an air suction port, and a blowing port. The humidity sensor is used to detect the humidity of the surface to be cleaned, the method includes:
when the cleaning machine is in a drying mode, detecting whether the cleaning machine is in a motion state;
if the cleaning machine is in the motion state, obtaining the humidity detected and obtained by the humidity sensor; and
adjusting a power of the heating element and a power of the motor according to the humidity.

The embodiment of the present disclosure also provides a cleaning machine drying apparatus, which is applied to the cleaning machine. The cleaning machine includes a main body, a motor, a humidity sensor, a heating element, an air suction port, and a blowing port. The humidity sensor is used to detect the humidity of the surface to be cleaned, the apparatus includes:
a state detection module, configured to detect whether the cleaning machine is in a motion state, when the cleaning machine is in a drying mode;
a humidity obtaining module, configured to obtain the humidity detected and obtained by the humidity sensor if the cleaning machine is in the motion state; and
a power adjusting module, configured to adjust a power of the heating element and a power of the motor according to the humidity.

The embodiment of the present disclosure also provides a cleaning machine, including a processor, a communication interface, a memory, and a communication bus, where the processor, the communication interface, and the memory complete communication with each other through the communication bus;
the memory, used to store computer programs;
the processor, used to implement each step in the cleaning machine drying method provided by the embodiment of the present disclosure when executing the program stored in the memory.

The embodiment of the present disclosure also provides a storage medium on which a computer program is stored. When the program is executed by a processor, the cleaning machine drying method provided by the embodiment of the present disclosure is implemented.

The technical solution provided by the embodiment of the present disclosure is applied to a cleaning machine. The cleaning machine includes a main body, a motor, a humidity sensor, a heating element, an air suction port, and a blowing port. The humidity sensor is used to detect the humidity of the surface to be cleaned, when the cleaning machine is in a drying mode, detect whether the cleaning machine is in a motion state, if the cleaning machine is in the motion state, obtain the humidity detected and obtained by the humidity sensor, and adjust the power of the heating element and the power of the motor according to the humidity. By the humidity detected and obtained by the humidity sensor, adjusting the power of the heating element and the power of the motor in the cleaning machine, the drying temperature can be adjusted according to the actual working conditions, the drying efficiency is improved, damage to the object to be dried is avoided, and thus have a better universality.

The embodiment of the present disclosure also provides a method for detecting the state of a recycling bin, which is applied to cleaning device. The cleaning device at least includes a recycling bin, a cleaning component, a Hall sensor and a motor. The recycling bin communicates with the cleaning component. The recycling bin includes an air outlet and an air duct. The air outlet of the recycling bin communicates with an air inlet end of the motor via the air duct. A negative pressure sensor is installed in the air duct or at the air inlet end of the motor. The methods include:
during the operation of the motor, obtaining the Hall signal output by the Hall sensor and obtaining the negative pressure signal collected by the negative pressure sensor;
monitoring whether a first state occurs according to the change information of the Hall signal and the negative pressure signal, where the first state refers to a state in which the negative pressure signal meets the first condition and the Hall signal is a second level value; and
when the first state occurs, determining that the recycling bin is in a full state.

The embodiment of the present disclosure also provides a processing system, including:
an obtaining module, configured to obtain the Hall signal output by the Hall sensor during the operation of the motor, and obtain the negative pressure signal collected by the negative pressure sensor; and
a processing module, configured to monitor whether a first state occurs according to the change information of the Hall signal and the change information of the negative pressure signal, where the first state refers to a state in which the negative pressure signal meets the first condition and the Hall signal is a second level value; determines that the recycling bin is in a full state, when the first state occurs.

The embodiment of the present disclosure also provides a cleaning device. The cleaning device at least includes a recycling bin, a cleaning component, a Hall sensor and a motor. The recycling bin communicates with the cleaning component. The recycling bin includes an air outlet and an air duct. The air outlet of the recycling bin communicates with the air inlet end of the motor via the air duct, and a negative pressure sensor is installed in the air duct or at the air inlet end of the motor; the cleaning device also includes: a memory and a processor;
the memory is used to store computer programs; and
the processor is coupled to the memory and is used to execute the computer program to execute the recycling bin state detection method provided by the embodiment of the present disclosure.

In the embodiment of the present disclosure, a Hall sensor and a negative pressure sensor are added to the cleaning device, and the change information of the Hall signal output by the Hall sensor and the change information of the negative pressure signal collected by the negative pressure sensor are combined to identify the recycling bin being in water full state. As a result, the state of the recycling bin can be identified automatically, promptly, and accurately.

### BRIEF DESCRIPTION OF THE DRAWINGS

The drawings described herein are used to provide a further understanding of the present application and constitute a part of the present application. The example embodiments of the present application and the descriptions thereof are used to explain the present application, and do not constitute an improper limitation on the present application. In the drawings:

FIG. 1a shows a schematic structural diagram of an embodiment of a cleaning device provided by the present disclosure;

FIG. 1b shows a schematic structural diagram of an embodiment of a front view of a cleaning device provided by the present disclosure;

FIG. 1c shows a schematic structural diagram of an embodiment of a right-side view of a cleaning device provided by the present disclosure;

FIG. 1d shows a schematic structural diagram of an embodiment of a rear view of a cleaning device provided by the present disclosure;

FIG. 1e shows a schematic structural diagram of an embodiment of the left-side view of a cleaning device provided by the present disclosure;

FIG. if shows a schematic structural diagram of an embodiment of a top view of a cleaning device provided by the present disclosure;

FIG. 1g shows a schematic structural diagram of an embodiment of a bottom view of a cleaning device provided by the present disclosure;

FIG. 1h shows a schematic structural diagram of an embodiment of a perspective view of a cleaning device provided by the present disclosure;

FIG. 1i shows a schematic structural diagram of another embodiment of a cleaning device provided by the present disclosure;

FIG. 1j shows a schematic structural diagram of yet another embodiment of a cleaning device provided by the present disclosure;

FIG. 1k shows a schematic structural diagram of yet another embodiment of a cleaning device provided by the present disclosure;

FIG. 1l shows a schematic structural diagram of an embodiment of a humidity detection mechanism provided by the present disclosure;

FIG. 1m shows a schematic structural diagram of another embodiment of a humidity detection mechanism provided by the present disclosure;

FIG. 1n shows a schematic structural diagram of an embodiment of a temperature and humidity sensor provided by the present disclosure;

FIG. 1o shows a graph of an embodiment of a temperature change trend and a humidity change trend provided by the present disclosure;

FIG. 1p shows a schematic structural diagram of yet another embodiment of a humidity detection mechanism provided by the present disclosure;

FIG. 1q shows a schematic structural diagram of an embodiment of a recycling apparatus provided by the present disclosure;

FIG. 1r shows a schematic structural diagram of yet another embodiment of a cleaning device provided by the present disclosure;

FIG. 1s shows a schematic structural diagram of an embodiment of a pressure sensor provided by the present disclosure;

FIG. 1t shows a flowchart of an embodiment of a control method provided by the present disclosure;

FIG. 2a is a schematic cross-sectional structural diagram from one perspective of an embodiment of a cleaning device of the present disclosure;

FIG. 2b is a partial enlarged view of A1 in FIG. 2a;

FIG. 2c is a schematic cross-sectional structural diagram from another perspective of an embodiment of a cleaning device of the present disclosure;

FIG. 2d is a partial enlarged view of B1 in FIG. 2c;

FIG. 2e is a partial structural schematic diagram of a cleaning device after a lower housing of FIG. 2d moves into a body under an action of external force;

FIG. 2f is a partial structural schematic diagram of a cleaning device after an entire housing in FIG. 2d moves into a body under an action of external force;

FIG. 2g is a schematic structural diagram of a lower housing of the present disclosure from a first perspective;

FIG. 2h is a schematic structural diagram of a lower housing of the present disclosure from a second perspective;

FIG. 2i is a schematic cross-sectional structural diagram of a second embodiment of a detection apparatus of the present disclosure;

FIG. 2j is a schematic cross-sectional structural diagram of a third embodiment of a detection apparatus of the present disclosure;

FIG. 2k is a schematic three-dimensional structural diagram of a fourth embodiment of a detection apparatus of the present disclosure;

FIG. 2l is a bottom view of FIG. 2k;

FIG. 2m is a schematic structural diagram of a display;

FIG. 2n is a schematic structural diagram of a lower housing of the present disclosure from a second perspective;

FIG. 2o is a schematic diagram of a fitting curve of a corresponding relationship between a motion state of a cleaning device of the present disclosure and a temperature and humidity of a carpet;

FIG. 2p is a characteristic curve diagram of a cross-sectional area of an air duct of a cleaning device;

FIG. 3a is an integrated schematic diagram of a module in a cleaning machine shown in the embodiment of the present disclosure;

FIG. 3b is a schematic flowchart of an implementation of a cleaning machine drying method shown in the embodiment of the present disclosure;

FIG. 3c is a schematic flowchart of an implementation of another cleaning machine drying method shown in the embodiment of the present disclosure;

FIG. 3d is a schematic flowchart of an implementation of another cleaning machine drying method shown in the embodiment of the present disclosure;

FIG. 3e is a schematic structural diagram of a cleaning machine drying apparatus shown in the embodiment of the present disclosure;

FIG. 3f is a schematic structural diagram of a cleaning machine shown in an embodiment of the present disclosure;

FIG. 4a is a schematic structural diagram of a cleaning device provided by an exemplary embodiment of the present disclosure;

FIG. 4b is a partial structural schematic diagram of a cleaning device provided by an exemplary embodiment of the present disclosure;

FIG. 4c is a partial cross-sectional view of a cleaning device provided by an exemplary embodiment of the present disclosure;

FIG. 4d is a schematic flowchart of a recycling bin state detection method provided by an exemplary embodiment of the present disclosure;

FIG. 4e is a schematic flowchart of another recycling bin state detection method provided by an exemplary embodiment of the present disclosure;

FIG. 4f is a schematic structural diagram of a processing system provided by an exemplary embodiment of the present disclosure; and

FIG. 4g is a schematic structural diagram of a cleaning device provided by another exemplary embodiment of the present disclosure.

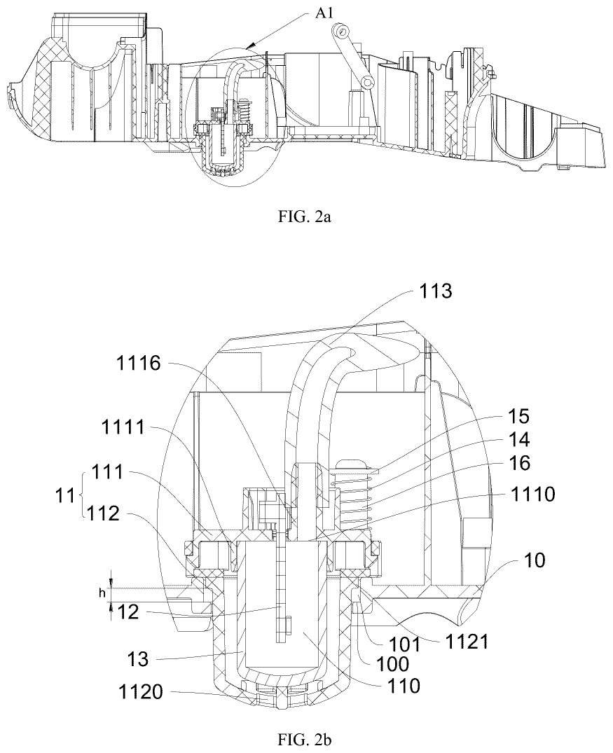

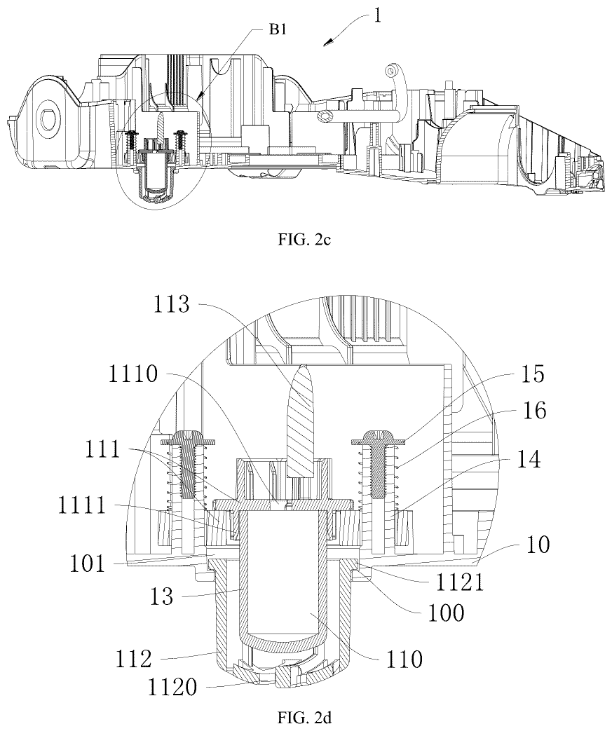

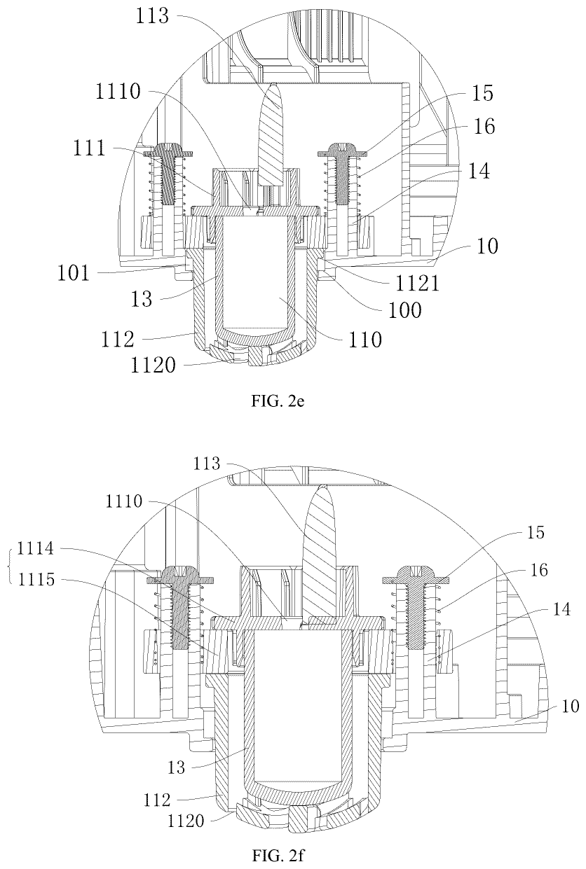

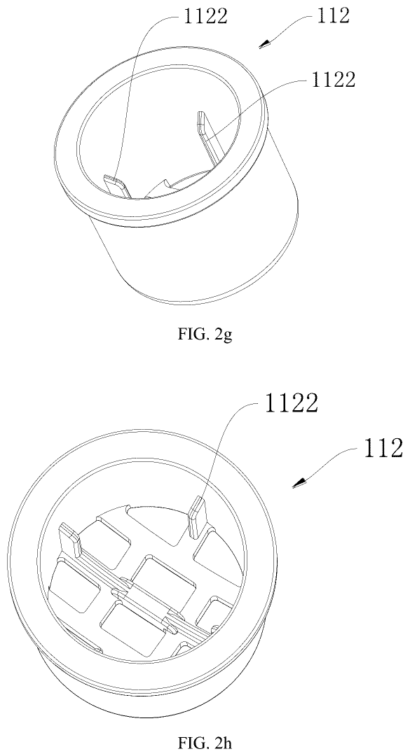

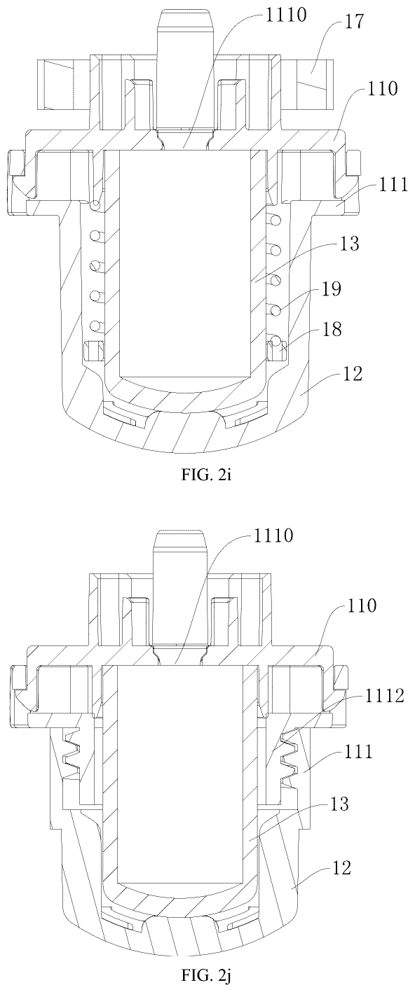

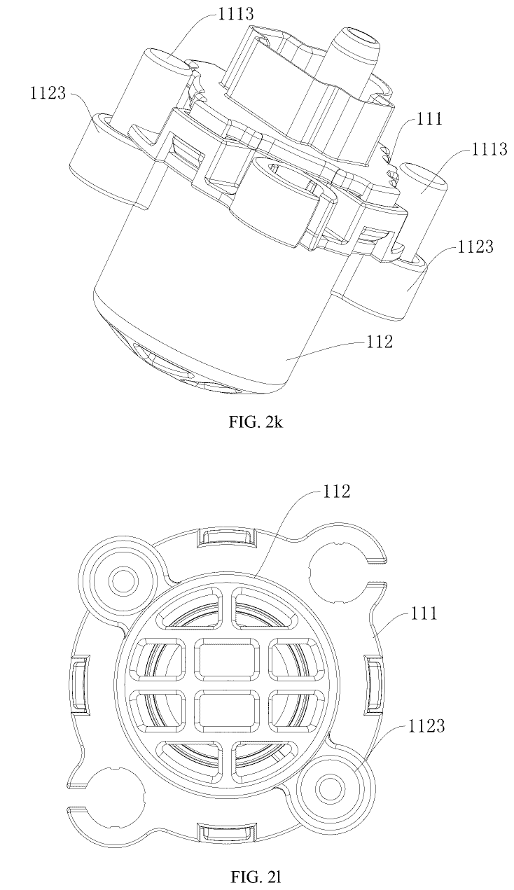

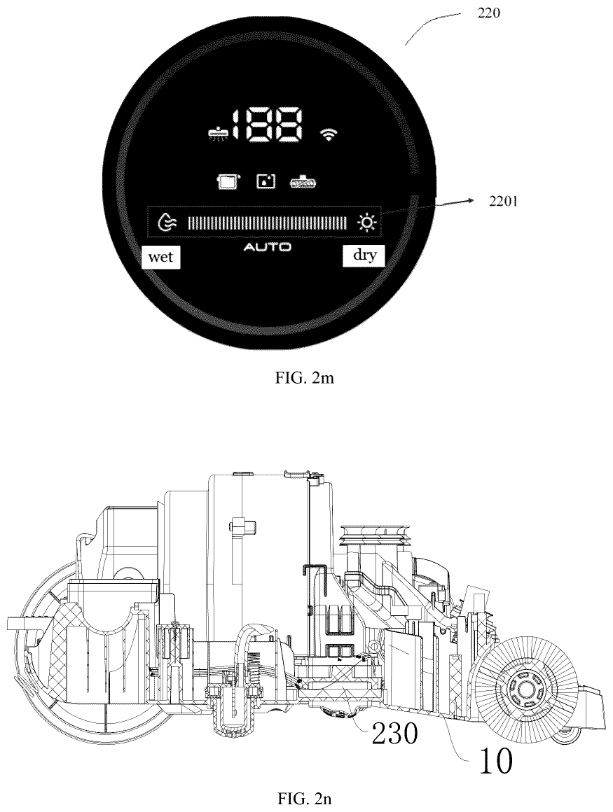

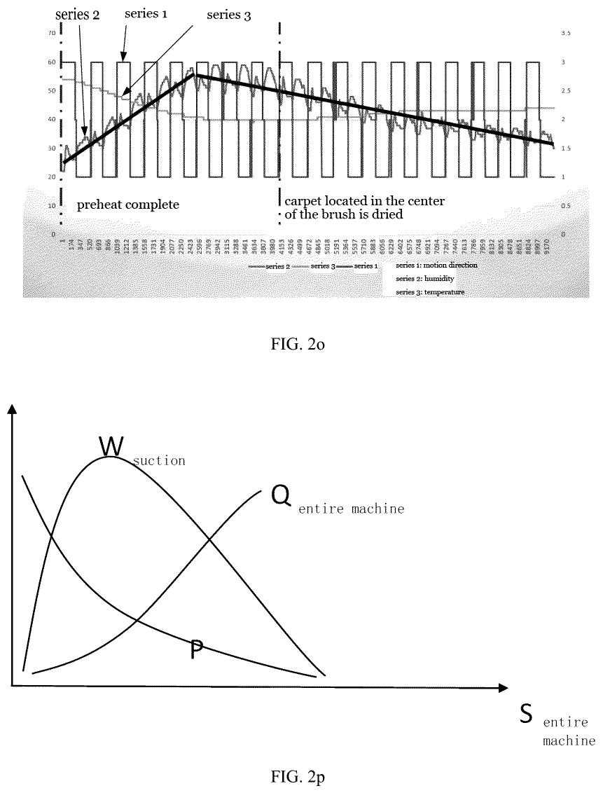

Specifically, a one-to-one correspondence between the names and reference signs of each component in FIGS. 2a to 2n is as follows:

1 cleaning device: 10 body, 100 step groove, 101 through hole, 11 housing, 110 housing inner cavity, 111 upper housing, 1110 air outlet, 1111 first connecting sleeve, 1112 second connecting sleeve, 1113 positioning rod, 1114 first upper housing, 1115 second upper housing, 1116 pipe joint, 112 lower housing, 113 hose, 1120 air inlet, 1121 flange, 1122 scraper strip, 1123 lower ear plate, 12 detection component, 13 filter cover, 14 guiding rod, 15 stopper, 16 first elastic apparatus, 17 electromagnet, 18 iron ring, 19 second elastic apparatus; 220 display; 2201 humidity progress bar; 230 heating apparatus.

### DETAILED DESCRIPTION OF EXAMPLE EMBODIMENTS

For making the purposes, technical solutions and advantages of the embodiments of the present disclosure clearer, the technical solutions in the embodiments of the present disclosure will be clearly and completely described below in combination with the drawings in the embodiments of the present disclosure. It is apparent that the described embodiments are not all embodiments but part of embodiments of the present disclosure. All other embodiments obtained by those of ordinary skill in the art on the basis of the embodiments in the present disclosure without creative work shall fall within the scope of protection of the present disclosure.

In some of the processes described in the description, claims, and the above drawings of the present application, a plurality of operations occurring in a particular order are included, which may be performed out of the order herein or be performed in parallel. The sequence numbers of the operations, such as 101, 102, etc., are merely used to distinguish between the various operations, and the sequence numbers themselves do not represent any order of execution. In addition, the processes may include more or fewer operations, and the operations may be performed sequentially or in parallel. It should be noted that the expressions herein of “first”, “second”, etc. are intended to distinguish between different messages, devices, modules, etc., and are not intended to represent a sequential order, nor is it intended to limit that “first” and “second” are of different types.

The technical solution of the present disclosure is suitable for the field of cleaning, especially for the field of household cleaning. Taking the use of a carpet cleaning machine to clean the carpet as an example, the cleaning machine sprays clean water onto the carpet to wet the carpet for cleaning, and then dries the carpet. During this process the user cannot know the humidity or dryness of the carpet, and thus cannot judge whether the carpet has been dried. It is usually necessary to manually touch the carpet to roughly estimate the humidity of the carpet, which is not accurate and the user experience is poor.

In order to solve the above technical problems, after a series of thinking and experiments, the inventor proposed the technical solution of the present disclosure, which provides a cleaning device, including a device body, including a cleaning module acting on an object to be cleaned; a humidity detection mechanism, provided in the device body and in contact with the object to be cleaned, to detect a humidity of the object to be cleaned; a control module, provided in the device body and connected to the humidity detection mechanism, to perform corresponding control processing according to humidity data detected and obtained by the humidity detection mechanism.

In the cleaning device provided by the present disclosure, the device body is provided with a cleaning module and a control module, as well as a humidity detection mechanism in contact with the object to be cleaned. The humidity detection mechanism can detect the humidity of the object to be cleaned, the control module can perform corresponding control processing according to the humidity data detected and obtained by the humidity detection module, thereby realizing the detection of the humidity of the object to be cleaned, without the user having to manually touch the object to be cleaned for perception, which improves the user experience.

The technical solutions in the embodiments of the present disclosure will be clearly and completely described below with reference to the accompanying drawings in the embodiments of the present disclosure. Obviously, the embodiments described hereafter are merely a part of the embodiments of the present application and not all the embodiments. Based on the embodiments of the present application, all other embodiments obtained by those ordinarily skilled in the art without paying creative work fall within the protection scope of the present application.

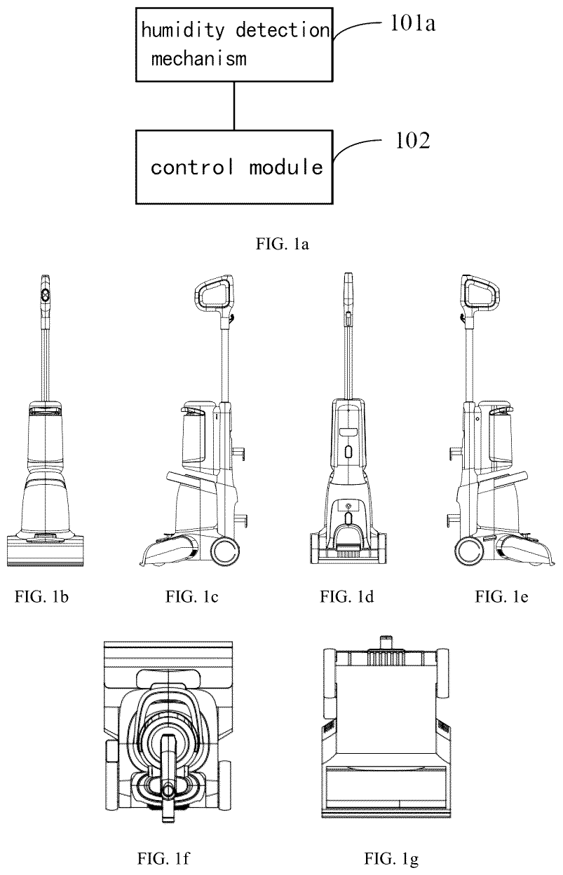

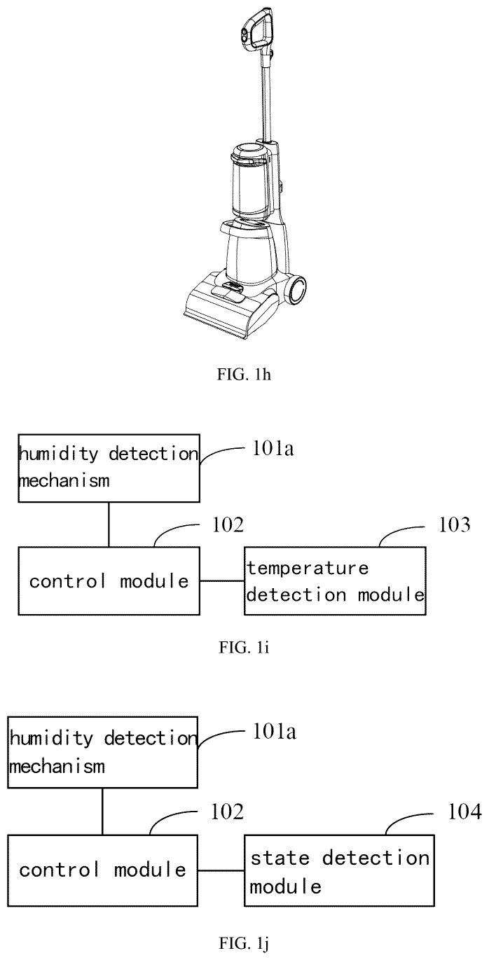

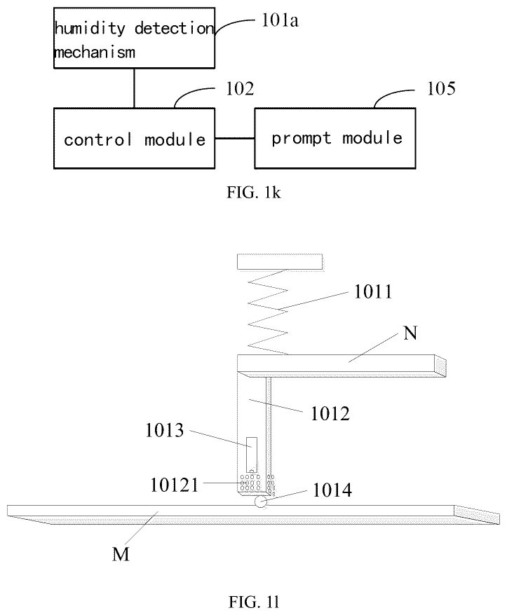

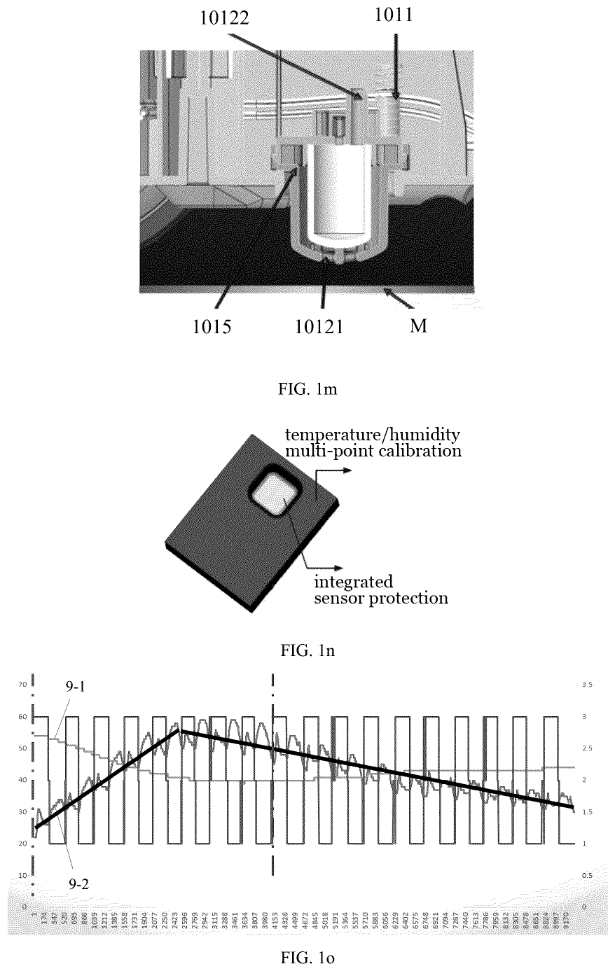

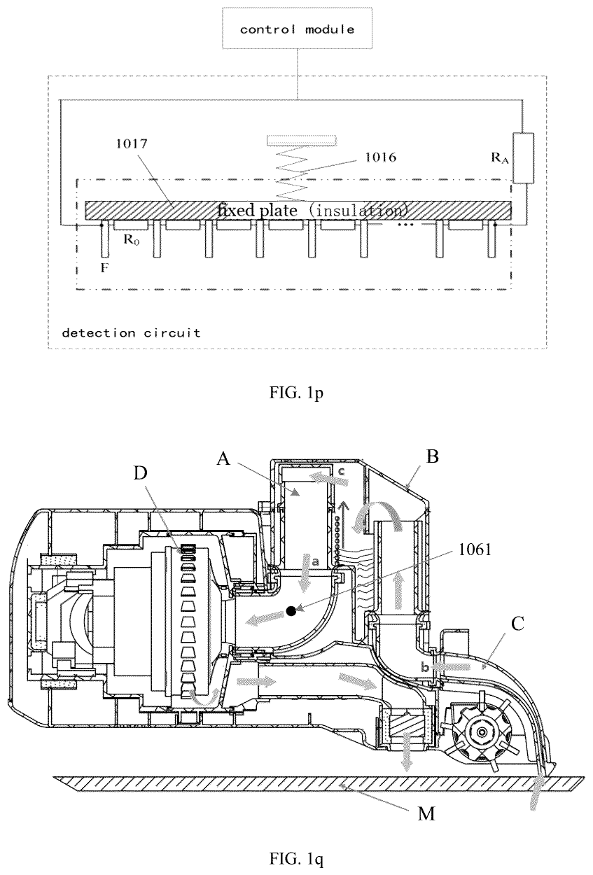

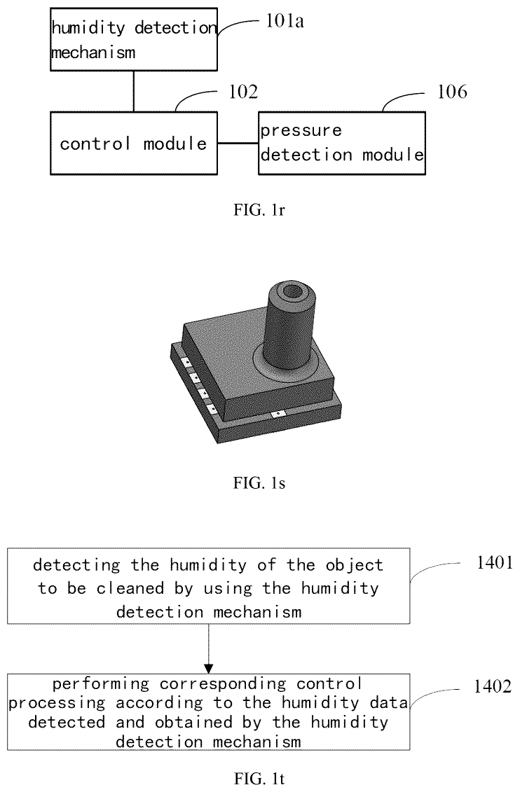

As shown, FIG. 1a is a schematic structural diagram of an embodiment of a cleaning device provided by the present disclosure, including a device body. The device body may include a cleaning module that acts on the object to be cleaned;
a humidity detection mechanism 101a provided in the device body and in contact with the object to be cleaned to detect the humidity of the object to be cleaned; and
a control module 102 provided in the device body and connected to the humidity detection mechanism 101a to perform corresponding control processing according to the humidity data detected and obtained by the humidity detection mechanism.

The cleaning device is a device that provides cleaning functions, such as a cleaning machine for cleaning floors, a vacuum cleaner, a sweeping robot, a carpet cleaning machine for cleaning the carpets, etc. Taking a carpet cleaning machine as an example, when performing a carpet cleaning operation, the device will continuously spray water onto the carpet to wet the carpet for cleaning, and then dry the carpet.

The cleaning device may include a device body, and the device body may include a cleaning module acting on the object to be cleaned. The cleaning module may include a cleaning apparatus in contact with the object to be cleaned, such as a floor brush, a rolling brush, etc., and may also include a fluid supply apparatus responsible for spraying the first liquid to the outside and a recycling apparatus responsible for recycling the second liquid generated from the first liquid, such as a clean water bucket and a recycling bin, etc. The first liquid may be a clean liquid, such as clean water or a liquid mixed with detergent, and the second liquid may be a dirty liquid generated after cleaning, which is not specifically limited in the present disclosure.

The cleaning device may also include a motion module that moves along the surface of the object to be cleaned. The motion module can include a walking mechanism, such as a wheel, a crawler, etc., and can also include a walking driving mechanism, such as a motor, etc. The cleaning device can automatically walk along the surface of the object to be cleaned under the driving of the driving mechanism. In addition, the cleaning device can also include an interactive module, such as a handle, through which the user can push the cleaning device to move. For ease of understanding, FIGS. 1b to 1h show various views of a cleaning device in practical application (specifically, FIG. 1b is the front view, FIG. 1c is the right-side view, FIG. 1d is the rear view, FIG. 1e is the left-side view, FIG. if is the top view, FIG. 1g is the bottom view, and FIG. 1h is the perspective view). It should be noted that FIG. 1b to FIG. 1h are only examples of the structural shape of the cleaning device, and the present disclosure is not limited thereto.

In this embodiment, as shown in FIG. 1a, the device body is also provided with a humidity detection mechanism 101a in contact with the object to be cleaned and a control module 102 connected to the humidity detection mechanism 101a. The humidity detection mechanism 101a can detect the humidity of the object to be cleaned, and send the detected humidity data to the control module 102, so that the control module 102 can perform corresponding control processing. In practical applications, the humidity detection mechanism can be implemented as a sensor component, a detection circuit, and other apparatuses. The specific implementation will be described in subsequent embodiments and will not be described in detail here. The control module can be implemented as a microcontroller unit (MCU), microprocessor, microcontroller, etc.

Specifically, the humidity data detected and obtained by the humidity detection mechanism can be data representing the humidity of the object to be cleaned, and can be implemented as a numerical value or a percentage.

Optionally, the control module performing corresponding control processing according to the humidity data detected and obtained by the humidity detection mechanism includes: outputting the humidity data. There are many implementation methods for outputting the humidity data, such as text, sound, etc. The specific implementation will be described in subsequent embodiments and will not be described again here.

Optionally, the control module performing corresponding control processing may also include: controlling the fluid supply apparatus in the cleaning module to stop running if the humidity data reaches the preset humidity data. The preset humidity data can be implemented as a numerical value or percentage. Taking a carpet cleaning machine as an example, the preset humidity data of the carpet to be cleaned can be 80%. When the preset humidity data is reached, the carpet is considered to be wetted to the required extent, and there is no need to continue spraying water for wetting, so that the fluid supply apparatus in the cleaning module can be controlled to stop running.

In actual applications, the control module performing corresponding control processing may also include various implementation methods, which will be explained in subsequent embodiments and will not be described in detail here.

In the embodiment of the present disclosure, the device body of the cleaning device is provided with a cleaning module and a control module, as well as a humidity detection mechanism in contact with the object to be cleaned. The humidity detection mechanism can detect the humidity of the object to be cleaned, and the control module can perform corresponding control processing according to the humidity data detected and obtained by the humidity detection module, thereby realizing the detection of the humidity of the object to be cleaned, without the need for the user to manually touch the object to be cleaned for perception, which improves the detection accuracy and enhances the user experience.

Taking a carpet cleaning machine as an example, the cleaning machine sprays clean water onto the carpet to wet the carpet and cleans it, and then dries the carpet. Therefore, in some embodiments, the device body may also be provided with a drying module, which can emit hot air to dry the object to be cleaned. The contact surface corresponding to the object to be cleaned in the device body may be provided with an air outlet corresponding to the drying module. Hot air is output via the air outlet to dry the object to be cleaned. In practical applications, the drying module can be implemented as a PTC (Positive Temperature Coefficient) heater, etc. The present disclosure does not specifically limit this.

At this time, according to the humidity data detected and obtained by the humidity detection mechanism, the dryness degree of the object to be cleaned during the drying process can also be obtained. The control module performing corresponding control processing may include determining the dryness degree of the object to be cleaned. For example, a corresponding relationship between the humidity data and the dryness degree can be set in advance to determine the dryness degree corresponding to the detected humidity data. The specific implementation of determining the dryness degree according to humidity data will be described in subsequent embodiments, and will not be described again here.

Optionally, the control module performing corresponding control processing may also include: controlling the drying module to stop running when the drying degree reaches a preset drying degree. The preset drying degree can be set according to the actual application scenario, such as 80%, 90%, etc.

In order to obtain better drying effect, the drying module can be set to dry at a constant temperature. Taking a carpet cleaning machine as an example, the constant temperature can be set to 70° C., 80° C., etc. As shown, FIG. 1i is a schematic structural diagram of another embodiment of a cleaning device provided by the present disclosure. Compared with the structure in FIG. 1a, it also includes a temperature detection module 103 arranged in the device body at a position between the drying module and the air outlet and connected to the control module 102. The temperature detection module 103 can detect the drying temperature at the air outlet, and sends the detected drying temperature to the control module 102.

The control module can also control to increase the working voltage of the drying module when the drying temperature does not reach the preset temperature, control to maintain the working voltage of the drying module when the drying temperature reaches the preset temperature, and control to decrease the working voltage of the drying module when the drying temperature exceeds the preset temperature. Optionally, a power supply module can also be provided in the device body to provide the working voltage of the drying module. At this time, the control module can specifically control the working voltage of the drying module to increase, decrease, or remain unchanged through the power supply module.

In this embodiment, the temperature detection module provided in the device body can detect the drying temperature of the drying module. Based on the detection result of the drying temperature, the drying temperature of the drying module can be controlled to be constant to improve the drying effect.

During the above-mentioned drying process, the cleaning device can continuously move along the surface of the object to be cleaned, such as moving forward or backward, drying different positions of the object to be cleaned, or it can also stay stationary at a certain position for drying. When the motion state of the cleaning device is different, the drying effect on the object to be cleaned is also different. For example, when the cleaning device advances along the surface of the object to be cleaned, the drying module can emit hot air at a higher rate than when it retreats. Then, when the object to be cleaned is in the forward state, it dries faster, which may affect the judgment of the dryness degree of the object to be cleaned. Therefore, in some embodiments, the motion state of the cleaning device will be judged. As shown, FIG. 1j is a schematic structural diagram of another embodiment of a cleaning device provided by the present disclosure. Compared with the structure in FIG. 1a, it also includes a state detection module 104 arranged in the device body and connected to the control module 102. The state detection module 104 can detect the motion state of the device, and the control module 102 can perform corresponding control processing when the device body is in the same motion state in a preset time according to the humidity data detected and obtained by the humidity detection mechanism.

In this embodiment, the motion state of the device body may include a forward state, a backward state, and a stationary state. Specifically, the cleaning device may include a walking mechanism, and the walking mechanism can drive the device body forward, backward or stationary. The state detection module can be arranged in the device body at a corresponding position of the walking mechanism to detect the motion state of the walking mechanism to detect the motion state of the device body.

Specifically, in the walking mechanism, a trigger component may be provided at a contact position corresponding to the state detection module. Specifically, the state detection module may detect the motion state of the device body according to the trigger information of contact with the trigger component.

The state detection module may include a magnetic field sensor, and the trigger component may be implemented as a magnet. The magnetic field sensor can detect magnetic field strength information generated by magnet induction, thereby detecting whether the cleaning device is in motion state. Optionally, the state detection module can be implemented as a Hall sensor, such as a dual-channel Hall sensor. Correspondingly, the trigger component can be implemented as a plurality of magnets, and the plurality of magnets can be arranged around the contact position corresponding to the state detection module in the walking mechanism. Specifically, the polarity of two adjacent magnets can be opposite, and the distance therebetween is fixed.

When the magnet is close to or away from the Hall sensor, the Hall sensor can output different level signals. For example, when the magnet is close to the Hall sensor, it outputs a high-level signal, and when the magnet is away from the Hall sensor, it outputs a low-level signal. Therefore, as the walking mechanism moves, multiple magnets approach and move away from the Hall sensor in sequence, and the Hall sensor can output a square wave pulse signal.

According to the output signal of the Hall sensor, the motion state of the device body can be detected. When the Hall sensor does not output a square wave pulse signal within a certain preset time, it can be judged that the device body is in a stationary state. When the Hall sensor outputs a square wave pulse signal within a certain preset time, it can be judged that the device body is in a motion state, and it can be judged whether the device body has changed in motion according to the level or changing trend of the pulse signal. The detection of device motion state can be realized.

When detecting the device body is in the same motion state within a preset time, it can perform corresponding control processing according to the humidity data detected and obtained by the humidity detection mechanism, such as outputting humidity data, obtaining the dryness degree of the object to be cleaned during the drying process, etc. The specific implementation process has been described in the above embodiments and will not be described again here.

Further, when detecting of the device body is in different motion states within a certain preset time, that is, when the motion state changes, such as changing from the forward state to the backward state, based on the humidity data detected and obtained by the humidity detection mechanism, the humidity data will be output and the dryness degree of the object to be cleaned during the drying process will be obtained again, etc.

Optionally, if the device body is in a stationary state within a certain preset time, in order to prevent the device from drying at a certain position for a long time, a preset drying time when the device is in a stationary state can be set. At this time, the control module can also control the drying module to stop running when the drying time reaches the preset drying time when the device is in a stationary state.

As shown, FIG. 1k is a schematic structural diagram of another embodiment of a cleaning device provided by the present disclosure. Compared with the structure in FIG. 1a, it also includes a prompt module 105 provided in the device body and connected to the control module 102.

The control module 102 performing corresponding control processing may include using the prompt module 105 to output corresponding prompt information.

Optionally, the prompt module may include at least one of a display module, a lighting module and/or an audio module. Specifically, the display module can be arranged on the surface of the device body, and can be implemented as a display screen, etc., to facilitate user observation. The display module can use numbers or percentages to display the humidity or dryness degree of the object to be cleaned, such as different humidity levels such as 40%, 50%, 60%, etc. It can also use text to display different dryness degrees such as wet, tending to wet, tending to dry, dry, etc.

To the extent, pattern display can also be used, such as using raindrop patterns to indicate moisture, and the more raindrops, the wetter, and using sun patterns to indicate dryness, etc. There are also other display methods that can be set according to actual application scenarios.

The lighting module can also be set on the surface of the device body, and can be implemented as an LED light panel, etc., to facilitate user observation. Specifically, the lighting module can use lights of different colors to indicate the humidity or dryness degree of the object to be cleaned. For example, green light indicates moisture, red light indicates dryness, etc. It can also use the flashing frequency of the light to display. For example, the higher the flashing frequency, the drier it is. etc., there are also other display methods, which can be set according to the actual application scenario.

The audio module can be set inside the device body and can be implemented as a speaker, etc. The audio module can use voice broadcast to prompt the humidity or dryness degree of the object to be cleaned, such as the current dryness is tending to wet, the current dryness is tending to dry, etc. It can also use sound frequency to prompt, for example, a beep sound can be set, and the higher frequency, the more humid it is, etc., which can be set according to the actual application scenario.

In actual applications, in addition to the above implementation methods, the prompt module can also have other implementation methods, and the present disclosure does not impose specific restrictions on this. Moreover, the above implementation methods can be combined and set up, such as setting up the display module and the audio module at the same time for prompts, etc. There can also be other display methods, which can be set according to the actual application scenario.

The specific implementation of the humidity testing mechanism is described below. FIG. 1l is a schematic structural diagram of an embodiment of a humidity detection mechanism provided by the present disclosure. As shown, the humidity detection mechanism can include:
a first elastic component 1011 with on end fixed in the device body, where the first elastic component 1011 is able to expand and contract according to different surface heights of the object to be cleaned;
a hollow structure 1012 provided in the device body, with a first end connected to the other end of the first elastic component 1011 and a second end in contact with the object to be cleaned M; where the second end of the hollow structure extends out of a contact surface between the device body and the object to be cleaned M and is provided with a first opening 10121; and
a humidity sensor 1013 fixed in the hollow structure 1012 and connected to the control module 102, where the humidity sensor 1013 is used to detect water vapor entering the hollow structure 1012 through the first opening 10121, to obtain the humidity of the object to be cleaned.

Taking a carpet cleaning machine as an example, the carpet to be cleaned can be of various types, such as short-fiber carpets, long-fiber carpets, etc. In order to improve the detection effect for different types of carpets, in this embodiment, the humidity detection mechanism is provided with a first elastic component 1011. One end of the first elastic component 1011 is fixed in the device body (not shown in the device body diagram), and the other end is connected to the hollow structure 1012. Depending on the height of the object to be cleaned M, the first elastic component 1011 can expand and contract accordingly, so that the distance between the hollow structure 1012 and the object to be cleaned M is fixed. The elastic component may include a spring, a corrugated pipe, etc.

The hollow structure 1012 may include a cavity, and the water vapor enters which through the first opening 10121 at the second end of the hollow structure 1012 and circulates in the cavity. The first opening 10121 can be implemented as an air inlet, such as multiple holes shown in the drawings. The humidity sensor 1013 is fixed inside the cavity and detects water vapor inside the cavity, thereby realizing humidity detection of the object to be cleaned.

In order to increase the water vapor flow inside the cavity and speed up the water vapor flow rate, optionally, the first end of the hollow structure 1012 can be provided with a second opening (not shown in the drawings), and the second opening communicated with the air inlet duct N connected to the wind mechanism. Under the driving of air inlet of the wind mechanism, vapour in the object to be cleaned M is driven to enter an interior of the hollow structure 1012 through the first opening 10121.

Optionally, the humidity detection mechanism may also include a ball 1014 fixed on the second end of the hollow structure 1012 for contacting the object to be cleaned M. The ball can roll along the object to be cleaned to prevent the hollow structure 1012 from directly contacting the object to be cleaned and moving along the surface of the object to be cleaned, causing wear and tear when the cleaning device moves along the surface of the object to be cleaned.

In practical applications, during the humidity detection process of object to be cleaned, the drying module in the device body can dry the object to be cleaned through the air outlet. If the hot air from the drying module enters the hollow structure, it will cause interference to the humidity detection. Therefore, FIG. 1m shows a schematic structural diagram of another embodiment of a humidity detection mechanism. As shown, the first end of the hollow structure 1012 is provided with a second opening 10122. The humidity detection mechanism may also include a sealing component 1015 with one end open and sleeved on the second end of the hollow structure 1012. The sealing component 1015 extends out of the contact surface with the object to be cleaned M in the device body, and the protruding length is greater than the protruding length of the hollow structure 1012. The sealing component 1015 may be implemented as a dust cover or the like.

Optionally, a PE film may be provided at the first opening 10121 to prevent substances other than water vapor from entering the interior of the hollow structure 1012 to avoid affecting the accuracy of detection.

The above-mentioned humidity detection mechanism can detect the humidity of the object to be cleaned and obtain humidity data. Based on the humidity data, the control module can determine the dryness degree of the object to be cleaned. In order to improve the accuracy of drying degree, optionally, the humidity detection mechanism can also be used to detect temperature and obtain temperature data. Specifically, the humidity sensor can be implemented as a temperature and humidity sensor.

Specifically, the temperature and humidity sensor can use a digital interface sensor, high-precision temperature and humidity calibration, and surface coating technology to ensure long-term stability of the sensor. FIG. 1n shows a schematic structural diagram of an embodiment of a temperature and humidity sensor. The temperature and humidity sensor can use I2C communication to send temperature data and humidity data to the control module. The control module can determine the dryness degree of the object to be cleaned based on the temperature data and humidity data. As an optional implementation method, the control module can obtain the temperature change trend and the humidity change trend based on the detected humidity data and temperature data, and determine the dryness degree of the object to be cleaned based on the temperature change trend and the humidity change trend.

Taking a carpet cleaning machine as an example, FIG. 1o shows a schematic diagram of an embodiment of the temperature change trend and the humidity change trend detected and obtained by the humidity detection mechanism during the carpet drying process after the carpet is wetted. The temperature change curve 9-1 represents the temperature change trend, and the humidity change curve 9-2 represents the humidity change trend. Combined with the analysis of the temperature change curve 9-1 and the humidity change curve 9-2, when the temperature drops and the humidity rises, it indicates that the cleaning machine moves from the dry position to the wet carpet position for detection. At this time, the carpet is wet. After that the temperature stabilizes and the humidity drops, it indicates that the cleaning machine begins to dry the carpet. The carpet is still damp, but the degree of moisture becomes smaller. Then the temperature rises and the humidity drops, it indicates that the carpet is gradually drying. From this, combined with the temperature change trend and the humidity change trend, the dryness degree of the object to be cleaned can be determined.

As another optional implementation method for determining the dryness degree of the object to be cleaned, the temperature data detected and obtained by the humidity detection mechanism can be implemented as Celsius temperature, and the humidity data can be implemented as relative humidity. The control module can calculate the absolute humidity of the object to be cleaned based on the Celsius temperature and relative humidity, and determine the dryness degree of the object to be cleaned according to the absolute temperature. Specifically, relative humidity refers to the percentage of water vapor pressure in the air and the saturated water vapor pressure at the same temperature, and absolute humidity refers to the mass of water vapor contained in each cubic meter of moist air, that is, water vapor density.

Specifically, the absolute humidity of the object to be cleaned can be calculated based on the Celsius temperature and relative humidity in accordance with the absolute humidity calculation formula.

The absolute humidity calculation formula can be: ρ_{ω}=e/R_{ω}×T=m/V; where, ρ_{ω} represents the absolute humidity, e represents the vapor pressure, the unit is Pa, R_{ω} represents the gas constant of water, T represents the temperature, the unit is K, and m represents the mass of the dissolved water in the air, the unit is g, V represents the volume of air, the unit is m³.

Specifically, the vapor pressure can be calculated in accordance with the vapor pressure calculation formula:

The vapor pressure calculation formula can be: e=f×Eₛ=f×E₀×10^{(a×t÷(b+t)}; where f represents relative humidity, E₀ represents the saturated water vapor pressure when the temperature is 0 degrees Celsius, when the temperature is greater than 0 degrees Celsius, a=7.5, b=237.3.

Based on the above absolute humidity calculation formula and vapor pressure calculation formula, the absolute humidity of the object to be cleaned can be calculated. Based on the absolute humidity, the control module can determine the dryness degree of the object to be cleaned. Optionally, the control module can determine whether the absolute humidity is less than the absolute humidity threshold. If it is less than the absolute humidity threshold, it can be determined that the object to be cleaned is dry; otherwise, it can be determined that the object to be cleaned is wet. Specifically, the absolute humidity threshold can be set in advance.

Taking a carpet cleaning machine as an example, after the cleaning machine wets the carpet, the degree of moisture at different locations on the carpet will be different. When the cleaning machine moves to dry the carpet at different locations, the absolute humidity obtained by humidity detection will also change, and when the carpet is humid, the change range of absolute humidity is larger, and when the carpet is tending to dry, the change range of absolute humidity is smaller.

Therefore, in order to improve the accuracy of detection, optionally, the control module can determine the maximum absolute humidity within the first preset time, compare the maximum absolute humidity with the absolute humidity threshold, to obtain the first comparison result, and determine the difference between the maximum absolute humidity and the minimum absolute humidity within the second preset time, compare the difference with a difference threshold to obtain a second comparison result. Based on the first comparison result and the second comparison result, the dryness degree of the object to be cleaned is determined. The difference threshold can be set in advance, and the first preset time and the second preset time can be set according to actual application scenarios. They can be the same or different, and there are no specific restrictions here.

In an optional embodiment, the absolute humidity threshold can be set to 58.2 g/m³, the difference threshold can be set to 15 g/m³, the first preset time can be set to 1.5 s, and the second preset time can be set to Is. If the maximum absolute humidity within the first preset time is less than the absolute humidity threshold, and the difference is less than the difference threshold, it can be determined that the dryness degree of the object to be cleaned is dry; if the maximum absolute humidity within the first preset time is less than the absolute humidity threshold, but the difference is not less than the difference threshold, it can be determined that the dryness degree of the object to be cleaned is tending to dry; if the maximum absolute humidity within the first preset time is not less than the absolute humidity threshold, but the difference is less than the difference threshold, it can be determined that the dryness degree of the object to be cleaned is tending to wet; if the maximum absolute humidity within the first preset time is not less than the absolute humidity threshold, and the difference is not less than the difference threshold, it can be determined that the dryness degree of the object to be cleaned is wet.

FIG. 1p is a schematic structural diagram of another embodiment of a humidity detection mechanism provided by the present disclosure. As shown, the humidity detection mechanism can include:
at least one resistor R₀ and at least one electrode piece F; where, the at least one resistor R₀ and the at least one electrode piece F are alternately connected in series, and the at least one electrode piece F is in contact with the object to be cleaned; and
a detection circuit connected in series with the at least one resistor R₀ and the at least one electrode piece F and connected with the control module, to detect an output voltage of the at least one resistor R₀ and determine the humidity of the object to be cleaned according to the output voltage.

In this embodiment, the detection circuit is connected to the control module, and the control module can control the input voltage of the detection circuit to be fixed. The detection circuit includes at least one resistor and at least one electrode piece connected in series. According to the dryness degree of the object to be cleaned, the output voltage of the at least one resistor is also different, so the dryness degree of the object to be cleaned can be determined based on the output voltage of the at least one resistor. Taking a carpet cleaning machine as an example, the electrode piece and resistor are alternately connected and in contact with the carpet. When the carpet is wet, the space between the two electrodes is filled with water, the resistance between the electrodes is short-circuited, the output voltage of at least one resistor is relatively low. When the carpet is dry, the resistance between the electrodes is not short-circuited, and the output voltage of at least one resistor is relatively higher. And because the dryness degree at different locations on the carpet may be different, part of resistors may be short-circuited, and the output voltage may be between the maximum value and the minimum value.

In order to improve the detection effect for carpets with different pile lengths, optionally, the humidity detection mechanism can also include a second elastic component 1016 with one end fixed in the device body. The second elastic component 1016 can expand and contract according to different surface heights of the object to be cleaned, and an insulating structure 1017 provided in the device body and connected to the other end of the second elastic component 1016. The at least one resistor R₀ and at least one electrode piece F are fixed on the insulating structure. The elastic component may include a spring, a corrugated pipe, etc., the insulating structure may include an insulating plate, etc., and the electrode piece may include a metal or alloy that has conductive properties and is not easily corroded by water.

Optionally, as shown in FIG. 1p, the detection circuit can also include a current limiting resistor R_{A} to avoid damage to the detection circuit when all resistors R₀ are short-circuited.

Optionally, the humidity detection mechanism can be set at the bottom of the device body, specifically at a position subjecting to greater force, so that the electrode piece is in close contact with the object to be cleaned, thereby improving the detection effect.

Based on the detected output voltage, the humidity or dryness degree of the object to be cleaned can be determined. As an optional implementation, the difference between the maximum output voltage and the detected output voltage can be calculated, and the ratio of the difference to the maximum output voltage can be used as the humidity of the object to be cleaned. The maximum output voltage may refer to the output voltage of at least one resistor when the resistor is not short-circuited. For example, when the ratio is 1, the humidity is 100%, and the object to be cleaned is wet; when the ratio is 80%, the humidity is 80%, and the object to be cleaned is tending to wet; when the ratio is 20%, the humidity is 20%, and the object to be cleaned is tending to dry; when the ratio is 0%, the humidity is 0 and the object to be cleaned is dry.

As another optional implementation, the humidity or dryness degree of the object to be cleaned corresponding to the detected output voltage can be determined according to a preset corresponding relationship between the output voltage and the dryness degree. In an optional embodiment, the input voltage of the detection circuit is 3.3V. The detection circuit includes 7 resistors and 8 electrode pieces connected in series. The resistance of each resistor is 1 kΩ, and the resistance of the current limiting resistor is 3 kΩ. When the output voltage is 0V, the humidity is 100% and the object to be cleaned is wet; when the output voltage is 2.31V, the humidity is 0 and the object to be cleaned is dry.

The humidity detection mechanism provided in this embodiment can detect the humidity of the object to be cleaned by impedance changes. It is simple and easy to implement and has low cost. Taking a carpet cleaning machine as an example, it can detect the humidity of carpets with different fiber length types and has strong applicability.

In practical applications, the cleaning device uses the cleaning module to clean the object to be cleaned. Specifically, the fluid supply apparatus is used to spray the first liquid, such as clean water or detergent to the outside, and then the recycling apparatus is used to recycle the second liquid, such as dirty liquid generated by the first liquid. Specifically, the recycling apparatus performs recycle operations under the action of a driving mechanism, and the driving mechanism can be implemented as a motor or the like. The recycling apparatus is provided with a pipe and may include components such as a recycling bin and a suction port. FIG. 1q shows a schematic structural diagram of an embodiment of the recycling apparatus, showing a schematic diagram of the pipe A, the recycling bin B, the suction port C and the driving mechanism D.

During the above cleaning process, if the component of the recycling apparatus is abnormal, it will affect the normal progress of the cleaning process. In order to ensure the normal progress of the cleaning process, the state of the recycling apparatus needs to be detected.

Optionally, the abnormal state of the recycling apparatus may include at least one of the following: the recycling bin is not installed, the suction port is not installed, the recycling bin is full of water, and/or the pipe is blocked. When the recycling apparatus is in different states, the pressure inside the pipe will also be different. Combining FIG. 1q, it can be seen that when the recycling bin B is not installed, the driving mechanism D sucks air through point a, and the pressure inside the pipe will drop to a certain extent; when the suction port C is not installed, the driving mechanism D sucks air through point b. Since the diameter at b is smaller than a, and the pressure drop inside the pipe increases; when the recycling bin B is full of water, the filter below c floats, blocking part of the pipe, and the pressure drop inside the pipe continues to increase; when the pipe is blocked, the pressure drop inside the pipe continues to increase. Therefore, the state of the recycling apparatus can be detected and obtained by detecting the pressure inside the pipe.

As shown, FIG. 1r is a schematic structural diagram of another embodiment of a cleaning device provided by the present disclosure. Compared with the structure shown in FIG. 1a, it also includes a pressure detection module 106 fixed on the wall of the pipe and connected to the control module 102. Specifically, the wall of the pipe is provided a hole, the pressure detection module 106 can detect the pressure inside the pipe through the hole.

The control module 102 can also perform corresponding control processing according to the pressure data detected and obtained by the pressure detection module 106. Specifically, the pressure detection module can be implemented as a pressure sensor. FIG. 1q shows a schematic position diagram of an embodiment of the pressure sensor 1061, and FIG. is shows a schematic structural diagram of an embodiment of the pressure sensor.

Optionally, the control module performing corresponding control processing may include determining, according to the pressure data, that the state of the recycling apparatus is abnormal, and controlling the driving mechanism to stop running. Specifically, the corresponding relationship between the pressure data and each state of the recycling apparatus can be set in advance, and based on the corresponding relationship, the state of the recycling apparatus corresponding to the detected pressure data can be determined. In an optional embodiment, when the driving mechanism is not running, the pressure inside the pipe is 10721 Pa. After the driving mechanism is running and the recycling apparatus is in normal condition, the pressure data inside the pipe is 7300 Pa. When the recycling bin is not installed in the recycling apparatus, the pressure inside the pipe is 9030 Pa. When the suction port is not installed in the recycling apparatus, the pressure inside the pipe is 8350 Pa. When the recycling bin in the recycling apparatus is full, the pressure inside the pipe is 6500 Pa. When the pipe in the recycling apparatus is blocked, the pressure inside the pipe is 6000 Pa.

Optionally, the control module performing corresponding control processing may also include using the prompt module to output corresponding prompt information according to the pressure data detected and obtained by the pressure detection module. The prompt module may include at least one of a display module, a lighting module and/or an audio module. In an optional embodiment, the prompt module is implemented as a display module. If the detected pressure data is 9030 Pa, the display module can display a text prompt message that the recycling bin is not installed, please install the recycling bin. In another optional embodiment, the prompt module is implemented as a sound module. If the detected pressure data is 8350 Pa, the sound module can output a voice prompt message that the suction port is not installed, please install the suction port. The specific implementation of the prompt module has been described in detail in the above embodiments and will not be described again here.

In this embodiment, the pressure detection module provided in the device body can detect the pressure inside the pipe in the recycling apparatus, thereby realizing the state detection of the recycling apparatus and facilitating corresponding control processing when the state of the recycling apparatus is abnormal.

As shown, FIG. 1t is a flowchart of an embodiment of a control method provided in the present disclosure, which can be applied to cleaning device. The cleaning device may include a device body, which may include a cleaning module acting on an object to be cleaned, a humidity detection mechanism disposed in the device body and in contact with the object to be cleaned, and a control module disposed in the device body and connected to the humidity detection mechanism.

The method can include the following processes:
1401: detecting the humidity of the object to be cleaned by using the humidity detection mechanism; and
1402: performing corresponding control processing according to the humidity data detected and obtained by the humidity detection mechanism.

In this embodiment, the device body of the cleaning device is provided with a cleaning module and a control module, as well as a humidity detection mechanism in contact with the object to be cleaned. The humidity detection mechanism can be used to detect the humidity of the object to be cleaned, and corresponding control processing can be performed according to the humidity data detected and obtained by the humidity detection mechanism, thereby realizing the detection of the humidity of the object to be cleaned, without the need for the user to manually touch the object to be cleaned for perception, which improves the user experience.

In some embodiments, the cleaning device may further include a drying module disposed in the device body.

The method can also include:
drying the object to be cleaned by using the drying module.

In some embodiments, according to the humidity data detected and obtained by the humidity detection mechanism, the method for performing corresponding control processing may include:
controlling the drying module to stop running.

In some embodiments, the cleaning device may also include a prompt module disposed in the device body and connected to the control module.

The method of performing corresponding control processing according to the humidity data detected and obtained by the humidity detection mechanism may include:
outputting corresponding prompt information by using the prompt module.

In some embodiments, the humidity detection mechanism can also be used to detect temperature.

The method of performing corresponding control processing according to the humidity data detected and obtained by the humidity detection mechanism may include:
based on the humidity data and temperature data detected and obtained by the humidity detection mechanism, obtaining the temperature change trend and the humidity change trend, and determining the dryness degree of the object to be cleaned in combination the temperature change trend and the humidity change trend.

In some embodiments, the humidity detection mechanism can also be used to detect temperature.

The method of performing corresponding control processing according to the humidity data detected and obtained by the humidity detection mechanism may include:
calculating the absolute humidity of the object to be cleaned, based on the Celsius temperature and relative humidity detected and obtained by the humidity detection mechanism, comparing the maximum absolute humidity within the first preset time with the absolute humidity threshold, to obtain the first comparison result, and comparing the difference between the maximum absolute humidity and the minimum absolute humidity within the second preset time, to obtain the second comparison result, and determining the dryness degree of the object to be cleaned based on the first comparison result and the second comparison result.

In some embodiments, the cleaning device may further include a temperature detection module disposed in the device body at a position between the drying module and the air outlet and connected to the control module.

The method can also include:
detecting the drying temperature by using the temperature detection module; if the drying temperature does not reach the preset temperature, controlling to increase the working voltage of the drying module; if the drying temperature reaches the preset temperature, controlling to maintain the working voltage of the drying module; and if the drying temperature exceeds the preset temperature, controlling to decrease the working voltage of the drying module.

In some embodiments, the cleaning module may include a fluid supply apparatus responsible for spraying the first liquid to the outside, a recycling apparatus responsible for recycling the second liquid generated from the first liquid, and a driving mechanism connected to the recycling apparatus. The recycling apparatus is provided with a pipe. The wall of the pipe is provided with a hole. The cleaning device may also include a pressure detection module fixed on the wall and connected to the control module

The method can also include:
detecting the pressure inside the pipe by using the pressure detection module; and performing corresponding control processing according to the pressure data detected and obtained by the pressure detection module.

In some embodiments, performing corresponding control processing according to the pressure data detected and obtained by the pressure detection module may include: if the state of the recycling apparatus is determined as abnormal according to the pressure data, controlling the driving mechanism to stop running.

The control method described in FIG. 1t can be applied to the cleaning device described in the embodiment shown in FIG. 1a, the implementation principle and the technical effect of which will not be described in detail.

In a possible design, the above-mentioned cleaning device can be implemented as a carpet cleaning machine. For the corresponding principles and technical effects, please refer to the corresponding description of the cleaning device, which will not be described again here.

### Application Scenario One

The carpet cleaning machine includes a cleaning machine body. The cleaning machine body includes a rolling brush that acts on the carpet, a drying module arranged in the cleaning machine body, a humidity detection mechanism arranged in the cleaning machine body and in contact with the carpet, a control module arranged in the cleaning machine body and connected to the humidity detection mechanism, and a prompt module arranged in the cleaning machine body.

The cleaning machine wets the carpet and cleans afterwards, uses the drying module to dry the carpet, and uses the humidity detection mechanism to detect the humidity of the carpet. Specifically, the humidity detection mechanism includes a spring with one end fixed in the cleaning machine body, where the spring can expand and contract according to the different surface heights of the carpet, a hollow structure arranged in the cleaning device body, with a first end connected to the other end of the spring and a second end in contact with the carpet, and a temperature and humidity sensor fixed in the hollow structure and connected to the control module. Specifically, the second end of the hollow structure extends out of the cleaning device and is in contact with the carpet, and an air inlet is provided, and the temperature and humidity sensor detects water vapor entering the interior of the hollow structure through the air inlet to obtain the humidity data and temperature data of the carpet.

The control module obtains the temperature change trend and humidity change trend based on the humidity data and temperature data, determines the dryness degree of the carpet based on the temperature change trend and the humidity change trend, and uses the prompt module to output corresponding prompt information.

### Application Scenario Two

The carpet cleaning machine includes a cleaning machine body. The cleaning machine body includes a rolling brush that acts on the carpet, a drying module arranged in the cleaning machine body, a humidity detection mechanism arranged in the cleaning machine body and in contact with the carpet, a control module arranged in the cleaning machine body and connected to the humidity detection mechanism, and a prompt module arranged in the cleaning machine body.

The cleaning machine wets the carpet and cleans afterwards, uses the drying module to dry the carpet, and uses the humidity detection mechanism to detect the humidity of the carpet. Specifically, the humidity detection mechanism includes a spring with one end fixed in the cleaning machine body, where the spring can expand and contract according to the different surface heights of the carpet, a hollow structure arranged in the cleaning device body, with a first end connected to the other end of the spring and a second end in contact with the carpet, and a temperature and humidity sensor fixed in the hollow structure and connected to the control module. Specifically, the second end of the hollow structure extends out of the cleaning device and is in contact with the carpet, and an air inlet is provided, and the temperature and humidity sensor detects water vapor entering the interior of the hollow structure through the air inlet to obtain the humidity data and temperature data of the carpet.

Specifically, the humidity data is implemented as relative humidity, and the temperature data is implemented as Celsius temperature. The control module calculates and obtains the absolute humidity of the carpet based on the relative humidity and Celsius temperature, and compares the maximum absolute humidity within the first preset time with the absolute humidity threshold, to obtain the first comparison result, and compares the difference between the maximum absolute humidity and the minimum absolute humidity within the second preset time with the difference threshold, to obtain the second comparison result, based on the first comparison result and the second comparison result, determines the dryness degree of the carpet, and use the prompt module to output corresponding prompt information.

### Application Scenario Three

The carpet cleaning machine includes a cleaning machine body. The cleaning machine body includes a rolling brush that acts on the carpet, a drying module arranged in the cleaning machine body, a humidity detection mechanism arranged in the cleaning machine body and in contact with the carpet, a control module arranged in the cleaning machine body and connected to the humidity detection mechanism, and a prompt module arranged in the cleaning machine body.

The cleaning machine wets the carpet and cleans afterwards, uses the drying module to dry the carpet, and uses the humidity detection mechanism to detect the humidity of the carpet. Specifically, the humidity detection mechanism includes a spring with one end fixed in the main body of the cleaning machine, where the spring can expand and contract according to the different surface heights of the carpet, an insulating plate arranged in the cleaning machine body and connected to the other end of the spring, at least one resistor and at least one electrode piece fixed on the insulating plate and a detection circuit connected in series with the at least one resistor and at least one electrode piece, and connected to the control module. The at least one resistor and at least one electrode piece are alternately connected in series, at least one electrode piece is in contact with the carpet, and the detection circuit detects the output voltage of the at least one resistor and determines the humidity of the carpet based on the output voltage.

The control module determines the dryness degree of the carpet based on the carpet humidity, and uses the prompt module to output corresponding prompt information.

### Application Scenario Four

The carpet cleaning machine includes a cleaning machine body. The cleaning machine body includes a rolling brush that acts on the carpet, a fluid supply apparatus responsible for spraying clean water outwards, a recycling apparatus responsible for recycling sewage, a driving mechanism connected to the recycling apparatus, a humidity detection mechanism arranged in the cleaning machine device and in contact with the carpet, a control module arranged in the cleaning machine device and connected to the humidity detection mechanism, and a prompt module arranged in the cleaning machine body. Specifically, the recycling apparatus is provided with a pipe, and the wall of the pipe is provided with a hole. The cleaning machine body also includes a pressure detection module fixed on the wall and connected to the control module.

The cleaning machine uses the fluid supply apparatus to spray clean water on the carpet to wet the carpet for cleaning, and uses the recycling apparatus to recycle the sewage after cleaning. Specifically, the recycling apparatus includes a recycling bin and a suction port. When the recycling apparatus is in at least one abnormal state including the recycling bin not being installed, the suction port not being installed, the recycling bin being full of water, and/or the pipe being blocked, the pressure inside the pipe will change. The pressure detection module is used to detect the pressure inside the pipe of the recycling apparatus.

The control module determines the state of the recycling apparatus based on the pressure inside the pipe, and controls the driving mechanism to stop running when the recycling apparatus is in the above-mentioned abnormal state.

At present, the carpet cleaning machine can not only clean the carpet, but also add a drying mode. After the user uses the carpet machine to clean the carpet, the drying mode can be used to heat the air outlet through the heating wire of the heater and dry the carpet directly.

In order to allow the user to know the drying condition of the carpet in drying mode in real time, the cleaning device is also equipped with a detection apparatus, and the detection apparatus is configured as detecting the dryness degree of the carpet. In order for the detection apparatus to accurately detect a parameter on the surface to be worked on, such as the carpet, the detection apparatus needs to be set very close to the surface to be worked on so that the distance between the detection apparatus and the carpet can meet the sensing range of the detection apparatus.

Since the fiber lengths of different types of carpets are different, the detection apparatus will scratch the carpet when the cleaning device is walking, and there is a risk of damaging or scratching the carpet. In addition, the detection apparatus will form a large resistance with the carpet, thus affecting the movement of carpet cleaning machine.

In order to solve the above technical problems, embodiments of the present disclosure provide a cleaning device and a detection apparatus. The cleaning device can not only be used to clean the carpet, but also can be used to clean the floor or other fabrics. The detection apparatus can be arranged on the cleaning device and used to detect the airflow of the surface to be worked of the cleaning device to obtain a relevant parameter of the surface to be worked. It can be understood that the detection apparatus of the present disclosure is not limited to application on cleaning device, but can be used on any device used to detect the relevant parameter on the surface of the device to be worked. In addition, in order to facilitate understanding, the specific structure and working principle of the detection apparatus will be introduced in detail when describing the cleaning device of the present disclosure below, and will not be described separately.

The cleaning device of the present disclosure includes a body and a detection apparatus. Specifically, the body is provided with an air duct, and the air duct includes an air duct suction port and an air duct discharge port. The detection apparatus at least partially protrudes from the body and extends in a direction toward the surface to be worked (that is, the detection apparatus extends vertically downward); the detection apparatus is movably connected to the body and is configured as moving into the body when an external force is encountered.

The air duct is configured as forming a negative pressure in the detection apparatus, so that the detection apparatus sucks the airflow in the area of the surface to be worked and detects the parameter of the airflow.

When the cleaning device is working, the airflow in the air duct blows from the air duct outlet to the surface to be worked. The airflow gradually takes away the moisture on the surface to be worked, and the surface to be worked gradually dries.

At the same time, under the action of air duct suction, a negative pressure can be formed in the detection apparatus. Under the action of the pressure difference between the inside and outside of the detection apparatus, the airflow carrying moisture on the surface to be worked is sucked into the detection apparatus in real time, so that the detection apparatus can detected the parameter of the airflow in real time.

The detection apparatus is movably arranged on the body. When the detection apparatus encounters external resistance when the cleaning device is walking, it moves into the body of the cleaning device, which can avoid scratching the carpet, causing damage to the detection apparatus or scratching the carpet, thereby improving the safety of its use and possibly improving the user experience; at the same time, it can also reduce the resistance between the carpet and the detection apparatus, ensuring that the cleaning device can walk smoothly on the carpet.

In addition, users can judge the dryness degree of the surface to be worked based on this parameter, without having to repeatedly bend over and use their limbs to judge the dryness degree of the carpet, which greatly improves user experience and comfort. In one embodiment of the present disclosure, the detection apparatus includes a housing and a detection component located in the housing inner cavity; the housing has an air outlet and an air inlet facing the surface to be worked; the air outlet of the housing is communicated with the air duct. The airflow in the area near the surface to be worked is sucked into the housing inner cavity in the form of negative pressure. This allows the detection component to accurately detect the parameter of the surface to be worked, avoids the impact of air on the detection component, and improves accuracy of the detection of the surface to be worked.

In order to facilitate better understanding, the cleaning device of the present disclosure will be described in detail below with reference to FIGS. 2a to 2n, by taking carpet cleaning as an example, and the detection apparatus of the present disclosure will also be introduced. It is understood that the cleaning device can clean other fabrics besides the carpet.

With reference to FIG. 2a and FIG. 2b, the cleaning device of the present disclosure includes a body 10 and a detection apparatus.

The body 10 refers to a carrier that integrates the main functional components of the cleaning device, and can be made of metal, resin, plastic, or other materials. For example, the cleaning device includes a floor brush component, an air duct system, a sewage tank, a clean water tank, a motor and other component installed on the machine body. The clean water tank supplies water to the floor brush component, so that the floor brush component can use clean water or cleaning fluid to clean the carpet. The air duct system includes an air duct suction port and an air duct discharge port. The motor provides suction for the air duct system to suck up sewage or foreign matter. The sewage after cleaning conducted by the floor brush component is sucked into the sewage tank by the air duct suction port. The solid and liquid dirt remain in the sewage tank. The airflow separated from the sewage flows into the motor through the main air inlet of the motor and flows out of the motor via the main air outlet of the motor, and then the airflow is discharged from the body through the air duct outlet. The specific structure of the machine body and its relationship with each main functional component, as well as the working principle of each functional component are same with the existing carpet cleaning machine, which can be fully realized by those skilled in the art based on the existing technology, and will not be described in detail here.

Specifically, the body 10 is provided with an air duct (not shown in the drawings), which includes an air duct suction port and an air duct discharge port, and the airflow sucked by the air duct suction port is configured to blow from the air duct discharge port to the surface to be worked. Normally, the air duct suction port is set at the position of the floor brush component to suck away the sewage formed after the floor brush component cleans the surface to be worked. As mentioned above, this embodiment takes carpet cleaning as an example to explain the structure and working principle of the cleaning device in detail. Therefore, in order to facilitate expression and understanding, the following will use “carpet” to refer to the surface to be worked on, that is to say, the airflow sucked by the air duct suction port is configured to blow from the air duct suction port to the carpet or the surface of the carpet.

The air duct is formed in the body 10. According to some embodiments of the present disclosure, the air duct may be formed by casting, injection molding, assembly or machining. According to other embodiments of the present disclosure, the air duct may be an air pipe designed separately from the body 10, and the air duct is arranged on the body 10 by bonding, welding, or threaded connection.

Referring to FIG. 2b, the detection apparatus of the present disclosure includes a housing 11 and a detection component 12 located in the inner cavity 110 of the housing 11.

Specifically, the housing 11 has an air outlet 1110 and an air inlet 1120 facing the surface to be worked (carpet surface). The air outlet 1110 of the housing 11 is communicated with the air duct on the body 1. Specifically, the air outlet 1110 of the housing 11 is communicated to any position of the air duct between the suction port and the motor. Here, any position of the air duct between the suction port and the motor includes the two endpoint positions of the suction port and the main air inlet of the motor.

In detail, according to some embodiments of the present disclosure, the housing 11 of the present disclosure includes a lower housing 112 with an open end, and an upper housing 111 located at the open end of the lower housing 112. The upper housing 111 is configured as covering the open end of the lower housing 112, that is, the upper housing 111 and the lower housing 112, or together with other components, forming an inner cavity 110, so that the main structures such as the chip of the detection component 12 are located in the inner cavity 110, to prevent moisture, foreign matter, and dust on the carpet affecting the function of the chip, or cause the chip to short circuit or otherwise be damaged.

Specifically, the upper housing 111 is provided with a mounting hole, and the main body of the detection component 12 and other carrier structures are fixedly connected to the upper housing 111 through the mounting hole, while the chip of the detection component 12 is located in the inner cavity 110 enclosed by the upper housing 111 and the lower housing 112.

The air inlet 1120 is opened on the lower housing 112, and the air inlet 1120 is configured to face the carpet surface. The air outlet 1110 is opened on the upper housing 111. The air outlet 1110 of the upper housing 111 and the air duct on the body 10 are communicated through a communicating pipe, so that when the air duct suction port of the air duct sucks the airflow, or when the airflow flows in the air duct, a negative pressure is formed in the inner cavity 110 of the housing 11.

In some embodiments of the present disclosure, referring to FIG. 2b, the communicating pipe includes a pipe joint 1116 formed on the upper housing 111, and the pipe joint 1116 is in communication with the air outlet 1110 of the upper housing 111. The communicating pipe also includes a hose 113. One end of the hose 113 is connected to the pipe joint 1116, and the other end is communicated with the air duct of the body.

In some embodiments of the present disclosure, the communicating pipe can also be formed in other ways, such as by injection molding, or by splicing or enclosing to form the communicating pipes on the body 10.

In more detail, the air inlet 1120 is located on the bottom surface of the lower housing 112. The air inlet 1120 and the air outlet 1110 are staggered, and the central axes of the two do not overlap. The detection component 12 is located on the central axis of the air inlet 1120, and the central axis of the air inlet 1120 coincides with the central axis of the bottom surface of the lower housing 112.

With this arrangement, the airflow entering the housing inner cavity 110 from the air inlet 1120 can directly act on the detection component 12, so that the airflow and the detection component 12 are fully contacted to ensure the accuracy of the detection result of the detection component 12.

Specifically, the air outlet 1110 is communicated to a position in the air duct between the motor and the suction port of the air duct, that is, connected to the side of the air duct that has suction force. Under the action of the pressure difference between the inside and outside of the housing 11, the airflow on the carpet surface is sucked into the inner cavity 110 of the housing 11 from the air inlet 1120 of the housing 11, and finally discharged into the air from the air outlet 1110 of the housing 11. When the airflow on the carpet surface flows through the inner cavity 110 of the housing 11, the detection component 12 disposed in the inner cavity 110 is configured to detect the parameter of the airflow in the inner cavity 110 of the housing.

According to some embodiments of the present disclosure, the detection component 12 of the present disclosure is a humidity detection component, and the humidity detection component is configured to detect the humidity of the airflow entering the inner cavity 110, thereby allowing the user to know the dryness degree of the carpet. According to some embodiments of the present disclosure, the detection component 12 of the present disclosure can also be used to detect dust, particles, harmful substances or mites in the airflow. On the basis that the detection component 12 is capable of detecting carpet surface humidity, those skilled in the art can add or replace corresponding detection functions based on actual needs.

Considering the comprehensive consideration of cost, durability and product accuracy, the sensing distance of existing humidity detection components to water molecules is about a millimeter. Beyond a mm, the sensing sensitivity is too low and the function may be lost, or the humidity detection component only detects the humidity within a mm range. Therefore, in principle, the closer the humidity detection component is to the area to be detected, the higher the detection accuracy and sensitivity. Otherwise, the environment near the humidity detection component will interfere with its detection results. The present disclosure sucking air from the area near the carpet into the inner cavity of the housing, thereby increasing the distance from the ground while ensuring detection accuracy.

But even so, the height of the humidity detection component from the carpet, or the height of the housing air inlet 1120 from the carpet cannot be too large. Under the influence of this design factor, it must be satisfied that the distance between the lowest position and the ground is greater than or equal to b mm, otherwise the movement resistance between the housing and the carpet will be large (push and pull force when the product is in use, or resistance when the automatic cleaning device is walking), affecting the user experience, and also scratching the floor or carpet. Specifically, a is greater than b.

Therefore, the design requires that the distance between the humidity detection component and the carpet fiber be within a millimeter. It also needs to meet the sensing requirements for ultra-long fiber, long fiber, medium fiber, and short fiber carpets on the market. At the same time, the distance between the lowest position and the ground is greater than or equal to b mm. For example, in a specific embodiment of the present disclosure, a can be 8 mm, and b can be 5 mm. To this end, according to some embodiments of the present disclosure, the housing 11 of the present disclosure partially protrudes from the body 10 and extends in the direction facing the surface to be worked; the housing 11 is movably connected to the body 10 as a whole, and is configured to move into the body 10 when resistance is reached.

With this arrangement, when the cleaning device cleans different types of carpets such as extra long fiber, long fiber, medium fiber, short fiber, etc., the resistance received by the housing 11 varies, and the resistance received by the housing 11 is proportional to the length of the carpet fiber, that is, the longer the fiber of the carpet is, the greater the resistance the housing 11 will receive. Therefore, the housing 11 can automatically adjust the distance between the detection component 12 and the carpet surface according to the resistance received, thereby meeting both the sensing range of the humidity detection component and its minimum working position requirements.

In detail, the bottom plate of the body 10 is provided with a through hole 101 for the lower housing 112 to pass through. When the housing 11 is not subjected to resistance, the upper housing 111 covers the position of the through hole 101. For example, the edge of the upper housing 11 may cooperate with the end surface of the through hole 101 of the body to prevent the housing from falling off from the through hole 101. When the cleaning device is stopped or on standby and the housing 11 is not subjected to resistance, the detection apparatus causes the upper housing 111 to cover the position of the through hole 101 (initial position) under the action of gravity to limit the movement of the entire detection apparatus relative to the body 10. It can be understood that in other embodiments of the present disclosure, when the housing is not subjected to resistance, the detection apparatus can also be overlapped on other components inside the body 10 under the action of gravity (initial position), which will not be described in detail here.

When the cleaning device cleans the carpet, the lower housing 112 is resisted by the fiber of the carpet, and the lower housing 112 overcomes the gravity so that the housing 11 moves toward the inside of the body 10 to the position shown in FIG. 2f, that is, the lower housing 112 moving toward the body 10. The internal movement pushes the upper housing 111 to move synchronously into the body 10, so that the detection apparatus can automatically adjust the distance between the detection component 12 and the carpet surface according to the resistance received.

If the detection apparatus only relies on its own weight, there is a risk that the lower housing 112 is stuck in the through hole 101 and cannot be restored to the original position.

To this end, according to some embodiments of the present disclosure, see FIGS. 2c to 2f, the housing 11 of the present disclosure is configured to move in the vertical direction relative to the body 10 through a guiding mechanism, and the detection apparatus also includes a first elastic apparatus 16 being pre-pressure between the body 11 and the body 10. The housing 11 has a tendency to move toward the outside of the body 10 under the force of the first elastic apparatus 16.

In detail, the guiding mechanism includes a guiding rod 14 and a stopper 15. In one embodiment, one end of the guiding rod 14 passes through the upper housing 111 and is provided on the body 10, the stopper 15 is provided on the other end of the guiding rod 14, and the first elastic apparatus 16 is sleeved on the guiding rod 14 and is pre-pressed between the upper housing 111 and the stopper 15. Under the force of the first elastic apparatus 16, the upper housing 111 has a tendency to move toward the outside of the body 10, that is, the first elastic device 16 is always in a compressed state. When the detection apparatus receives an external force, the upper housing 111 pushes the first elastic apparatus 16 to move upward under the guidance of the guiding rod 14. In another embodiment, one end of the guiding rod 14 is pressed against the upper housing 111, the other end is provided with a stopper 15 and passes through the stopper 15, and the part of the other end of the guiding rod 14 passing through the stopper part 15 forms the free end. The first elastic apparatus 16 is sleeved on the guiding rod 14 and is pre-pressed between the upper housing 111 and the stopper 15. When the detection apparatus is subjected to external force, the upper housing 111 further compresses the first elastic apparatus 16, and the guiding rod 14 is pushed upward. In the above embodiment, the stopper 15 is provided on the body 10. Specifically, continuing to refer to FIG. 2f, the upper housing 111 may include a first upper housing 1114 and a second upper housing 1115, and the first upper housing 1114 is located on top of the second upper housing 1115. The edge position of the second upper housing 1115 protrudes relative to the first upper housing 1114, and a guide hole for cooperating with the guiding rod 14 is provided at this position. The first elastic apparatus 16 can specifically be a spring, which is sleeved on the guiding rod 14. One end of the spring is in contact with the stopper 15, and the other end is in contact with the edge of the second upper housing 1115.

When the cleaning device cleans the carpet, the lower housing 112 is resisted by the fiber of the carpet. Under this resistance, the detection apparatus can overcome the elastic force of the first elastic apparatus 16 and its own gravity, and move toward the inside of the body 10 to a position where the per housing 111 leaving the through hole 101, that is, the detection apparatus moving upward away from the initial position to automatically adjust the distance between the detection component 12 and the carpet surface according to the resistance received.

When the resistance exerted by the carpet on the lower housing 112 disappears, the detection apparatus moves from the current position toward the outside of the body 10 to the initial position under the elastic force and self-weight of the first elastic apparatus 16.

Since the housing 11 of the detection apparatus of the present disclosure is movably connected to the body 10 as a whole, according to some embodiments of the present disclosure, the air outlet 1110 of the housing 11 and the air duct on the body 10 are communicated through the hose 113 to facilitate the degree of freedom of movement relative to the body 10 of the housing 11. As for the communicating pipe formed by splicing or enclosing on the body 10, it only needs to ensure that the housing is always sealed and connected with the communicating pipe during movement. For example, an elastic seal with a certain displacement can be provided between the air outlet 1110 of the housing and the communicating pipe, or other structures well known to those skilled in the art that can maintain a sealed connection during movement, which will not be discussed here.

According to another embodiment of the present disclosure, when the upper housing 111 covers the through hole 101, that is, in the initial position, the conduit at the air outlet 1110 is located in the hose 113, so that when the housing 11 moves upward, the conduit is still inside hose 113.

According to another embodiment of the present disclosure, the detection apparatus may include two guiding rods 14 provided on both sides of the detection component 12, and two first elastic apparatuses 16 respectively sleeved on the two guiding rods 14, so as to ensure smooth and coordinated movement of the upper housing 111 relative to the body 10.

According to some embodiments of the present disclosure, continuing to refer to FIGS. 2a and 2b, the housing 11 of the present disclosure has a curved outer contour toward one end of the surface to be worked.

The curved outer contour of the housing 11 is in contact with the surface to be worked of the carpet surface. When the cleaning device walks on the carpet, the housing 11 slides corporately with regard to the carpet via the smooth curved surface without scratching or hurting the fiber on the carpet to protect the carpet. In addition, the outer contour design of the curved surface can also reduce the resistance with the carpet, which is conducive to the movement of the cleaning device on the carpet to clean the entire carpet.

As we all know, the humidity detection component is an electronic precision part. In order to meet its sensing range, the humidity detection component is relatively close to the carpet. The harsh use environment and easily being affected by water, dust or dirt, etc., affects their service life and detection accuracy.

To this end, according to some embodiments of the present disclosure, continuing to refer to FIG. 2b, the detection apparatus of the present disclosure also includes a filter cover 13 disposed in the inner cavity 110 of the housing 11, and the detection component 12 is located in the filter cover 13; the aperture on the filter cover 13 is constructed to be waterproof and breathable.

In detail, the upper housing 111 has a first connecting sleeve 1111 extending into the inner cavity 110. The filter cover 13 is inserted into the first connecting sleeve 1111 and is arranged on the first connecting sleeve 1111 by bonding, welding, threading, etc.

After the detection apparatus is provided with the filter cover 13, it can not only allow the airflow on the carpet surface to enter the inner cavity 110 from its aperture, so that the detection component 12 can detect the parameter of the airflow, but also prevent water, dust and dirt from entering the inner cavity where the detection component 12 is located, which affects its detection accuracy and service life. That is to say, the filter cover 13 has the functions of breathability, waterproof, dustproof and foreign matter prevention. The purpose of waterproofing and breathability can be achieved by selecting a suitable aperture.

According to some embodiments of the present disclosure, the filter cover 13 of the present disclosure is specifically a PE film. The PE film protects the detection component 12 from water, dust, and dirt, and at the same time utilizes its breathability and the three-dimensional wrap around it on three sides to greatly increase the effective area for water molecules to enter.

Since the smaller the mesh number a of the PE film, the larger the effective area, but the easier for dust and water vapor to enter, so the pore size of the PE film needs to be controlled. According to some embodiments of the present disclosure, the pore size of the PE film of the present disclosure is configured to prevent the entry of liquid water under a negative pressure of 7 KPa.

Preferably, according to the working state of the cleaning device, the pore size of the PE film of the present disclosure is configured to prevent the entry of liquid water under a negative pressure of 2.6 KPa.

According to some embodiments of the present disclosure, the pore size of the PE film of the present disclosure is less than or equal to 10 m (microns). This PE film not only effectively protects the detection component, but also ensures that the water vapor flow meets the sensing needs and achieves sensitive humidity response.

According to the principle of constant total flow, Q_{wet}=Q1+Q2=Q_{entire machine}−Q_{suction port}, where Q_{wet} is the flow quantity at the air outlet 1110 of the detection apparatus, which contains dry air and water vapor, Q₁ is the sucked water vapor in the area near the carpet, Q₂ is the sucked dry air; Q_{entire machine} is the gas flow quantity of the entire cleaning machine; Q_{suction port} is the gas flow quantity at the position of the air duct suction port.

For example, in one embodiment of the present disclosure, the filtration resistance of the filter cover (PE film) is 2.6 KPa, so the pressure in the communicating pipe needs to be >2.6 KPa in order for the airflow to overcome the filtration resistance of the filter cover and enter the filter cover. In the entire machine of the cleaning device, the vacuum degree is related to the cross-sectional area S_{entire machine} of the actual air duct. The pressure P at each position in the air duct cavity of the entire machine is the same. Therefore, S_{entire machine}=S_{suction port of air duct}+S_{communicating pipe}. Where the S_{suction port of air duct} is the cross-sectional area of the air duct at the position of the suction port, and the S_{communicating pipe} is the cross-sectional area of the air duct at the position of the communicating pipe.

When the cleaning device is working on a short-fiber carpet, the fiber of the carpet will not affect the cross-sectional area of the suction port of the air duct; when the cleaning device is working on a long-fiber carpet, the fiber of the carpet will reduce the cross-sectional area of the suction port of the air duct. No matter working on the short-fiber carpet or the long-fiber carpet, as long as the fiber length of the carpet is fixed, the cross-sectional area of the suction port of the air duct is fixed, that is, the S_{suction port of air duct} is unchanged (S_{suctionport of air duct} is slightly larger in the push-pull state than it is in the stationary state, which can be ignored). Therefore, the larger the S_{communicating pipe}, the larger S_{entire machine}, and the smaller the pressure P. In addition, the longer the carpet fiber, the smaller the S_{suction port of air duct}, and the greater the vacuum degree, the lower limit must be ensured, that is, on the short-fiber carpet, the vacuum degree value must be ≥2.6 KPa, so the inner aperture of the communicating pipe must be as small as possible. The lower limit of the inner aperture of the communicating pipe must ensure that the communicating pipe will not affect the vacuum degree at the suction port. In one embodiment of the present disclosure, for example, the vacuum degree of the communicating pipe can be made less than or equal to 7 KPa.

In addition, considering the problem of work done on water on the carpet (water droplets cannot be sucked in), it is necessary to control the vacuum degree in the communicating pipe not to be too large, that is, W−W_{resistance}<W_{water}, so that the suction force of the communicating pipe is not enough to suck in the water droplets. Specifically, the suction work in the communicating pipe is W=P*Q_{wet}, W_{water}=ρ gh, W_{resistance} depends on the pore size of the filter cover (PE film).

FIG. 2p shows the influence of the cross-sectional area S_{entire machine} of the entire machine air duct in the cleaning device on various parameters. Taking the above factors into consideration, it is more appropriate to select a hole size of 3-5 mm for the actual communicating pipe.

The detection apparatus of the present disclosure mainly works in the drying mode of the cleaning device. At this time, the temperature between the body and the carpet is high, the air volume is large, and the environmental interference factor is large. Temperature, air volume and humidity are inversely proportional under normal circumstances. The higher the temperature, the greater the air volume, the faster the water molecules evaporate and are easily blown away. The humidity will always show a low value, but the carpet is still wet and the correct humidity of the carpet cannot be displayed.

To this end, according to some embodiments of the present disclosure, a gap between the outer wall of the filter cover 13 and the inner wall of the lower housing 112 is provided.

When the detection apparatus is working, under the action of negative pressure in the air duct, the airflow on the carpet surface is sucked into the lower housing 112 through the air inlet 1120 at the bottom of the lower housing 112, flows in the gap, and then enters the filter cover 13 through the dense holes on the entire outer contour of the filter cover 13.

According to an embodiment of the present disclosure, the filter cover 13 is coaxially arranged with the lower housing 112.

In one embodiment of the present disclosure, the lower housing 112 may be made of heat-insulating material.

The outer surface of the filter cover 13 is three-dimensional, which has zero contact with the lower housing 112 and is distributed equidistantly, and is wrapped by the lower housing 112. Using the material of the lower housing 112 and the air medium in the gap, the heat conduction and heat convection between the periphery of the filter cover 13 and the outside air heat are reduced, the external heat interference is reduced, and the humidity sensitivity is greatly improved.

According to some embodiments of the present disclosure, the air inlet 1120 is provided at the bottom of the lower housing 112. The side wall of the lower housing 112 can block the interference of hot wind, allowing water molecules to enter only from the bottom of the housing 11, reducing the interference of the air output volume of external device.

The detection apparatus of the present disclosure has a harsh working environment and high durability requirements. Based on the structure of the existing detection apparatus, dirty water and dirt will accumulate between the lower housing 112 and the filter cover 13, resulting in poor air permeability of the filter cover 13. The accumulated dust or dirt may penetrate into the filter cover and slowly corrode the detection component 12, causing short circuit, open circuit or other damage, causing the detection and induction function to fail.

To this end, in one embodiment of the present disclosure, the lower housing 112 is configured to move toward the upper housing 111 when subjected to a first external force, and/or, the lower housing 112 is configured to rotate relative to the filter cover 13 when subjected to a second external force.

In a specific embodiment of the present disclosure, under the action of the first external force, the lower housing 112 moves in the direction towards the upper housing 111. Under the action of this movement, dust and foreign matter accumulated between the lower housing 112 and the filter cover 13 will lose adhesion, fall to the bottom of the lower housing 112, and then be discharged through the air inlet 1120. In addition, when the upper housing 112 moves upward, the gap between the upper housing 112 and the filter cover 13 will become smaller, so that dust or foreign matter attached to the surface of the filter cover 13 can also be scraped off.

In another specific embodiment of the present disclosure, under the action of the second external force, the lower housing 112 rotates relative to the filter cover 13. Under the action of this rotation, the dust and foreign objects accumulated between the lower housing 112 and the filter cover 13 will lose adhesion, fall to the bottom of the lower housing 112, and then be discharged through the air inlet 1120. In addition, under the rotational torque, dust or foreign matter attached to the surface of the filter cover 13 will also be scraped off.

In another specific embodiment of the present disclosure, under the action of the first external force and the second external force, the lower housing 112 reciprocates in the vertical direction relative to the body 10, and reciprocating rotates relative to the filter cover 13 or the body, this is more conducive to scraping off dust or foreign matter attached between the filter cover 13 and the lower housing 112 and on the surface of the filter cover 13.

To this end, according to some embodiments of the present disclosure, see FIG. 2g and FIG. 2h, the inner wall of the lower housing 112 is provided with scraping strips 1122 distributed at intervals, and the scraping strips 1122 are configured to scrap off the foreign matter on the filter cover 13 during movement of the lower housing 112. According to some embodiments of the present disclosure, the scraping strip 1122 on the lower housing 112 extends in the axial direction, so that when the lower housing 112 rotates relative to the body 10, the scraping strip 1122 scrapes off foreign matter on the peripheral wall of the filter cover 13.

According to some embodiments of the present disclosure, the scraping strip 1122 of the lower housing 112 may also extend in the circumferential direction, so that when the lower housing 112 moves axially relative to the upper housing 111, the scraping strip 1122 scrapes off the peripheral wall of the filter cover 13 of foreign matter. According to some embodiments of the present disclosure, the scraping strip 1122 of the lower housing 112 extends in the axial direction, and the scraping strip 1122 extends in the circumferential direction, so that when the lower housing 112 moves axially relative to the upper housing 111 and rotates relative to the body 10, the scraping strip 1122 can cooperate with the movement of the lower housing 112 to scrape off dust or foreign matter on the peripheral wall of the filter cover 13.

According to some embodiments of the present disclosure, with continued reference to FIGS. 2b, 2d and 2e, the side wall of the body 10 of the present disclosure is provided with a through hole 101 for the lower housing 112 to pass through, the inner wall of the through hole 101 is provided with a step groove 100, and the outer wall of the lower housing 112 is provided with a flange 1121 that extends radially outward and is supported on the step groove. The upper housing 111 covers the position of the through hole 101 and is configured to have a gap h between it and the end surface of the lower housing 112 supported on the step groove 100.

When the detection apparatus is not subject to external force in any direction, under the action of its own gravity, the lower housing 112 overlaps the step groove 100 of the body 10 through the flange 1121, and an axial gap h is provided between the upper surface of the lower housing 112 and the bottom surface of the upper housing 111. The axial direction refers to the movement direction in the vertical direction of the lower housing 112 relative to the body.

When the detection apparatus receives the first external force in the axial direction, the lower housing 112 moves upward relative to the body 10 in the axial direction relative to the upper housing 111, and the flange 1121 of the lower housing 112 leaves the step groove 100 of the body 10 and gradually moves in a direction towards the upper housing 111, until the lower housing 112 and the upper housing 111 collide.

When the detection apparatus receives a second external force in the circumferential direction, the lower housing 112 can rotate relative to the body 10 and the filter cover 13, so that the scraping strip 1122 on the inner wall of the lower housing 112 scrapes off foreign matter on the peripheral wall of the filter cover 13. Specifically, the circumferential direction refers to the direction around the axial direction.

The lower housing 112 is designed to rotate 360°, leaving a free movement space up and down with a preset gap h, and is misaligned with the filter cover 13, and has a scraper at the bottom. When the cleaning device is cleaning the carpet, during the process of pushing forward and pulling back, a torsion force will be formed between the carpet and the lower housing 112 to push the lower housing 112 to rotate. In addition, during the movement on the carpet, the fiber of the carpet will also push the lower housing up and down in the height direction, making it more difficult for dirt to accumulate. If time passes and serious accumulation of dirt occurs, the user can also manually rotate and move the lower housing 112 up and down according to the actual effect to clean the accumulated dirt.

According to some embodiments of the present disclosure, the filter cover 13 of the present disclosure is connected to the upper housing 111, and the open end of the filter cover 13 is communicated with the air outlet 1110 located on the upper housing 111; the air inlet 1120 is provided on the bottom of the lower housing 112.

Specifically, the air inlet 1120 of the present disclosure is a grid, and the grid protrudes from the inner wall of the lower housing 112.

When the lower housing 112 rotates relative to the body 10, the grid on the lower housing 112 can act as a scraping strip to scrape off foreign matter on the bottom of the filter cover 13.

In the present disclosure, at least one of the first external force and the second external force that drives the lower housing 112 to move relative to the body 10 can be provided by the resistance that the housing receives from the surface to be worked such as the carpet when the cleaning device 1 walks thereon. Of course, at least one of the first external force and the second external force can be provided by a user or other external auxiliary apparatus.

For example, in the above embodiment, referring to FIG. 2d, in the initial state, under the action of its own gravity, the lower housing 112 overlaps the step groove 100 of the body 10 through the flange 1121. When using the cleaning device of the present disclosure to clean a long-fiber carpet, due to a certain amount of interference between the detection apparatus and the carpet, when pushing the cleaning device to walk, the long fiber of the carpet will push the lower housing 112 to move upwards relative to the body 10. At the same time, when walking, a torsion force will be generated between the carpet and the lower housing 112 to push the lower housing 112 to rotate relative to the body or relative to the filter cover 13. This can prevent dust or foreign matter from accumulating between the lower housing 112 and the filter cover.

When the amount of interference between the detection apparatus and the carpet is too large and exceeds the movement range of the lower housing 112, the lower housing 112 first moves upward until it contacts the upper housing 111, see FIG. 2e. Afterwards, the carpet will push the upper housing 111 to continue moving in the direction toward the inner of the body. At this time, the lower housing 112 will push the upper housing 11 to move upward as a whole, refer to FIG. 2f, to reduce the amount of interference between the detection apparatus and the carpet and reduce the resistance when the cleaning device moves. The movement stroke of the lower housing 112 should not be too large to avoid affecting the overall floating of the detection apparatus. Preferably, the gap h does not exceed 3 mm, and more preferably, the gap h is 2.5 mm.

According to some embodiments of the present disclosure, the upper housing 111 and the lower housing 112 of the present disclosure are provided with an electric actuating apparatus, the electric actuating apparatus is configured to provide a first external force, and the first external force is used to drive the lower housing 112 to move axially relative to the upper housing 111.

In detail, referring to FIG. 2i, the electric actuator includes an electromagnet 17 provided on the upper housing 111 or the body 10, and the lower housing 112 is provided with a magnetic material that attracts the power supply magnet after being energized.

Specifically, the magnetic material can be a metal material that is magnetically adsorbed and has no magnetism itself, or it can be the magnet itself. In addition, the magnetic material can also be additionally provided on the lower housing, such as the iron ring 18 of the embodiment mentioned below, or the lower housing 112 can be partially or entirely made of ferromagnetic material.

When the electromagnet 17 is energized, the magnetic force generated by which will attract the magnetic material, and then drive the lower housing 112 to move axially toward the inside of the body 10 relative to the upper housing 11. On the contrary, when the electromagnet 17 is powered off, its adsorption force on the adsorption material disappears, and the lower housing 112 moves axially toward the outside of the body 10 to the initial position under the action of gravity.

Further, after the electromagnet 17 is powered off and the adsorption force disappears, in order to prevent the lower housing 112 from being stuck on the body 10, continue to refer to FIG. 2i. According to some embodiments of the present disclosure, a second elastic apparatus 19 is further provided between the upper housing 111 and the lower housing 112 of the present disclosure for the lower housing 112 to reset.

The second elastic apparatus 19 is specifically a spring, which can be sleeved on the filter cover 13 and one end of which can be abutted on the upper housing 111 and the other end is abutted on the iron ring 18 or other suitable position of the lower housing 112. The iron ring 18 is fixedly connected to the lower housing 112, and the iron ring 18 is an adsorption material that is attracted by the electromagnet after being energized.

When the electromagnet 17 is energized, it attracts the iron ring 18, and the iron ring 18 drives the lower housing 112 to move axially toward the inside of the body 10 relative to the upper housing 111. On the contrary, when the electromagnet 17 is powered off, the adsorption force generated by the electromagnet 17 on the iron ring 18 disappears, and the lower housing 112 moves axially toward the outside of the body 10 to the initial position under the action of its own weight and the second elastic apparatus 19.

Of course, based on the above disclosure, the electromagnet can also be provided on the lower housing, and the magnetic material can be provided on the upper housing or the body.

When the electromagnet is energized, it attracts the magnetic material, and then drives the lower housing to move axially toward the inside of the body relative to the upper housing. On the contrary, when the electromagnet is powered off, the adsorption force it generates on the adsorption material disappears, and the lower housing moves axially toward the outside of the body to the initial position under the action of gravity. In the embodiment shown in FIG. 2i, a gap h similar to that shown in FIGS. 2b and 2d-2f can also be provided between the lower housing 112 and the upper housing 111. The lower housing 112 can move up and down along the axis. Alternatively, it can also rotate reciprocally relative to the filter cover 13 when receiving a second external force.

According to some embodiments of the present disclosure, see FIG. 2k, the upper housing 111 and the lower housing 112 of the present disclosure can be connected together by a thread, and is configured to make the upper housing 111 and the lower housing 112 move relatively by rotation.

In detail, the upper housing 111 has a second connecting sleeve 1112 extending into the lower housing 112. The outer peripheral wall of the second connecting sleeve 1112 is processed with an external thread, and the inner wall of the upper housing 111 is processed with an internal thread at a corresponding position for meshing with the external thread. The external thread and the internal thread extend axially.

According to other embodiments of the present disclosure, the external thread and internal thread can also be arranged in an opposite way, that is, the inner wall of the connecting sleeve is processed with an internal thread, and the corresponding outer peripheral wall of the portion of the lower housing 112 that extends into the second connecting sleeve 1112 is processed with an external thread, and the internal and external threads extend axially.

When the second external force acts on the lower housing 112, the lower housing 112 rotates in a circumferential direction relative to the body 10 to clean accumulated dirt. Furthermore, the thread sizes of the external thread and the internal thread may be different. The thread size refers to the length of the thread along the axial direction of the detection apparatus. In the same axial direction of the detection apparatus, a gap is provided between the thread on the upper housing 111 and the thread on the lower housing 112, so that when the detection apparatus is subjected to a first external force, the lower housing 112 can move up and down along the axis. At the same time, when the detection apparatus is subjected to a second external force, the lower housing 112 can rotate reciprocally relative to the filter cover 13. According to some embodiments of the present disclosure, see FIG. 2k and FIG. 2l, the upper housing 111 and the lower housing 112 of the present disclosure are detachably connected together through a bolt (not shown in the drawings).

In detail, at least two positioning rods 1113 are provided on the upper housing 111, and two lower ear plates 1123 are provided at corresponding positions of the lower housing.

When the upper housing 111 and the lower housing 112 are assembled, the user first connects the lower housing 112 and the upper housing 111 and lock them together with bolts or screws. When a lot of dust or debris accumulated between the lower housing 112 and the filter cover 13, or after the carpet is cleaned, the user can manually remove the lower housing 112 to clean the foreign objects or dust.

As mentioned above, the cleaning device of the present disclosure senses the airflow from the carpet through the detection component to determine whether the carpet needs to be continued to be dried.

In order to allow the user to clearly understand the dryness degree of the carpet, according to an embodiment of the present disclosure, the cleaning device of the present disclosure further includes a display, which at least displays information used to represent the data detected and obtained by the humidity detection component.

According to some embodiments of the present disclosure, the display of the present disclosure can directly display the humidity value detected and obtained by the humidity detection component.

According to some embodiments of the present disclosure, referring to FIG. 2m, the display 220 of the present disclosure can also display the dryness degree in the form of a progress bar.

Specifically, a progress bar 2201 is set on the display 220. For example, with reference to the view direction of 12, the left side of the progress bar 2201 represents wetness and the right-side represents dryness; the further the progress bar is displayed toward the dry side, the drier the carpet is. When the carpet drying is completed, the progress bar fills up and the drying icon lights up.

According to some embodiments of the present disclosure, see FIG. 2n, the cleaning device of the present disclosure also includes a heating apparatus 230. The heating apparatus 230 is disposed at position between the main air outlet of the motor of the air duct and the air duct discharge outlet. The airflow in the air duct is configured to be heated by the heating apparatus and then blow to the surface to be worked through the air duct outlet.

In detail, the heating apparatus 230 is disposed in the air duct and may be an electric heater. The airflow in the air duct is heated after passing through the heating apparatus 230, and finally blows to the carpet surface through the air duct outlet to dry the carpet. The heating apparatus 230 may specifically be a PTC heating component. The PTC heating component is also called a PTC heater and is composed of a PTC ceramic heating element and an aluminum tube. This type of PTC heating element has the advantages of small thermal resistance and high heat exchange efficiency. It is an automatic constant temperature and power-saving electric heater. The outstanding feature lies in the safety performance. Under any application situation, there will be no “redness” phenomenon on the surface of electric heating tube heaters, which may cause burns, fires and other safety hazards.

The PTC heating component can be installed at a position near the air duct outlet to ensure that the heated airflow can be blown directly to the carpet through the air duct outlet to avoid heat loss.

With the cleaning device of the present disclosure, the user first cleans the carpet through the floor brush component, and then starts the drying mode to dry the carpet after the carpet is cleaned. The body 10 is provided with a drying button near the handle. When drying is required, the user can press the drying button and the cleaning device enters the drying mode. In order to facilitate understanding, the working process of the cleaning device and the changes in temperature and humidity are described in detail below with reference to FIG. 2o.

After the detection component of the cleaning device detects the airflow parameter, it can divide the temperature change curve into a falling area, a stable area, and a rising area, and fit the humidity change curve into a rising area and a falling area. In addition, whether the cleaning device is in a stationary or motion state can be obtained through the Hall sensor installed on the walking wheel of the cleaning device. From this, the movement process of the cleaning device can also be fitted to the curve shown in FIG. 2o.

The cleaning device can divide the carpet humidity situation into the following situations by comprehensively judging the changing trends of temperature and humidity:

In the initial state, the cleaning device starts to preheat. After preheating is completed:
(1) The cleaning device begins to clean the carpet. During this process, since the floor brush component cleans the carpet by adding water, the temperature gradually decreases and the humidity gradually increases;
(2) After cleaning to a certain extent, the temperature continues to drop and the humidity continues to rise (it is still in the cleaning stage at this time);
(3) The temperature continues to drop, and the humidity reaches the maximum. At this stage, the cleaning process ends, the peristaltic pump stops working, no more water is sprayed, and the humidity reaches the maximum value;
(4) At this stage, the drying mode is turned on. Since hot air has been blowing to the carpet during the cleaning stage, the temperature of the carpet is stable at this stage, and the humidity begins to decrease, which indicates that the carpet is being dried;
(5) After the drying mode continues for a certain duration, due to the reduction of water vapor, the temperature rises slightly and the humidity drops;
(6) During this stage, the temperature still rises slightly and the humidity continues to fall.

Items (1), (2) and (3) in the description of temperature and humidity changes are the cleaning mode of the cleaning device. The user can achieve continuous cleaning of a certain area of the carpet through the reciprocating movement of the cleaning device on the carpet. Items (4), (5) and (6) in the description of temperature and humidity changes are the drying mode of the cleaning device. In the drying mode, the cleaning device no longer cleans the carpet, but only discharges high-temperature airflow to the carpet and the reciprocating movement of the cleaning device allows the air duct outlet to dry a certain carpet area. In the above embodiment, in the cleaning mode, the heating apparatus 230 operates, and hot air is emitted from the air duct outlet. Of course, the heating apparatus 230 does not need to be started in the cleaning mode. Based on the above situation, in order to know the drying condition of the carpet, the present disclosure provides a set of experimental data in conjunction with Table 1 to exemplarily demonstrate the setting process of the carpet dryness.

TABLE 1

| | | | | |
|---|---|---|---|---|
| | brief description | carpet water | | |
| experiment | of the experimental | volume per | personal | |
| number | scheme | unit area (g/m²) | feeling | note |

| | | | |
|---|---|---|---|
| 1 | the machine sprays | 135.1 | |
| | water 4 times back and | | |
| | forth to wet the carpet | | |
| | the machine dries 8 | 48.5 | the carpet |
| | times | | is dry |
| 2 | the machine sprays | 140.6 | |
| | water 4 times back and | | |
| | forth to wet the carpet | | |
| | the machine dries 8 | 51.7 | the carpet |
| | times | | is dry |
| 3 | the machine sprays | 150.3 | |
| | water 4 times back and | | |
| | forth to wet the carpet | | |
| | the machine dries 5 | 91.7 | acceptable |
| | times | | dryness |

test method: standard laboratory drying method
test carpet: standard carpet used in laboratory test WET CE & carpet drying test

It can be understood that the change in dryness of the carpet in the drying mode is related to the amount of water sprayed on the carpet in the cleaning mode, see Table 1.

### Experiment 1

In the cleaning mode, after the cleaning device sprays water back and forth four times to wet the carpet, the water volume per unit area of the carpet is 135.1 g/m3. In drying mode, the cleaning device moves eight times back and forth to dry the carpet. At this time, the amount of water per unit area of the carpet is detected to be 48.5 g/m3, which can be sensed by human hand touch. At this time, the carpet has reached the dryness degree considered by traditional sensing methods.

### Experiment 2

In the cleaning mode, after the cleaning device sprays water back and forth four times to wet the carpet, the water volume per unit area of the carpet is 140.6 g/m3. In drying mode, the cleaning device moves eight times back and forth over a certain area of the carpet to dry the carpet. At this time, the amount of water per unit area of the carpet was detected to be 51.7 g/m3, which was sensed by human hand touch. At this time, the carpet reached the dryness degree considered by traditional sensing methods.

### Experiment 3

In the cleaning mode, after the cleaning device sprays water back and forth to wet the carpet four times, the water volume per unit area of the carpet is 150.3 g/m3. In drying mode, the cleaning device moves back and forth five times on a certain area of the carpet to dry the carpet. At this time, the amount of the water per unit area of the carpet was detected to be 91.7 g/m3, which was sensed by human hand touch. At this time, the carpet reached an acceptable level considered by traditional sensing methods. Based on the above experiments, the present disclosure can quantify the data detected and obtained by the detection component. For example, after drying for 5 times, the dryness degree is considered acceptable. At this time, the quantified residual water value of the carpet is about 90 g/m². After drying for 8 times, the carpet is considered dry. The quantified residual water value of the carpet at this time is about 50 g/m². In this way, a correlation is established between the detected humidity value and the dryness degree of the carpet, so that the humidity value detected and obtained by the detection component can be displayed on the display 220 in the form of a progress bar, which can be displayed to the user more intuitively and improve the user's experience.

### Application Scenario 1

In order to facilitate a clearer understanding, the working principle of the cleaning device of the present disclosure will be described in detail below with reference to FIGS. 2a and 2b, taking an application scenario as an example.

The motor connected to the air duct is started to deliver airflow into the air duct through the air duct suction port. The airflow is heated by the heating apparatus. The heated high-temperature airflow is blown onto the carpet through the air duct outlet to dry the wet carpet.

At the same time, the airflow in the air duct forms a negative pressure in the inner cavity 110 of the housing 11 of the detection apparatus. Under the action of the pressure difference between the inside and outside of the housing 11, the airflow in the area being dried on the carpet passes through the air inlet 1120 on the housing 11, and is sucked into the inner cavity 110 of the housing 11, and then enters the filter cover 13 after being filtered by the filter cover 13. The detection component 12 located in the filter cover 13 detects the humidity parameter of the airflow which is finally displayed on the display in a form of a humidity value or drying progress the bar. Users can know the drying state of the carpet in real time through the display, without having to repeatedly bend over and use their limbs to judge the dryness degree of the carpet, which greatly improves user experience and comfort.

### Application Scenario 2

When the user uses the cleaning device to clean and dry the short-fiber carpet, there is a gap between the lower housing of the detection apparatus and the carpet on the short-fiber carpet, and there is no interference between the two, or the amount of interference is not large. At this time, the detection apparatus is in the lowest position under the action of its own gravity and the first elastic apparatus. At this time, the sensing distance of the detection component can be less than 8 mm, which can effectively ensure the sensitivity of humidity detection.

### Application Scenario 3

When the user uses the cleaning device to clean and dry long-fiber or super-long-fiber carpets, interference is formed between the lower housing of the detection apparatus and the carpet on this type of carpet. For example, the amount of interference between the two, when the cleaning device is walking, the carpet can push the lower housing to move the entire detection apparatus in the direction towards the inside of the body, and lift the detection apparatus upward to avoid the large movement resistance caused by too much interference (push and pull force when using the product) and scratching the baseboard or carpet.

At present, the drying function of cleaning machines (such as floor cleaning machines, carpet cleaning machines, tablecloth cleaning machines, etc.) mainly uses constant temperature as the control target, that is, the program sets a fixed temperature, and the cleaning machine adjusts the heating element to make the temperature reaches the set range according to the data from the temperature sensor during the cleaning machine drying the object to be dried (such as the floor).

Although the drying method of this cleaning machine is simple and efficient, it lacks universality. Some objects to be dried (such as floors, carpets, tablecloths, etc.) will be damaged when dried at a constant temperature, or the drying efficiency is low at constant temperature for some objects to be dried (such as floors, carpets, tablecloths, etc.) at constant temperature.

In order to solve such problems, embodiments of the present disclosure provide a cleaning machine (such as a floor cleaning machine, a carpet cleaning machine, a tablecloth cleaning machine, etc.), which includes: a main body, a (AC) motor and a power adjustment system thereof, a humidity detection system (such as humidity sensor), a heating element, an air suction port, and air blowing port. In addition, the cleaning machine can also include an air duct component, a motion detection system, an MCU, a WIFI module, etc., where the air duct component cooperates with the motor to form the air suction port and the blowing port.

Specifically, the heating element is used to generate heat, such as a PTC device, etc.; the temperature sensor is used to detect the temperature of the air outlet of the heating element, such as NTC, etc.; the air duct assembly cooperates with the motor to form the air suction port and the blowing port; a humidity detection system (such as a humidity sensor) is used to detect the humidity of the surface to be cleaned (that is, the surface to be clean of an object to be dried, such as the floor, the carpet, the tablecloth, etc.), and the humidity detection system (such as a humidity sensor) is set at the air suction outlet, specifically used to detect the humidity of the surface to be cleaned at the air suction outlet (that is, the surface to be cleaned of the object to be dried, such as the floor, the carpet, the tablecloth, etc.) to detect whether the object to be dried (such as the floor, the carpet, the tablecloth, etc.) is in a dry state; the motion detection system is used to detect whether the whole cleaning machine is in motion state; MCU is used for coordinated control of each module; WIFI module communicates with terminal (such as mobile phone) APP to allow users to actively control the drying temperature.

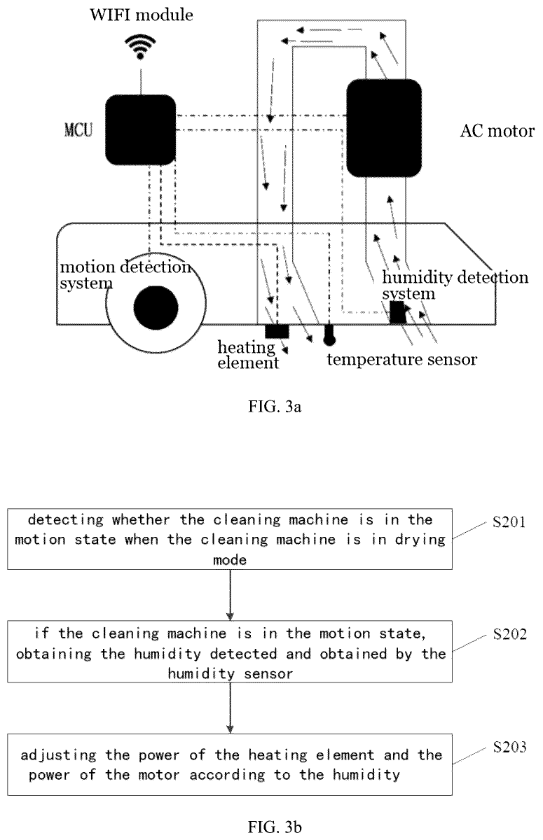

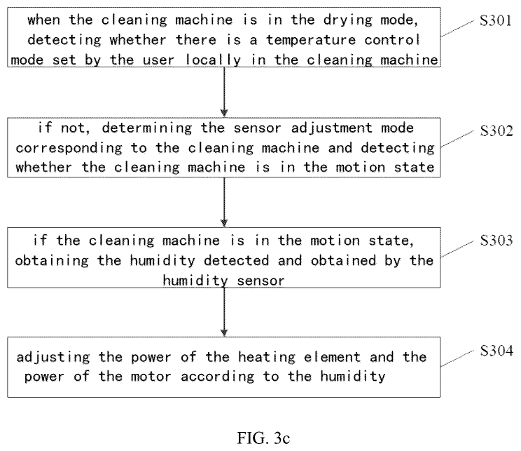

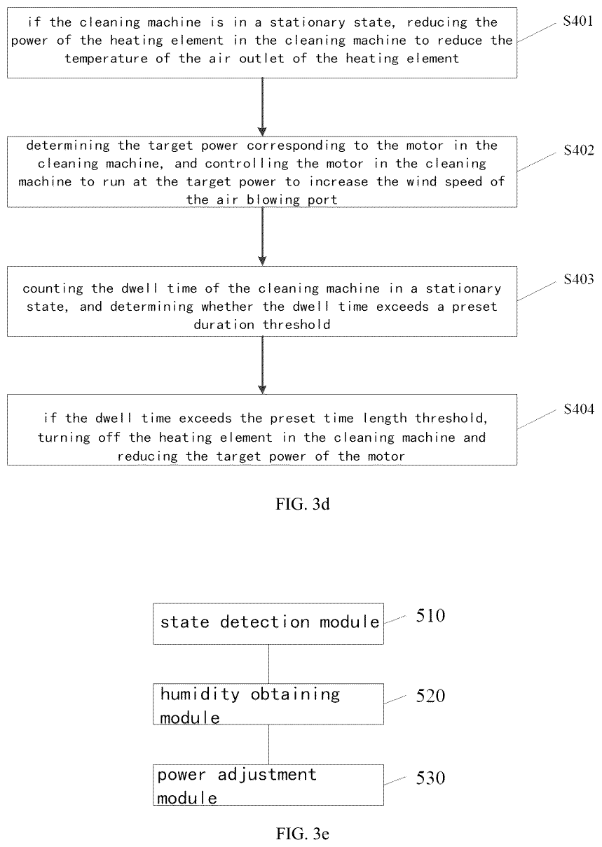

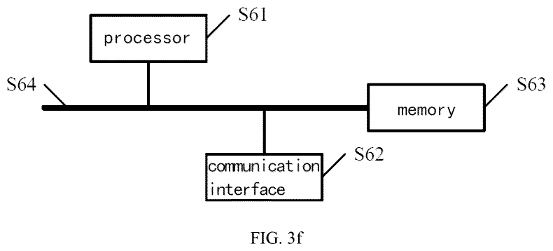

As shown in FIG. 3a, modules such as the eating element, the temperature sensor, the humidity detection system (such as humidity sensors), and the motion detection system are installed on the base of the cleaning machine. The suction port and the blowing port formed by modules such as the (AC) motor and the air duct component (not shown in FIG. 3a) are also integrated into the base of the cleaning machine.

In the process of the user actually using the cleaning machine (such as floor cleaning machine, carpet cleaning machine, tablecloth cleaning machine, etc.) to dry the object to be dried (such as floors, carpets, tablecloths, etc.), the cleaning machine is set to drying mode. When the cleaning machine is in drying mode, the cleaning machine is detected whether in a motion state by the above motion detection system. If the cleaning machine is in the motion state, the humidity detected and obtained by the humidity sensor can be obtained, and the power of the heating element and the power of the motor in the cleaning machine can be adjusted based on the humidity, allowing the drying temperature to be adjusted according to the actual working conditions, which improves the drying efficiency and avoids damage to the object to be dried, thus having better universal applicability.

Specifically, as shown, FIG. 3b is a schematic flowchart of a cleaning machine drying method provided by an embodiment of the present disclosure. This method is applied to a cleaning machine (such as a carpet cleaning machine), and may specifically include the following steps:
S201: detecting whether the cleaning machine is in the motion state when the cleaning machine is in drying mode.

In the embodiment of the present disclosure, a cleaning machine, such as the carpet cleaning machine, is generally provided with a drying function. When the user wants to use the drying function of the cleaning machine, the user can choose to set the cleaning machine to drying mode. For example, the user sets the carpet cleaning machine to drying mode.

When the cleaning machine is in drying mode, the above motion detection system can be used to detect whether the cleaning machine is in in the motion state. For example, when the carpet cleaning machine is in drying mode, the above motion detection system can be used to detect whether the carpet cleaning machine is in the motion state.

It should be noted that the motion state can be understood as whether the cleaning machine is moving. For example, when the user pushes and pulls the carpet cleaning machine, the carpet cleaning machine is in a motion state, which is not limited in the embodiments of the present disclosure.
S202: if the cleaning machine is in the motion state, obtaining the humidity detected and obtained by the humidity sensor.

In the embodiment of the present disclosure, for the cleaning machine, if the cleaning machine is in the motion state, the humidity detected and obtained by the humidity sensor can be obtained at this time. The humidity sensor here is used to detect the humidity of the surface to be cleaned, specifically, obtaining the humidity of the surface to be cleaned detected and obtained by the humidity sensor.

The humidity sensor can be arranged at the air suction port, and then the humidity of the surface to be cleaned (that is, the surface to be cleaned of the object to be dried, such as floors, carpets, tablecloths, etc.) at the air suction port can be obtained by the humidity sensor at the air suction port. The wetter the object to be dried (such as floors, carpets, tablecloths, etc.), the greater the humidity. The drier the object to be dried (such as floors, carpets, tablecloths, etc.), the smaller the humidity, which is not limited by the embodiments of the present disclosure.

For example, in the embodiment of the present disclosure, for a carpet cleaning machine, if the carpet cleaning machine is in the motion state, it indicates that the user is pushing or pulling the carpet cleaning machine. At this time, the humidity of the carpet surface to be cleaned at the air blowing port is detected by the humidity sensor is obtained. Specifically, the wetter the carpet, the greater the humidity, and the drier the carpet, the lower the humidity.
S203: adjusting the power of the heating element and the power of the motor according to the humidity.

In the embodiment of the present disclosure, for the humidity of the surface to be cleaned (that is, the surface to be cleaned of the object to be dried, such as floors, carpets, tablecloths, etc.) at the air blowing port detected and obtained by the humidity sensor, the powers of the heating element and the motor in the cleaning machine can be adjusted according to the humidity. For example, for the humidity of the carpet surface to be cleaned at the air blowing port detected and obtained by the humidity sensor, the power of the heating element in the carpet cleaning machine can be adjusted according to the humidity, so that the temperature of the air outlet of the heating element rises. According to the humidity, the power of the heating element in the carpet cleaning machine can be adjusted, so that the wind speed of the air blowing port increases.

It should be noted that the powers of the heating element and the motor in the cleaning machine are positively correlated with the influence of humidity. As the humidity increases, indicating the object to be dried (such as floors, carpets, tablecloths, etc.) is wetter, the power of the heating element in the cleaning machine is adjusted to increase, causing the temperature of the air outlet of the heating element to rise (but the temperature cannot exceed the upper limit value Tmax). Increasing the power of the motor in the cleaning machine causes the wind speed at the air blowing port to increase. As the humidity decreases, indicating the object to be dried (such as floors, carpets, tablecloths, etc.) is drier, the power of the heating element in the cleaning machine is adjusted to decrease, causing the wind speed at the air blowing port to increase. Decreasing the power of the motor in the cleaning machine causes the wind speed at the air blowing port to decrease, which is not limited in the embodiments of the present disclosure.

The technical solution provided by the embodiment of the present disclosure, which is applied to a cleaning machine, is described in above. The cleaning machine includes a main body, a motor, a humidity sensor, an air suction port, and a blowing port. The humidity sensor is used to detect the humidity of the surface to be cleaned. When the cleaning machine is in the drying mode, whether the cleaning machine is in the motion state is detected. If the cleaning machine is in the motion state, the humidity detected by the humidity sensor is obtained. According to the humidity, the powers of the heating element and the motor in the cleaning machine are adjusted.

Through the humidity detected and obtained by the humidity sensor, adjusting the powers of the heating element and the motor in the cleaning machine can adjust the drying temperature according to the actual working conditions, improve the drying efficiency, avoid damage to the object to be dried, and thus have a better universality.

In addition, in order to allow users to perform personalized settings and enhance user experience, as shown, FIG. 3c is a schematic flowchart of another cleaning machine drying method provided by an embodiment of the present disclosure. This method is applied to cleaning machines (such as carpet cleaning machine), which may include the following steps:
S301. when the cleaning machine is in the drying mode, detecting whether there is a temperature control mode set by the user locally in the cleaning machine, where the temperature control mode set by the user is determined and sent to the cleaning machine to save.

In the embodiment of the present disclosure, two adjustment modes are provided: sensor adjustment mode and user adjustment mode. In the user adjustment mode, the user actively controls the temperature, so that the user can select constant temperature mode on the terminal (such as a mobile phone) APP (or on the cleaning machine), or to select or select automatic adjustment mode. The constant temperature mode allows the user to set the corresponding heating temperature according to the nature of the object to be dried (such as carpet). At this time, the MCU will adjust the temperature of the air outlet of the heating element to the heating temperature set by the user based on the temperature sensor.

When the user selects the automatic adjustment mode, the user only needs to set the maximum temperature upper limit value Tmax_usr. Of course, the user can also choose the program default Tmax. All settings have a memory function. Therefore, the terminal (or cleaning machine) can determine the temperature control mode (constant temperature mode or automatic adjustment mode) set by the user and the corresponding temperature of the temperature control mode (heating temperature, Tmax_usr, or Tmax), and send them to the cleaning machine for storage. Here the user adjustment method has higher priority than the sensor adjustment method.

Based on this, during the actual use of the cleaning machine, the user can choose to set the cleaning machine to drying mode. For example, the user sets the carpet cleaning machine to drying mode. When the cleaning machine is in drying mode, the cleaning machine is first detected locally whether there is a temperature control mode set by the user, which means determining whether the user has set the corresponding temperature control mode, and then based on the detection results, it is decided whether to implement the user adjustment method or the sensor adjustment method.

For example, during the actual use of the carpet cleaning machine, the user can choose to set the carpet cleaning machine to drying mode to dry the carpet. When the carpet cleaning machine is in drying mode, first detect whether the carpet cleaning machine exists locally. The temperature control mode set by the user means determining whether the user has set the corresponding temperature control mode, so as to decide whether to execute the user adjustment method or the sensor adjustment method based on the detection results.
S302, if not, determining the sensor adjustment mode corresponding to the cleaning machine and detecting whether the cleaning machine is in the motion state.
S303: if the cleaning machine is in the motion state, obtaining the humidity detected and obtained by the humidity sensor.
S304: adjusting the power of the heating element and the power of the motor according to the humidity.

In the embodiment of the present disclosure, if the temperature control mode set by the user does not exist locally in the cleaning machine, the sensor adjustment mode is entered at this time, which can be considered as the default adjustment mode of the program. The user does not participate in temperature control. By using the sensor to control the temperature, the corresponding sensor adjustment method of the cleaning machine can be determined. The cleaning machine is detected whether in the motion state through the above-mentioned motion detection system.

If the cleaning machine is in the motion state, the humidity of the surface to be cleaned detected and obtained by the humidity sensor at the suction port can be obtained. For the humidity of the surface to be cleaned detected and obtained by the humidity sensor at the air blowing port, the powers of the heating element and the motor in the cleaning machine can be adjusted based on the humidity.

In addition, in the embodiment of the present disclosure, if a temperature control mode set by the user is stored locally in the cleaning machine, it is considered that the user has participated in the temperature control. At this time, it is further detected whether the temperature control mode is a constant temperature mode. If the temperature control mode is a constant temperature mode, it is determined the corresponding user adjustment method of the cleaning machine, obtaining the heating temperature corresponding to the constant temperature mode, and adjusting the power of the heating element in the cleaning machine, so that the temperature of the air outlet of the heating element reaches the heating temperature, thus maintaining a constant temperature.

For example, in the embodiment of the present disclosure, if a temperature control mode set by the user is stored locally in the carpet cleaning machine, it is considered that the user has participated in the temperature control. At this time, it is further detected whether the temperature control mode is a constant temperature mode. If the temperature control mode is a constant temperature mode, it is determined the corresponding user adjustment method of the carpet cleaning machine, obtaining the heating temperature corresponding to the constant temperature mode, and adjusting the power of the heating element in the carpet cleaning machine, so that the temperature of the air outlet of the heating element reaches the heating temperature, thus maintaining a constant temperature.

If the temperature control mode is the automatic adjustment mode, it is determined the user adjustment mode corresponding to the cleaning machine, and detect whether the cleaning machine is in motion through the above motion detection system. If the cleaning machine is in the motion state, the humidity of the surface to be cleaned detected and obtained by the humidity sensor at the suction port can be obtained. For the humidity of the surface to be cleaned detected and obtained by the humidity sensor at the air blowing port, the powers of the heating element and the motor in the cleaning machine can be adjusted based on the humidity.

For example, if the temperature control mode is the automatic adjustment mode, it is determined that the user adjustment method corresponding to the cleaning machine, which is similar to the sensor adjustment method, that is, through the above-mentioned motion detection system, it is detected whether the carpet cleaning machine is in the motion state. If the carpet cleaning machine is in the motion state, the humidity of the carpet surface to be cleaned at the suction port detected and obtained by the humidity sensor can be obtained, at this time. Regarding the humidity of the carpet surface to be cleaned at the air blowing port detected and obtained by the humidity sensor, the powers of the heating element and the motor in the carpet cleaning machine can be adjusted based on the humidity.

In addition, in the embodiment of the present disclosure, the powers of the heating element and the motor in the cleaning machine are positively correlated with the influence of humidity. Specifically, the powers of the heating element and the motor in the cleaning machine can be adjusted in the following ways:
if the humidity increases, determining the first power of the heating element in the cleaning machine corresponding to the humidity, and increasing the power of the heating element in the cleaning machine to the first power; determining the second power of the motor in the cleaning machine corresponding to the humidity, and increasing the power of the heating element in the cleaning machine to the first power.

For example, if the humidity increases, it means that the carpet humidity increases. The power of the heating element in the carpet cleaning machine is positively correlated with the influence of humidity. Based on this, the first power of the heating element in the carpet cleaning machine corresponding to the humidity can be determined, thereby increasing the power of the heating element in the cleaning machine as the first power.

Similarly, the power of the motor in the carpet cleaning machine is positively correlated with the influence of humidity. Based on this, the second power of the motor in the carpet cleaning machine corresponding to the humidity can be determined, and the power of the motor in the carpet cleaning machine can be increased to the second power. As the humidity increases, the humidity of the carpet increases. At this time, the powers of the heating element and the motor in the carpet cleaning machine can be increased.

Specifically, in the embodiment of the present disclosure, in order to protect the object to be dried from damage, such as burning carpets, during the process of increasing the power of the heating element in the cleaning machine, it is necessary to set a heating upper limit temperature to ensure that the temperature of air blowing port pf the heating element in the cleaning machine cannot exceed the heating upper limit temperature. Based on this, the embodiment of the present disclosure specifically increases the power of the heating element in the cleaning machine in the following ways:
obtaining the heating upper limit temperature and the current temperature of the air outlet of the heating element in the cleaning machine, and determining whether the current temperature is less than the heating upper limit temperature; if the current temperature is less than the heating upper limit temperature, increasing the power of the heating element in the cleaning machine to the first power, where, during the process of increasing the power of the heating element in the cleaning machine, if the temperature of the air outlet of the heating element in the cleaning machine is equal to the heating upper limit temperature, the increase will stop, so that the temperature of the air outlet of the heating element in the cleaning machine can be maintained to do not exceed the heating upper limit temperature.

For example, in the embodiment of the present disclosure, the heating upper limit temperature Tmax and the current temperature T of the air outlet of the heating element in the carpet cleaning machine are obtained, and it is determined whether the current temperature T is less than the heating upper limit temperature Tmax. If the current temperature T is less than the heating upper limit temperature Tmax, the power of the heating element in the carpet cleaning machine is increased to the first power, otherwise the power of the heating element in the cleaning machine is no longer increased. Specifically, in the process of increasing the power of the heating element in the carpet cleaning machine, if the temperature of the air outlet of the heating element in the carpet cleaning machine is equal to the heating upper limit temperature Tmax, the increase will stop, so that the temperature of the air outlet of the heating element in the cleaning machine can be maintained to do not exceed the heating upper limit temperature Tmax.

It should be noted that the above heating upper limit temperature can be the program default heating upper limit temperature Tmax in the sensor adjustment mode, of course it can also be the heating upper limit temperature Tmax_usr in the user adjustment mode, or the system default selected by the user in the user adjustment mode, which is not limited in the embodiments of the present disclosure.

If the humidity decreases, the third power of the heating element in the cleaning machine corresponding to the humidity is determined, and the power of the heating element in the cleaning machine is reduced to the third power; the fourth power of the motor in the cleaning machine corresponding to the humidity is determined, and the power of the heating element in the cleaning machine is reduced to the fourth power.

For example, if the humidity decreases, it means that the carpet humidity decreases. The power of the heating element in the carpet cleaning machine is positively correlated with the influence of humidity. Based on this, the third power of the heating element in the carpet cleaning machine corresponding to the humidity can be determined, so as to decrease the power of the heating element in the carpet cleaning machine to the third power.

Similarly, the power of the motor in the carpet cleaning machine is positively correlated with the influence of humidity. Based on this, the fourth power of the motor in the carpet cleaning machine corresponding to the humidity can be determined, thereby reducing the power of the motor in the carpet cleaning machine to the fourth power. As the humidity decreases, the humidity of the carpet decreases. At this time, the powers of the heating element and the motor in the carpet cleaning machine can be reduced.

Through the above description of the technical solution provided by the embodiment of the present disclosure, in the embodiment of the present disclosure, two adjustment modes are provided: a sensor adjustment mode and a user adjustment mode. In the user adjustment mode, the user actively controls the temperature, and in the sensor adjustment mode, the sensor actively controls the temperature, which allows users to make personalized settings and enhance user experience. The powers of the heating element and the motor in the cleaning machine are adjusted accordingly according to the humidity, so that the drying temperature can be adjusted according to actual working conditions, which improves drying efficiency and avoids damage to the object to be dried, thus having better universal applicability.

In addition, in order to effectively prevent the object to be dried from being damaged due to overheating and correspondingly reduce the noise of the whole machine, as shown, FIG. 3d is a schematic flowchart of an implementation of another cleaning machine drying method shown in the embodiment of the present disclosure, which is applied to cleaning machine (such as carpet cleaning machines), and may include the following steps:
S401. if the cleaning machine is in a stationary state, reducing the power of the heating element in the cleaning machine to reduce the temperature of the air outlet of the heating element.
S402: determining the target power corresponding to the motor in the cleaning machine, and controlling the motor in the cleaning machine to run at the target power to increase the wind speed of the air blowing port.

In the embodiment of the present disclosure, the cleaning machine, such as carpet cleaning machines, is generally provided with a drying function. When the user wants to use the drying function of the cleaning machine, the user can choose to set the cleaning machine to drying mode. For example, the user sets the carpet cleaning machine to drying mode.

When the cleaning machine is in drying mode, the above motion detection system can be used to detect whether the cleaning machine is in the motion state. For example, when the carpet cleaning machine is in drying mode, the above motion detection system can be used to detect whether the carpet cleaning machine is in the motion state.

In the embodiment of the present disclosure, for the cleaning machine, if the cleaning machine is not in the motion state, that is, the cleaning machine is in a stationary state, at this time, in order to avoid damage to the object to be dried due to over-temperature heating, the power of the heating element in the cleaning machine is reduced, so that the temperature of the air outlet of the heating element decreases.

Correspondingly, the target power corresponding to the motor in the cleaning machine is determined. The target power here is a relatively large power, so that the motor in the cleaning machine can be controlled to run at the target power to increase the wind speed of the air blowing port, thus avoiding the object to be dried form damaging due to overheating.

It should be noted that the stationary state can be understood as the cleaning machine is not moving. For example, when the user pushes and pulls the carpet cleaning machine, the pushing and pulling cleaning machine stops at a certain position. At this time, the carpet cleaning machine is in a stationary state, which is not limited in the embodiments of the present disclosure.

For example, for a carpet cleaning machine, if the carpet cleaning machine is not in the motion state, it means that the carpet cleaning machine is in a stationary state. At this time, in order to avoid damage to the carpet due to overheating, the power of the heating element in the carpet cleaning machine is reduced, so that the temperature of the air outlet of the heating component decreases.

At the same time, the target power corresponding to the motor in the carpet cleaning machine can be determined. The target power is a relatively large power, so that the motor in the carpet cleaning machine can be controlled to run at the target power to increase the wind speed of the air blowing port. This will prevent the carpet from being damaged by overheating.
S403: counting the dwell time of the cleaning machine in a stationary state, and determining whether the dwell time exceeds a preset duration threshold.
S404: if the dwell time exceeds the preset time length threshold, turning off the heating element in the cleaning machine and reducing the target power of the motor.

In the embodiment of the present disclosure, in order to reduce the overall noise of the cleaning machine, a timeout mechanism is set up. Based on this, the dwell time of the cleaning machine in a stationary state can be counted, and whether the dwell time exceeds the preset duration threshold can be determined. If the dwell time exceeds the preset duration threshold, the heating element in the cleaning machine will be turned off and the target power of the motor in the cleaning machine will be reduced. Turning off the heating element in the cleaning machine here can further prevent the object to be dried from being damaged due to overheating. In addition, reducing the target power of the motor in the cleaning machine can reduce the overall noise of the cleaning machine.

For example, in the embodiment of the present disclosure, the dwell time t1 when the carpet cleaning machine is in a stationary state is counted, and whether the dwell time t1 exceeds the preset duration threshold t is determined. If the dwell time t1 exceeds the preset duration threshold t, the carpet cleaning machine is turned off. The heating element can further prevent the carpet from being damaged due to over-temperature heating. At the same time, reducing the target power of the motor in the cleaning machine can reduce the overall noise of the cleaning machine. In this way, in the sensor adjustment mode or the automatic adjustment mode set in the user adjustment mode, the carpet cleaning machine can have better drying efficiency while also protecting the carpet to the greatest extent from overheating damage, and the overall machine noise is reduced.

Through the above description of the technical solutions provided by the embodiments of the present disclosure, if the cleaning machine is in a stationary state, the power of the heating element in the cleaning machine is reduced to reduce the temperature of the air outlet of the heating element, and the target power corresponding to the motor in the cleaning machine is determined, and the motor in the cleaning machine is controlled to run at the target power to increase the wind speed of the air blowing port, the dwell time of the cleaning machine in the stationary state is counted, and whether the dwell time exceeds the preset duration threshold is determined. If the dwell time exceeds the preset duration threshold, then the heating element in the cleaning machine is turned off to reduce the target power of the motor. This can protect the carpet to the greatest extent, from overheating damage, and also the noise of the entire machine is reduced.

Corresponding to the above method embodiments, embodiments of the present disclosure also provide a cleaning machine drying apparatus, as shown in FIG. 3e, which can be applied to a cleaning machine. The cleaning machine includes a main body, a motor, a humidity sensor, and a heating element, an air suction port, an air blowing port. The humidity sensor is used to detect the humidity of the surface to be cleaned. The apparatus may include: a state detection module 510, a humidity obtaining module 520, and a power adjustment module 530.

The state detection module 510 is used to detect whether the cleaning machine is in a motion state when the cleaning machine is in drying mode.

The humidity obtaining module 520 is used to obtain the humidity detected and obtained by the humidity sensor if the cleaning machine is in the motion state.

The power adjustment module 530 is used to adjust the power of the heating element and the power of the motor according to the humidity.

The embodiment of the present disclosure also provides a cleaning machine, as shown in FIG. 3f, including a processor S61, a communication interface S62, a memory S63, and a communication bus S64. The processor S61, the communication interface S62, and the memory S63 communicate mutually through the communication bus S64.

The memory S63 is used to store computer programs.

The processor S61 is used to implement the following steps when executing the program stored in the memory S63:
when the cleaning machine is in drying mode, detecting whether the cleaning machine is in the motion state; if the cleaning machine is in the motion state, obtaining the humidity detected and obtained by the humidity sensor; adjusting the power of the heating element and the power of the motor.

The communication bus mentioned in the above-mentioned cleaning machine may be a Peripheral Component Interconnect (PCI) bus or an Extended Industry Standard Architecture (EISA) bus, etc. The communication bus can be divided into address bus, data bus, control bus, etc. For ease of presentation, only one thick line is used in the figure, but it does not mean that there is only one bus or one type of bus.

The communication interface is used for communication between the above-mentioned cleaning machine and other device.

The memory may include random access memory (RAM) or non-volatile memory (non-volatile memory), such as at least one disk memory. Optionally, the memory may also be at least one storage device located far away from the aforementioned processor.

The above-mentioned processor can be a general-purpose processor, including a central processing unit (Central Processing Unit, referred to as CPU), a network processor (Network Processor, referred to as NP), etc.; it can also be a digital signal processor (Digital Signal Processing, referred to as DSP), Application Specific Integrated Circuit (ASIC for short), Field-Programmable Gate Array (FPGA for short) or other programmable logic devices, discrete gate or transistor logic devices, and discrete hardware components.

In yet another embodiment provided by the present disclosure, a storage medium is also provided. Instructions are stored in the storage medium. When run on a computer, the computer is caused to execute the cleaning machine drying method described in any of the above embodiments.

In yet another embodiment provided by the present disclosure, a computer program product containing instructions is also provided, which when run on a computer causes the computer to execute the cleaning machine drying method described in any of the above embodiments.

This embodiment discloses E1, a cleaning machine drying method, which is applied to the cleaning machine. The cleaning machine includes a main body, a motor, a humidity sensor, a heating element, an air suction port, and an air blowing port. The humidity sensor is used to detect surface to be cleaned humidity, the method includes: when the cleaning machine is in drying mode, detecting whether the cleaning machine is in the motion state;
if the cleaning machine is in the motion state, obtaining the humidity detected and obtained by the humidity sensor;
adjusting the power of the heating element and the power of the motor according to the humidity.

E2. In the method described in E1, before detecting whether the cleaning machine is in the motion state, the method further includes:
detecting whether the temperature control mode set by the user exists locally in the cleaning machine, wherein the temperature control mode set by the user is determined and sent to the cleaning machine for storage;
if not, determining the sensor adjustment mode corresponding to the cleaning machine, and executing the step of detecting whether the cleaning machine is in the motion state.

E3. In the method described in E2, the method further includes:
if there is a temperature control mode set by the user locally in the cleaning machine, detecting whether the temperature control mode is a constant temperature mode; if the temperature control mode is the constant temperature mode, determining the user adjustment mode corresponding to the cleaning machine and obtaining the heating temperature corresponding to the constant temperature mode;
adjusting the power of the heating element in the cleaning machine so that the temperature of the air outlet of the heating element reaches the heating temperature.

E4. In the method described in E3, the method further includes:
if the temperature control mode is an automatic adjustment mode, determining the user adjustment mode corresponding to the cleaning machine, and jumping to the step of detecting whether the cleaning machine is in the motion state.

E5. In the method described in E1, the powers of the heating element and the motor in the cleaning machine change in a positive correlation due to the influence of the humidity;
adjusting the power of the heating element and the power of the motor according to the humidity includes:
   if the humidity increases, determining a first power of the heating element in the cleaning machine corresponding to the humidity, increasing the power of the heating element in the cleaning machine to the first power; determining a second power of the motor in the cleaning machine corresponding to the humidity, increasing the power of the motor in the cleaning machine to the second power;
   if the humidity decreases, determining a third power of the heating element in the cleaning machine corresponding to the humidity, and reducing the power of the heating element in the cleaning machine to the third power;
   determining a fourth power of the motor in the cleaning machine corresponding to the humidity, and reducing the power of the motor in the cleaning machine to the fourth power.

E6. In the method described in E5, increasing the power of the heating element in the cleaning machine to the first power includes:
obtaining the heating upper limit temperature and the current temperature of the air outlet of the heating element in the cleaning machine, and determining whether the current temperature is less than the heating upper limit temperature;
if the current temperature is less than the heating upper limit temperature, increasing the power of the heating element in the cleaning machine to the first power;
wherein, during the process of increasing the power of the heating element in the cleaning machine, if the temperature of the air outlet of the heating element in the cleaning machine is equal to the heating upper limit temperature, the increase will stop.

E7. In any one of the methods E1 to E6, the method further includes:
if the cleaning machine is in a stationary state, reducing the power of the heating element in the cleaning machine to reduce the temperature of the air outlet of the heating element;
determining the target power corresponding to the motor in the cleaning machine, and controlling the motor in the cleaning machine to run at the target power to increase the wind speed of the air blowing port;
counting the dwell time of the cleaning machine in a stationary state, and determining whether the dwell time exceeds a preset duration threshold;
if the dwell time exceeds the preset time threshold, turning off the heating element in the cleaning machine and reducing the target power of the motor.

The embodiment of the present disclosure discloses E8, a cleaning machine drying apparatus, which is applied to a cleaning machine. The cleaning machine includes a main body, a motor, a humidity sensor, a heating element, an air suction port, and an air blowing port. The humidity sensor is used to detect the humidity of the surface to be cleaned, the apparatus includes:
a state detection module, used to detect whether the cleaning machine is in the motion state when the cleaning machine is in drying mode;
a humidity obtaining module, used to obtain the humidity detected and obtained by the humidity sensor if the cleaning machine is in the motion state;
a power adjustment module, used to adjust the power of the heating element and the power of the motor according to the humidity.

The embodiment of the present disclosure discloses E9, a cleaning machine, which includes a processor, a communication interface, a memory, and a communication bus, wherein the processor, the communication interface, and the memory complete communication with each other through the communication bus;
the memory, used to store computer programs;
the processor, used to implement the steps of the cleaning machine drying method provided by the embodiment of the present disclosure when executing the program stored in the memory.

The embodiment of the present disclosure discloses E10, a storage medium on which a computer program is stored, and a method is implemented when the program is executed by a processor.

In the above embodiments, it may be implemented in whole or in part by software, hardware, firmware, or any combination thereof. When implemented using software, it may be implemented in whole or in part in the form of a computer program product. The computer program product includes one or more computer instructions. When the computer program instructions are loaded and executed on a computer, the processes or functions described in the embodiments of the present disclosure are generated in whole or in part. The computer may be a general-purpose computer, a special-purpose computer, a computer network, or other programmable device. The computer instructions may be stored in a storage medium or transmitted from one storage medium to another, e.g., the computer instructions may be transmitted from a website, computer, server, or data center via wired (e.g., coaxial cable, fiber optic cable), Digital Subscriber Line (DSL)) or wireless (such as infrared, wireless, microwave, etc.) to transmit to another website, computer, server or data center. The storage medium may be any available medium that can be accessed by a computer or a data storage device such as a server or data center integrated with one or more available media. The available media may be magnetic media (e.g., floppy disk, hard disk, magnetic tape), optical media (e.g., DVD), or semiconductor media (e.g., Solid State Disk (SSD)), etc.

With the continuous development of computer technology, sensor technology and artificial intelligence technology, the functions of cleaning device are becoming more and more perfect. More and more families are choosing cleaning device to replace traditional manual cleaning methods to complete the cleaning of the home environment. Taking the cleaning device as a carpet cleaning machine as an example, when the carpet cleaning machine is working, it sprays the clean water in the clean water bucket onto the carpet in real time to clean the carpet. At the same time, the sewage generated during the cleaning process is recycled into the recycling bin, thereby automatically completing the carpet cleaning process, which frees the user's hands.

Due to the limited capacity of the recycling bin, when the carpet cleaning machine is operating, it is necessary to monitor in real time whether the recycling bin is full or not full. When the water is full, the user is notified to empty the recycling bin in time to ensure that the carpet cleaning machine continues recycling sewage. At present, two conductive probes are mainly installed at the maximum water level line of the recycling bin corresponding to the full water level. The state of the recycling bin can be identified by detecting whether the two conductive probes are connected; when the water level of the recycling bin reaches the maximum water level, the two conductive probes are connected; when the water level in the recycling bin does not reach the maximum water level, the two conductive probes are not connected. However, the conductive probe is in direct contact with the sewage in the recycling bin. After long-term use, the conductive probe has problems with oxidation and surface dirt adhesion, which affects the state identification of the recycling bin and is prone to misjudgment. In order to solve the above technical problems, embodiments of the present disclosure provide a recycling bin state detection method, a processing system and a cleaning device, by adding a Hall sensor and a negative pressure sensor to the cleaning device, and combining the changes of the Hall sensor to output the Hall signal information and the change information of the negative pressure signal collected by the negative pressure sensor to identify that the recycling bin is full of water. As a result, the state of the recycling bin can be identified automatically, promptly, and accurately.

The technical solutions provided by each embodiment of the present disclosure will be described in detail below with reference to the accompanying drawings.

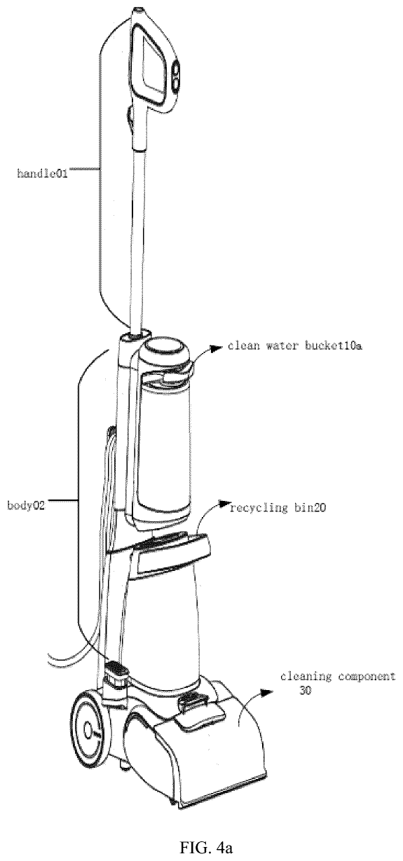

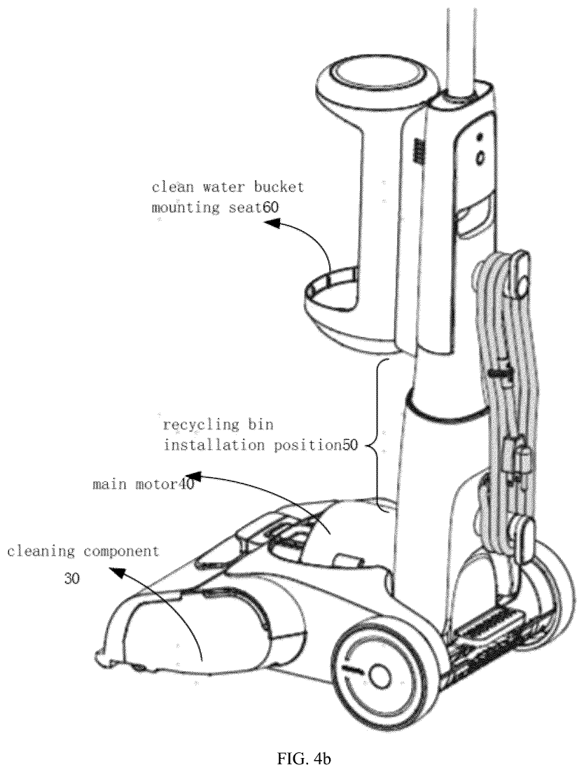

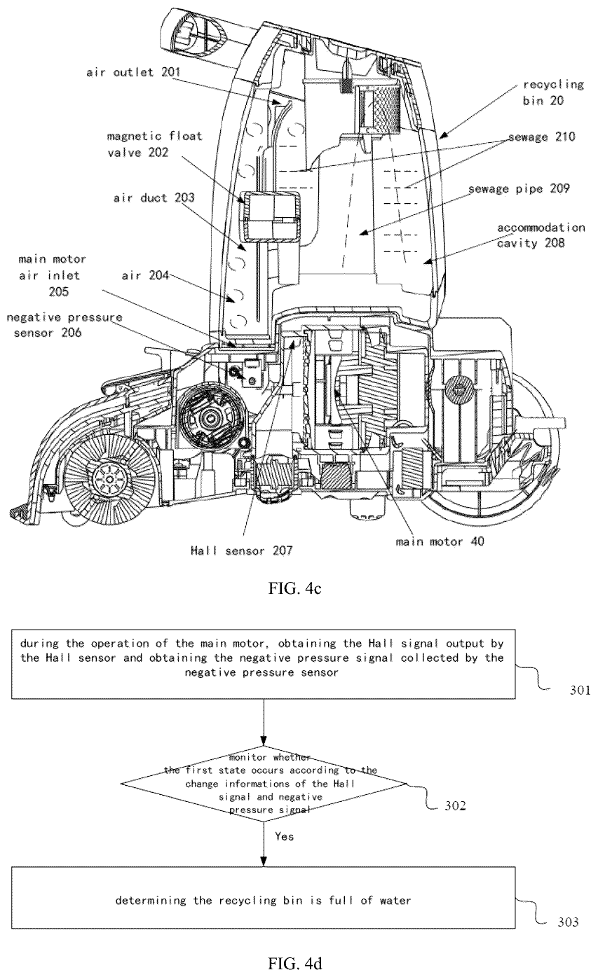

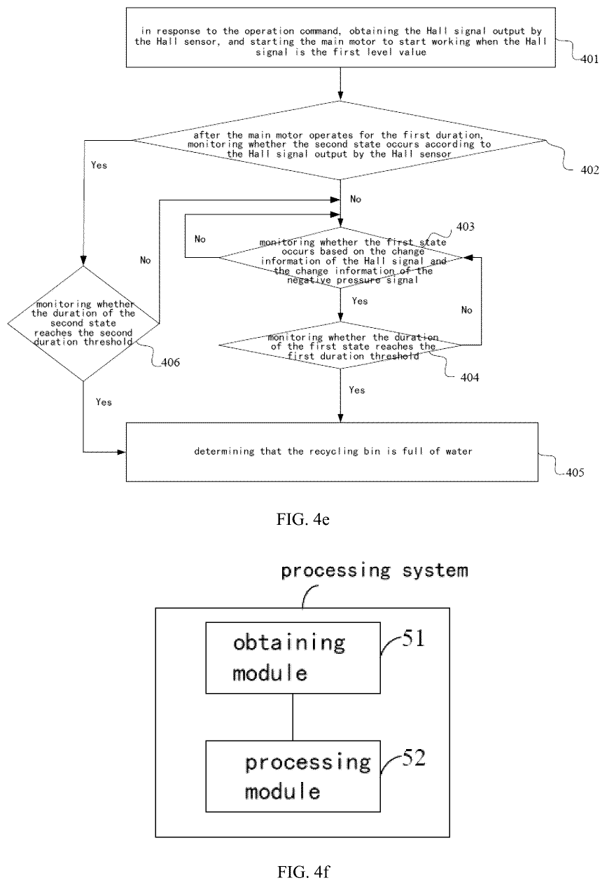

The recycling bin state detection method provided by the embodiment of the present disclosure can be applied to cleaning device of any structure. To facilitate understanding, the cleaning device shown in FIG. 4a, 4b and FIG. 4c is used as an example for explanation.

Referring to FIGS. 4a, 4b and 4c, the cleaning device at least includes a clean water bucket 10a, a recycling bin 20, a cleaning component 30 and a motor 40. The clean water bucket 10a provides cleaning liquid, and the cleaning liquid flows out of the clean water bucket 10a and flows into the cleaning component 30. The cleaning component 30 uses cleaning liquid to clean the surface to be cleaned to be worked. The sewage generated during the cleaning process is recycled into the recycling bin 20 through the recycle pipe under the suction force generated by the motor 40 after operation. Specifically, the cleaning component 30 is communicated with the recycling bin 20 through the recycling pipe.

In the embodiment of the present disclosure, a magnetic float valve 202 that can float up and down according to the liquid level is installed in the recycling bin 20. The magnetic float valve 202 may be a float valve with a magnet installed at the bottom. A Hall sensor 207 is provided on the cleaning device body at a position matching the installation position of the magnetic float valve 202. The Hall sensor 207 is used to output different Hall signals as the liquid level in the recycling bin 20 changes. Optionally, the Hall sensor 207 is provided on the body of the cleaning device located below the recycling bin 20.

In the embodiment of the present disclosure, the motor 40 can be a negative pressure fan or a vacuum pump, but it is not limited to this. Any motor device that can generate negative pressure can be used. The air duct 203 of the recycling bin communicates the air inlet end 205 of the motor and the air outlet 201 of the recycling bin. Before the air outlet of the recycling bin is not closed and the motor 40 starts working, the air in the recycling bin 20 will be sucked by the motor 40, so that the inside of the recycling bin 20 is in a negative pressure state. Since the negative pressure inside the recycling bin 20 is relatively small and the negative pressure outside relatively large, in this way, the sewage generated during the cleaning process is sucked in from the suction port near the cleaning assembly 30 and flows into the sewage pipe 209 of the recycling bin through the water inlet pipe communicated with the suction port. The sewage in the sewage pipe 209 (the dotted line segment in FIG. 4 c represents the sewage 210) will flow into the accommodation cavity 208 of the recycling bin 20. Along with the sewage, the air in the recycling bin 20 (the circle drawn with a dotted line in FIG. 4c represents the air 204) will flow through the air outlet 201 into the air duct of the recycling bin under the suction of the motor 40 and be sucked away, so that the recycling bin continues to be in a negative pressure state. As time goes by, the liquid level in the accommodation chamber 208 continues to rise, and the magnetic float valve 202 rises until the air outlet 201 of the recycling bin is closed. At this time, the negative pressure in the air duct becomes stronger, the value of the negative pressure sensor becomes smaller, and the sewage will be stopped being sucked into the suction port and into the recycling bin.

In the embodiment of the present disclosure, the negative pressure sensor used to collect negative pressure signals can be installed in the air duct 203 of the recycling bin, or can be installed at the air inlet end 205 of the motor 40. The embodiment of the present disclosure does not limit the installation position of the negative pressure sensor, as long as it is located downstream of the airflow of the air outlet 201 of the recycling bin and upstream of the air inlet of the motor 40.

The embodiment of the present disclosure does not limit the installation positions of the clean water bucket 10a and the recycling bin 20. For example, the clean water bucket mounting seat 60 is above the recycling bin installation position 50, or the clean water bucket mounting seat 60 is below the recycling bin installation position 50. Optionally, as shown in FIG. 4a, the cleaning device may also include a handle assembly, and the handle assembly may include: a handle 01 and a body 02. Furthermore, the length of the body 02 may be fixed or adjustable. Optionally, if the length of the body 02 is adjustable, its structure is a telescopic structure. Accordingly, users can flexibly adjust the length of the body 02 according to their own needs. Alternatively, the extension length of the handle 01 outside the body 02 is adjustable. FIG. 4d is a schematic flowchart of a recycling bin state detection method provided by an exemplary embodiment of the present disclosure. Referring to FIG. 4d, the method may include the following steps:
301. during the operation of the motor, obtaining the Hall signal output by the Hall sensor and obtaining the negative pressure signal collected by the negative pressure sensor.
302. monitor whether the first state occurs according to the change information of the Hall signal and the change information of the negative pressure signal. If so, performing step 303. The first state refers to a state in which the negative voltage signal meets the first condition and the Hall signal is a second level value.
303. determining the recycling bin is full of water.

Of course, the negative pressure signal satisfying the first condition may also include: the current negative pressure value meeting a predetermined negative pressure requirement. However, optimally, the negative pressure signal satisfying the first condition includes at least one of the following: the change value of the negative pressure signal is greater than the set difference threshold, the change value of the negative pressure signal falls within the set change range, the change rate of the negative pressure signal is greater than the set change rate, or the change rate of the negative pressure signal falls within the set change rate range. When the first condition is the change value of the negative pressure signal, interference from factors such as machine errors and regional influences can be eliminated, and the detection results are more accurate.

In the embodiment of the present disclosure, after the motor starts working, the sewage generated during the cleaning process is continuously recycled into the recycling bin. The liquid level in the recycling bin continues to rise. The magnetic float valve continues to rise along with the liquid level, and the magnetic field intensity detected the Hall sensor is weaker and weaker, which is generated by the magnetic float valve. When the liquid level in the recycling bin reaches the maximum liquid level corresponding to the water fullness, the magnetic float valve is the farthest from the Hall sensor. The Hall sensor cannot detect the magnetic field intensity generated by the magnetic float valve. The Hall signal output by the Hall sensor is the second level value. When the Hall sensor can detect the magnetic field intensity generated by the magnetic float valve, the Hall signal output by the Hall sensor is the first level value. Specifically, it is assumed that the high level value is 1 and the low level value is 0. The first level value may be 1, and the second level value may be 0. Alternatively, the first level value may be 0 and the second level value may be 1. When the recycling bin is not full of water, the liquid level in the recycling bin has not yet reached the maximum liquid level corresponding to the full water level, and the negative pressure value in the air duct remains basically unchanged. However, when the recycling bin is full of water, the liquid level in the recycling bin reaches the maximum level corresponding to the full water level, the magnetic float valve closes the air outlet of the recycling bin, and the negative pressure value in the air duct will jump.

Based on this, it is possible to identify whether the recycling bin is full of water or not full of water by detecting the change information of the Hall signal and the change information of the negative pressure signal.

Specifically, it is monitored whether the first state occurs. The first state refers to the state in which the current negative pressure signal change information meets the first condition and the Hall signal is the second level value. It is worth noting that when monitoring the first state, priority can be given to detecting whether the Hall signal is the second level value. When the Hall signal is the second level value, it is then monitored whether the change information of the negative pressure signal satisfies the first condition.

In this embodiment, the change information of the negative pressure signal may be the change value or change rate of the negative pressure signal, but it is not limited to this. Specifically, the change value of the negative pressure signal refers to the difference between the negative pressure signals at two different times, and the change rate of the negative pressure signal refers to the ratio of the increment of the negative pressure signal to the increment of time. For example, the negative pressure signal at time t1 is 7600 negative pressure sensor values, and the negative pressure signal at time t2 is 7000 negative pressure sensor values. Then between time t1 and time t2, the change value of the negative pressure signal is 600 negative pressure sensor values. Between time t1 and time t2, the change rate of the negative pressure signal is the ratio of the 600 negative pressure sensor values to the time difference (t2−t1).

In this embodiment, the first condition includes, but is not limited to, at least one of the following: the change value of the negative pressure signal is greater than the set difference threshold, the change value of the negative pressure signal falls within the set change range, the change value of the negative pressure signal is greater than the set change rate, or the change rate of the negative pressure signal falls within the set change rate range. The set difference threshold, set change range, set change rate, and set change rate range can all be set according to the actual situation. For example, set the difference threshold to 600 negative pressure sensor values, and convert it into a negative pressure value according to the calculation formula, which is 1.5 KPa (the negative pressure sensor value and the negative pressure value have a fixed calculation formula. According to the negative pressure sensor selection and detected negative pressure sensor value, the current negative pressure value can be calculated). Here, the change value of the negative pressure signal is greater than the set threshold difference, which can either mean that the change value of the negative pressure sensor value directly detected and obtained by the negative pressure sensor is greater than the first set threshold, or can also mean that the change value of the negative pressure value calculated from the negative pressure sensor value is greater than the second set threshold, and the second set threshold is obtained according to the above calculation formula and the first set threshold.

In this embodiment, the change information of the negative pressure signal may refer to the change information between the current negative pressure signal and the negative pressure signal at historical moments. The current negative pressure signal refers to the negative pressure signal collected by the negative pressure sensor at the current moment. Further optionally, the change information of the negative pressure signal refers to the change information between the current negative pressure signal and the initial negative pressure signal. Optionally, the initial negative pressure signal refers to the negative pressure signal collected by the negative pressure sensor when the recycling bin is in the water-filling process and is not full of water. Therefore, the change information of the negative pressure signal may specifically refer to the difference between the current negative pressure signal and the initial negative pressure signal or the change rate of the negative pressure signal from the time corresponding to the initial negative pressure signal to the current time.

Further optionally, when the first state occurs, determining that the recycling bin is in the full state may be: when the first state occurs, monitoring whether the duration of the first state reaches the first duration threshold; if the duration of the first state reaches the first duration threshold, determining that the recycling bin is full of water. Specifically, in order to reduce misjudgment of the recycling bin state, the duration of the first state can be detected. If the duration of the first state reaches the first duration threshold, it means that the recycling bin is full of water. If the duration of the first state does not reach the first duration threshold, it means that the recycling bin is not full of water. Specifically, the first duration threshold is set based on a large amount of experimental data.

For example, when the recycling bin is filled with water, the liquid level in the recycling bin continues to rise. Before the recycling bin is full of water, the Hall signal output by the Hall sensor is the first level value, and the negative pressure signal collected by the negative pressure sensor is 7600 negative pressure sensor values. When the recycling bin is full of water, the Hall signal output by the Hall sensor is the second level value, and the negative pressure signal collected by the negative pressure sensor is 7000 negative pressure sensor values, and lasts for 5 seconds.

Further optionally, if the first state does not occur or the duration of the first state does not reach the first duration threshold, continue to monitor whether the first state occurs based on the change information of the Hall signal and the change information of the negative pressure signal.

It is worth noting that if only the Hall signal output by the Hall sensor is used to identify whether the recycling bin is full of water, however, as time goes by, the magnetic field strength of the magnetic float valve will weaken, or the magnetic float valve adsorbing iron filings, etc. will cause the magnetic field strength being weaken, causing the Hall sensor to misjudge that the recycling bin is full when it is not full. The ideal condition is that the negative pressure signal collected by the negative pressure sensor can be used to determine whether the recycling bin is full of water. However, because the negative pressure sensor is affected by factors such as the suction power of the motor, different atmospheric pressures, and different cleaning materials at the suction port, the negative pressure signal output by the negative pressure sensor will be different when the water is full under different conditions. Therefore, only using the negative pressure signal collected by the negative pressure sensor may cause misjudgments caused by various factors.

In the embodiment of the present disclosure, the change information of the Hall signal output by the Hall sensor and the change information of the negative pressure signal collected by the negative pressure sensor are combined to identify that the recycling bin is full of water, which can effectively reduce the probability of misjudgment of water fullness caused by waken magnetic field of a long-term used magnetic float valve. Determining the recycling bin is full by the change information of the negative pressure signal effectively reduces the probability of misjudgment of water fullness caused by various factors.

Further optionally, after it is determined that the recycling bin is full of water, in order to improve the operating efficiency of the cleaning device, a prompt message that the recycling bin is full of water can also be output. The output method of the prompt information is not limited. For example, the output method of the prompt information can be text output, voice prompt or light prompt information. The light prompt information is, for example, flashing lights.

Further optionally, in order to reduce the damage to the cleaning device, after it is determined that the recycling bin is full of water, the cleaning operation is suspended, and the recycling bin full prompt message is output; based on the change information of the Hall signal within the specified time period, it is determined whether the state of the recycling bin has returned to the state of not being full of water and the recycling bin has been installed on the cleaning device; if so, restart the cleaning operation.

It is worth noting that after the cleaning device suspends the cleaning operation, no sewage will enter the recycling bin, which can ensure the safety of the cleaning device. In addition, through the change information of the Hall signal within a specified duration, it can automatically, accurately and efficiently determine whether the full recycling bin has been cleaned and reinstalled on the cleaning device. When it is confirmed that the full recycling bin has been cleaned and reinstalled on the cleaning device, the cleaning operation can be quickly restarted to improve the efficiency of the cleaning operation.

It is worth noting that the specified duration is set according to the actual situation, for example, 1 minute. Based on the above content, it can be known that different Hall signals will appear depending on whether the cleaning device is equipped with a recycling bin and whether the installed recycling bin is full of water. Therefore, through the change information of the Hall signal within a specified duration, it can be determined whether the recycling bin is removed from the cleaning device for cleaning, and whether the cleaned recycling bin is reinstalled on the cleaning device. For example, when the recycling bin installed on the cleaning device is full of water, the Hall signal output by the Hall sensor is high level. When the recycling bin is removed from the cleaning device, the Hall signal output by the Hall sensor is still high level. When the recycling bin is cleaned and installed on the Hall sensor again, the Hall signal output by the Hall sensor changes from high level to low level.

Further optionally, the specified time period is divided into multiple time periods; based on the change information of the Hall signal within the specified time period, determining whether the state of the recycling bin has returned to the water-not-full state and the recycling bin having been installed on the cleaning device, specifically includes: setting one of the multiple time periods as the current time period in turn; based on the change information of the Hall signal in the current time period, determining whether the state of the recycling bin has returned to the water-not-full state and the recycling bin having been installed on the cleaning device; if not, enhancing the recycling bin full prompt information, outputting the enhanced recycling bin full prompt information, and re-executing the step of sequentially setting one of the multiple time periods as the current time period and subsequent steps; if so, determining that the state of the recycling bin returns to the not-full state and the recycling bin has been installed on the cleaning device.

In the embodiment of the present disclosure, in order to improve the efficiency of reaching prompt information and enable users to clean the recycling bin in time, the specified time period can be divided into multiple periods. If the user did not remove the recycling bin from the cleaning device for cleaning and reinstalling it on the cleaning device in the previous period, the prompt information is enhanced and the enhanced prompt information is output, so that the prompt information can reach the user, thereby increasing the possibility that the user will clean the recycling bin in time in the next period. Specifically, enhancing the prompt information is like, increasing the volume and prompt frequency of the voice prompt, increasing the brightness or frequency of light flashing, etc., or increasing the number of output prompt information output in text mode, etc., or outputting in the prompt information by a way of combining the text, the voice prompt mode or light prompt information. The method for detecting the state of a recycling bin provided by the embodiment of the present disclosure adds a Hall sensor and a negative pressure sensor to the cleaning device, and combines the change information of the Hall signal output by the Hall sensor and the change information of the negative pressure signal collected by the negative pressure sensor, to identify that the recycling bin is full of water. As a result, the state of the recycling bin can be identified automatically, promptly, and accurately.

In some embodiments of the present disclosure, before the motor is started, the Hall signal output by the Hall sensor can be obtained in response to the work instruction, and when the Hall signal is the first level value, the motor is started to start working. After the motor starts working, the suction generated by the motor will pull up the pollutants from the surface to be cleaned to be worked such as the ground, table or glass surface. Therefore, in order to ensure the safety of the cleaning device, before starting the motor to start working, it is necessary to ensure that recycling bin is installed on the cleaning device, and the recycling bin installed is not a full recycling bin.

In the embodiment of the present disclosure, the user can send a work instruction to the cleaning device requesting the cleaning device to perform a cleaning task through a terminal device such as a mobile phone, tablet, or notebook that interacts with the cleaning device, or the user can input the above working command through the display screen of the cleaning device. The cleaning device responds to the job command and enters the power-on state. When the cleaning device is turned on, the Hall signal output by the Hall sensor is obtained. If the Hall signal is the first level value, it means that the recycling bin is installed on the cleaning device, and the installed recycling bin is not a full recycling bin. At this point the motor can be started. If the Hall signal is the second level value, it means that the recycling bin is not installed on the cleaning device, or the installed recycling bin is full of water, and the motor cannot be started at this time.

In some embodiments of the present disclosure, based on the change information of the Hall signal and the change information of the negative pressure signal, an implementation process of monitoring whether the first state occurs is: after the motor operates for the first duration, according to the change information of the Hall signal and the change information of the negative pressure signal are monitored to determine whether the first state occurs.

In practical applications, after starting the motor, it needs to work for a duration to enter a steady state and provide sufficient suction. Therefore, in order to reduce the probability of misjudgment of the recycling bin state, it is possible to monitor whether the first state occurs after the motor has been operated for the first duration. Specifically, the first duration is set based on a large amount of test data, for example, 3 seconds. After the motor works for the first duration, the motor enters a steady state and can provide sufficient suction, and the negative pressure in the air duct is relatively stable. It should be understood that the first duration is the time duration required for the motor to enter a steady state from startup. Before the motor enters a steady state, that is, within the first duration, the suction provided by the motor fluctuates high and low, the negative pressure in the air duct also fluctuates high and low, and the negative pressure signal collected by the negative pressure sensor is not reliable enough. Therefore, it is more accurate and reliable to monitor the first state based on the negative pressure signal collected by the negative pressure sensor and the Hall signal output by the Hall sensor after the first duration.

In some embodiments of the present disclosure, after the motor is operated for the first duration, the cleaning device may inhale a large amount of sewage during the first duration, resulting in the recycling bin becoming full of water after the first duration. Therefore, after the motor operates for the first duration, based on the change information of the Hall signal and the change information of the negative pressure signal, an implementation process of monitoring whether the first state occurs is: after the motor operates for the first duration, according to the Hall signal output by the Hall sensor monitoring whether the second state occurs, where the second state refers to the state in which the Hall signal is the second level value; if the second state occurs, monitoring whether the duration of the second state reaches the second duration threshold; if the duration of the second state exceeds the second duration threshold, determining that the recycling bin is full of water; if the second state does not occur or the duration of the second state does not exceed the second duration threshold, then according to the change of the Hall signal information and the change of the negative pressure signal to monitor whether the first state occurs. The second duration threshold is set based on a large amount of test data, for example, 5 seconds. In practical applications, the first duration required for the motor to enter a steady state from startup is short, and the negative pressure signal collected by the negative pressure sensor during the first time is not reliable enough. In this case, the Hall signal output by the Hall sensor can be used to identify whether the recycling bin is full of water in a short duration. Specifically, after the motor operates for the first duration, the Hall signal currently output by the Hall sensor can be obtained at the end of the first duration. If the Hall signal currently output by the Hall sensor is the second level value, then it determines that the second state is detected. When the occurrence of the second state is detected, the duration of the second state may be detected. If the duration of the second state reaches the second duration threshold, it means that the recycling bin is in a full state; or if the second state does not occur or the duration of the second state does not reach the second duration threshold, it means that the recycling bin is in a not-full state. If it is determined that the recycling bin is not full in a short duration, the step of determining that the water is full based on the negative pressure signal collected by the negative pressure sensor and the Hall signal output by the Hall sensor can be performed then.

Further optionally, if it is determined that the recycling bin is not full of water after the motor is working for the first duration, the initial negative pressure signal can be calculated according to the negative pressure signals collected by the negative pressure sensor in the duration after the motor is working for the first duration and the recycling bin is not full of water. Optionally, the negative pressure signals collected by the negative pressure sensor at different times during this in the duration can be averaged, and the average value can be used as the initial negative pressure signal to achieve a more objective and accurate calculation of the initial negative pressure signal.

An embodiment of the present disclosure also provides a method for detecting the state of a recycling bin. FIG. 4e is a schematic flowchart of another method for detecting the state of a recycling bin provided by an exemplary embodiment of the present disclosure. Referring to FIG. 4e, the method may include the following steps:
401. in response to the operation command, obtaining the Hall signal output by the Hall sensor, and starting the motor to start working when the Hall signal is the first level value.
402. after the motor operates for the first duration, monitoring whether the second state occurs according to the Hall signal output by the Hall sensor. If not, execute step 403. If yes, execute step 406;
403. monitoring whether the first state occurs based on the change information of the Hall signal and the change information of the negative pressure signal. If yes, execute step 404. If not, return to step 403.
404. monitoring whether the duration of the first state reaches the first duration threshold. If yes, perform step 405. If not, return to step 403.
405. determining that the recycling bin is full of water.
406. monitoring whether the duration of the second state reaches the second duration threshold. If yes, perform step 405. If not, return to step 403.

Regarding the specific implementation of each step in the embodiment shown in FIG. 4e, please refer to the specific implementation of each step in the foregoing embodiment, and will not be described again here.

For ease of understanding, several scenario embodiments are introduced below to describe in detail the recycling bin state detection method provided by the embodiments of the present disclosure.

### Scenario Example 1

When the user needs cleaning, he fills the clean water bucket with cleaning fluid, and installs the clean water bucket filled with cleaning fluid and the empty recycling bin on the cleaning device. After completing the above preparations, the user presses the power-on button on the control panel of the cleaning device, the cleaning device enters the power-on state. The cleaning device first detects whether an empty recycling bin has been installed. If not, it prompts “an empty recycling bin need to be installed by the user” in voice, or prompts “a recycling bin is not installed by the user or the recycling bin is full of water” in voice.

When determining that the cleaning device is installed with an empty recycling bin, the cleaning device executes the cleaning instruction and controls the clean water bucket to provide cleaning liquid to the cleaning component, and the cleaning component uses the cleaning liquid to clean the floor. At the same time, the motor starts working, to generate negative pressure, accordingly the sewage generated during the cleaning process is such through the sewage suction port and flows into the recycling bin. The magnetic float valve in the recycling bin rises as the liquid level in the recycling bin rises. When the recycling bin is full of water, the air outlet of the recycling bin closes, causing negative pressure in the air duct between the air inlet end of the motor and the air outlet of the recycling bin becomes stronger, the value detected and obtained by the negative pressure sensor becomes smaller, which in turn stops recycling sewage into the recycling bin. At this time, the Hall sensor outputs a Hall signal related to the fullness of the recycling bin, and the negative pressure signal of the negative pressure sensor is very different from the negative pressure signal when the recycling bin is not full. The cleaning device prompts the user the recycling bin is full based on this in voice.

### Scenario Example 2

When the user needs cleaning, he fills the clean water bucket with cleaning fluid, and installs the clean water bucket filled with cleaning fluid and the empty recycling bin on the cleaning device. After completing the above preparations, the user sends a power-on command to the cleaning device via his mobile phone, the cleaning device enters the power-on state. The cleaning device first detects whether an empty recycling bin has been installed. If not, it prompts “an empty recycling bin need to be installed by the user” in voice, or prompts “a recycling bin is not installed by the user or the recycling bin is full of water” in voice.

When determining that the cleaning device is installed with an empty recycling bin, the cleaning device executes the cleaning instruction and controls the clean water bucket to provide cleaning liquid to the cleaning component, and the cleaning component uses the cleaning liquid to clean the floor. At the same time, the motor starts working, to generate negative pressure, accordingly the sewage generated during the cleaning process is such through the sewage suction port and flows into the recycling bin. The magnetic float valve in the recycling bin rises as the liquid level in the recycling bin rises. When the recycling bin is full of water, the air outlet of the recycling bin closes, causing negative pressure in the air duct between the air inlet end of the motor and the air outlet of the recycling bin becomes stronger, the value detected and obtained by the negative pressure sensor becomes smaller, which in turn stops recycling sewage into the recycling bin. At this time, the Hall sensor outputs a Hall signal related to the fullness of the recycling bin, and the negative pressure signal of the negative pressure sensor is very different from the negative pressure signal when the recycling bin is not full. The cleaning device send prompt information to user's phone, to prompt the user the recycling bin is full based on this.

It should be noted that the execution subject of each step of the method provided in the above embodiments may be the same device, or the method may also be executed by different devices. For example, the execution subject of steps 401 to 403 may be device A; for another example, the execution subject of steps 401 and 402 may be device A, the execution subject of step 403 may be device B; and so on.

In some of the processes described in the description, claims, and the above drawings of the present application, a plurality of operations occurring in a particular order are included, which may be performed out of the order herein or be performed in parallel. The sequence numbers of the operations, such as 401, 402, etc., are merely used to distinguish between the various operations, and the sequence numbers themselves do not represent any order of execution. In addition, the processes may include more or fewer operations, and the operations may be performed sequentially or in parallel. It should be noted that the expressions herein of “first”, “second”, etc. are intended to distinguish between different messages, devices, modules, etc., and are not intended to represent a sequential order, nor is it intended to limit that “first” and “second” are of different types.

FIG. 4f is a schematic structural diagram of a processing system provided by an exemplary embodiment of the present disclosure. In the embodiment of the present disclosure, the processing system can be implemented by software and/or hardware, and can generally be integrated into a CPU (central processing unit, central processing unit), GPU (graphics processing unit, graphics processor) or MCU (Microcontroller). Unit, micro control unit). As shown in FIG. 4f, the processing system may include: an obtaining module 51 used to obtain the Hall signal output by the Hall sensor and the negative pressure signal collected by the negative pressure sensor during the operation of the motor;
a processing module 52 used to monitor whether the first state occurs based on the change information of the Hall signal and the change information of the negative pressure signal, where the first state means that the change information of the negative pressure signal meets the first condition and the Hall signal is the second state; when the first state occurs, determining that the recycling bin is full of water.

Further optionally, when the first state occurs, the processing module 52 determines that the recycling bin is in a full state, and is specifically used to: when the first state occurs, monitor whether the duration of the first state reaches the first duration threshold; if the duration of the first state reaches the first duration threshold, determine that the recycling bin is in a full state.

Further optionally, the first condition includes at least one of the following: the change value of the negative pressure signal is greater than the set difference threshold, the change value of the negative pressure signal falls within the set change range, the change rate of the negative pressure signal is greater than the set change rate, or the change rate of the negative pressure signal falls within the set change rate range.

Further optionally, before the motor works, the processing module 52 is also used to: in response to the work instruction, the Hall signal output by the Hall sensor is obtained. When the Hall signal is the first level value, the motor is started to start working.

Further optionally, the processing module 52 monitoring whether the first state occurs based on the change information of the Hall signal and the change information of the negative pressure signal is specifically used to:
after the motor operates for the first duration, monitor whether the first state occurs based on the change information of the Hall signal and the change information of the negative pressure signal.

Further optionally, after the motor has been operated for the first duration, the processing module 52 monitoring whether the first state occurs based on the change information of the Hall signal and the change information of the negative pressure signal is specifically used for:
after the motor operates for the first duration, monitor whether the second state occurs based on the Hall signal output by the Hall sensor, where the second state refers to the state where the Hall signal is the second level value; if the second state occurs, monitor whether the duration of the second state reaches the second duration threshold; if the duration of the second state exceeds the second duration threshold, determine that the recycling bin is full; if the second state does not occur or the duration of the second state does not exceed the second duration threshold, monitor whether the first state occurs based on the change information of the Hall signal and the change information of the negative pressure signal.

Further optionally, the change information of the negative pressure signal refers to the change information between the current negative pressure signal and the initial negative pressure signal. The processing module 52 is also used to: if the second state does not occur or the duration of the second state does not reach the second duration threshold, generate an initial negative pressure signal based on the negative pressure signal collected by the negative pressure sensor.

Further optionally, the processing module 52 is also configured to: if the first state does not occur or the duration of the first state does not reach the first duration threshold, continue to execute the operation of monitoring whether the first state of occurs based on the change information of the Hall signal and the change information of the negative pressure signal.

Further optionally, after determining that the recycling bin is full of water, the processing module 52 is also used to:
pause the cleaning operation and output a prompt message that the recycling bin is full of water; based on the change information of the Hall signal within the specified time period, determine whether the state of the recycling bin has returned to the water-not-full state and the recycling bin has been installed on the cleaning device; if so, then restart cleaning operation.

Further optionally, the specified time period is divided into multiple time periods; the processing module 52 is also used to: set one of the multiple time periods as the current time period in turn; based on the change information of the Hall signal in the current time period, determine whether the state of the recycling bin has returned to the water-not-full state and the recycling bin having been installed on the cleaning device; if not, enhance the recycling bin full prompt information, and output the enhanced recycling bin full prompt information.

The specific implementation of the processing system shown in FIG. 4f has been described in detail in the embodiment of the above method, and will not be described in detail here.

FIG. 4g is a schematic structural diagram of another cleaning device provided by an exemplary embodiment of the present disclosure. As shown in FIG. 4g, the device at least includes a clean water bucket 10a, a recycling bin 20, a cleaning component 30, a Hall sensor and a motor. The recycling bin is communicated with the cleaning component. The recycling bin includes an air outlet and an air duct. The air outlet of the recycling bin is communicated with the air inlet end of the motor via the air duct. A negative pressure sensor is installed in the air duct or at the air inlet end of the motor. Optionally, the Hall sensor is arranged on the body of the cleaning device located below the recycling bin. Specifically, the Hall sensor, the motor, and the negative pressure sensor are not shown in FIG. 4g.

The cleaning device also includes: a memory 61 and a processor 62.

The memory 61 is used to store computer programs and can be configured to store various other data to support operations on the computing platform. Examples of such data include instructions for any application or method operating on the computing platform, contact data, phonebook data, messages, pictures, videos, etc.

The memory 61 may be implemented by any type of volatile or non-volatile storage device, or a combination thereof, such as static random access memory (SRAM), electrically erasable programmable read-only memory (EEPROM), erasable programmable read-only memory (EEPROM), Programmable read-only memory (EPROM), programmable read-only memory (PROM), read-only memory (ROM), magnetic memory, flash memory, magnetic or optical disk.

The processor 62, coupled to memory 61, is used to execute the computer program in memory 61 for:
during the operation of the motor, obtaining the Hall signal output by the Hall sensor and obtaining the negative pressure signal collected by the negative pressure sensor; monitoring whether the first state occurs based on the change information of the Hall signal and the change information of the negative pressure signal, where the first state refers to a state in which the change information of the negative pressure signal meets the first condition and the Hall signal is a second level value; when the first state occurs, determining that the recycling bin is in a full state.

Further optionally, the first condition includes at least one of the following: the change value of the negative pressure signal is greater than the set difference threshold, the change value of the negative pressure signal falls within the set change range, the change rate of the negative pressure signal is greater than the set change rate, or the change rate of the negative pressure signal falls within the set change rate range.

Further optionally, when the first state occurs, the processor 62 determining that the recycling bin is in a full state is specifically configured to: when the first state occurs, monitor whether the duration of the first state reaches the first duration threshold; if the duration of the first state reaches the first duration threshold, determine that the recycling bin is in a full state.

Further optionally, before the motor works, the processor 62 is also used to: in response to the work instruction, obtain the Hall signal output by the Hall sensor, and when the Hall signal is the first level value, the motor is started to start working.

Further optionally, the processor 62 monitoring whether the first state occurs based on the change information of the Hall signal and the change information of the negative pressure signal is specifically used to: after the motor operates for the first duration, monitor whether the first state occurs based on the change information of the Hall signal and negative pressure signal change information.

Further optionally, after the motor operates for the first duration, within the first duration or at the end of the first duration and before the first state occurs, after the processor 62 operations after the first duration, monitoring whether the first state occurs according to the change information of the Hall signal and the change information of the negative pressure signal is specifically used to: monitor whether the second state occurs according to the Hall signal output by the Hall sensor, where the second state is a state where the Hall signal is a second level value; if the second state occurs, monitor whether the duration of the second state reaches the second duration threshold; if the duration of the second state exceeds the second duration threshold, determine that the recycling bin is full; if the second state does not occur or the duration of the second state does not exceed the second duration threshold, monitor whether the first state occurs based on the change information of the Hall signal and the change information of the negative pressure signal.

Further optionally, the change information of the negative pressure signal refers to the change information between the current negative pressure signal and the initial negative pressure signal. The processor 62 is also used to: if the second state does not occur or the duration of the second state does not reach the second duration threshold, generate an initial negative pressure signal based on the negative pressure signal collected by the negative pressure sensor.

Further optionally, the processor 62 is also configured to: if the first state does not occur or the duration of the first state does not reach the first duration threshold, continue to execute the operation of monitoring whether the first state of operation occurs according to the change information of the Hall signal and the change information of the negative pressure signal.

Further optionally, after determining that the recycling bin is in a full state, the processor 62 is also configured to: suspend the cleaning operation and output a prompt message that the recycling bin is full; based on the change information of the Hall signal within the specified time period, determine whether the state of the recycling bin has returned to the state of not being full of water and the recycling bin has been installed on the cleaning device; if so, restart the cleaning operation.

Further optionally, the specified time period is divided into multiple time periods; the processor 62 is also used to: set one of the multiple time periods as the current time period in turn; based on the change information of the Hall signal in the current time period, determine whether the state of the recycling bin has returned to the water-not-full state and the recycling bin having been installed on the cleaning device; if not, enhance the recycling bin full prompt information, and output the enhanced recycling bin full prompt information.

In the embodiment of the present disclosure, the implementation form of the processor 62 is not limited. For example, it may be, but is not limited to, a CPU, a GPU, or an MCU. The processor 62 can be regarded as a control system of the cleaning device and can be used to execute the computer program stored in the memory 61 to control the cleaning device to implement corresponding functions and complete corresponding actions or tasks. It is worth noting that depending on the implementation form of the cleaning device and the scene it is in, the functions, actions or tasks it needs to complete will be different; accordingly, the computer program stored in the memory 61 will also be different. The processor 62 executes different computer programs to control the cleaning device to implement different functions and to complete different actions or tasks.

Correspondingly, embodiments of the present disclosure also provide a computer-readable storage medium storing a computer program. When the computer program is executed, it can implement each step that can be performed by the cleaning device in the above method embodiment.

The present disclosure discloses F1, a recycling bin state detection method, which is applied to cleaning device. The cleaning device at least includes a recycling bin, a cleaning component, a Hall sensor and a motor. The recycling bin is communicated with the cleaning component. The recycling bin includes an air outlet and an air duct.

The air outlet of the recycling bin is communicated with the air inlet end of the motor through the air duct. A negative pressure sensor is installed in the air duct or at the air inlet end of the motor. The method include:
during the operation of the motor, obtaining the Hall signal output by the Hall sensor and obtaining the negative pressure signal collected by the negative pressure sensor; monitoring whether a first state occurs according to the change information of the Hall signal and the negative pressure signal, where the first state refers to a state in which the negative pressure signal meets the first condition and the Hall signal is a second level value;
when the first state occurs, determining that the recycling bin is in a full state.

F2. In the method as described in F1, the negative pressure signal satisfying the first condition includes at least one of the following: the change value of the negative pressure signal is greater than the set difference threshold, the change value of the negative pressure signal falls within the set the change value of the negative pressure signal is greater than the set difference threshold, the change value of the negative pressure signal falls within the set change range, the change rate of the negative pressure signal is greater than the set change rate, or the change rate of the negative pressure signal falls within the set change rate range.

F3. In the method described in F1, determining that the recycling bin is in a full state when the first state occurs includes:
when the first state occurs, monitoring whether the duration of the first state reaches a first duration threshold; if the duration of the first state reaches the first duration threshold, determining that the recycling bin is in a full of water state.

F4. In the method described in F1, before the motor operates, also includes: in response to the work instruction, obtaining the Hall signal output by the Hall sensor, when the Hall signal is a first level value, the motor is started to start working.

F5. In the method described in F2, monitoring whether the first state occurs based on the change information of the Hall signal and the change information of the negative pressure signal includes:
after the motor operates for a first duration, monitoring whether the first state occurs based on the change information of the Hall signal and the change information of the negative pressure signal.

F6. In the method described in F5, the first duration is the time required for the motor to enter a steady state from startup. After the motor operates for a first duration, monitoring whether the first state occurs based on the change information of the Hall signal and the change information of the negative pressure signal includes:
after the motor operates for the first duration, monitoring whether a second state occurs based on the change information of the Hall signal output by the Hall sensor, where the second state means that the Hall signal is at the second level value;
if the second state occurs, monitoring whether the duration of the second state reaches a second duration threshold; if the duration of the second state exceeds the second duration threshold, determining that the recycling bin is in a full state;
if the second state does not occur or the duration of the second state does not exceed the second duration threshold, monitoring whether the first state occurs based on the change information of the Hall signal and the change information of the negative pressure signal.

F7. The method described in F6 also includes:
the change information of the negative pressure signal refers to the change information between the current negative pressure signal and the initial negative pressure signal, if the second state does not occur or the duration of the second state does not reach the second duration threshold, generating an initial negative pressure signal according to the negative pressure signal collected by the negative pressure sensor.

F8. The method described in F3 also includes:
if the first state does not occur or the duration of the first state does not reach the first duration threshold, continuing to monitor whether the first state occurs based on the change information of the Hall signal and the change information of the negative pressure signal.

F9. In the method described in any one of F1-F8, after determining that the recycling bin is full of water, also includes:
pausing the cleaning operation and outputting a prompt message that the recycling bin is full;
based on the change information of the Hall signal within the specified time period, determining whether the state of the recycling bin has returned to the water-not-full state and the recycling bin has been installed on the cleaning device;
if so, restarting the cleaning operation.

F10. In the method described in F9, the specified duration is divided into multiple time periods; the method further includes:
setting one of the multiple time periods as the current time period in turn;
based on the change information of the Hall signal in the current time period, determining whether the state of the recycling bin has returned to the water-not-full state and the recycling bin having been installed on the cleaning device;
if not, enhancing the recycling bin full prompt information, and outputting the enhanced recycling bin full prompt information.

F11. A processing system, including:
an obtaining module, configured to obtain the Hall signal output by the Hall sensor and obtain the negative pressure signal collected by the negative pressure sensor during the operation of the motor;
a processing module, configured to monitor whether a first state occurs based on the change information of the Hall signal and the change information of the negative pressure signal, where the first state means that the negative pressure signal meets the first condition and the Hall signal is the second level value; when the first state occurs, determine that the recycling bin is in a full state.

F12. A cleaning device, at least including a recycling bin, a cleaning component, a Hall sensor and a motor. The recycling bin is communicated with the cleaning component. The recycling bin includes an air outlet and an air duct. The air outlet of the recycling bin is communicated with the air inlet end of the motor through an air duct, and a negative pressure sensor is installed in the air duct or at the air inlet end of the motor; the cleaning device also includes: a memory and a processor;
the memory is used to store computer programs;
the processor is coupled to the memory and is used to execute the computer program to execute the recycling bin state detection method provided by the embodiment of the present disclosure.

Those skilled in the art should know that the embodiment of the present disclosure may be provided as a method, a system or a computer program product. Therefore, the present disclosure may adopt a form of pure hardware embodiment, pure software embodiment and combined software and hardware embodiment. Moreover, the present disclosure may adopt a form of computer program product implemented on one or more computer-available storage media (including, but not limited to, a disk memory, a Compact Disc Read-Only Memory (CD-ROM) and an optical memory) including computer-available program codes.

The present disclosure is described with reference to flowcharts and/or block diagrams of the method, a device (system) and computer program product according to the embodiment of the present disclosure. It is to be understood that each flow and/or block in the flowcharts and/or the block diagrams and combinations of the flows and/or blocks in the flowcharts and/or the block diagrams may be implemented by computer program instructions. These computer program instructions may be provided for a universal computer, a dedicated computer, an embedded processor or a processor of another programmable data processing device to generate a machine, so that an apparatus for realizing a function specified in one flow or more flows in the flowcharts and/or one block or more blocks in the block diagrams is generated by the instructions executed through the computer or the processor of the other programmable data processing device.

These computer program instructions may also be stored in a computer-readable memory capable of guiding the computer or the other programmable data processing device to work in a specific manner, so that a product including an instruction apparatus may be generated by the instructions stored in the computer-readable memory, the instruction apparatus realizing the function specified in one flow or many flows in the flowcharts and/or one block or many blocks in the block diagrams.

These computer program instructions may further be loaded onto the computer or the other programmable data processing device, so that a series of operating steps are executed on the computer or the other programmable data processing device to generate processing implemented by the computer, and steps for realizing the function specified in one flow or many flows in the flowcharts and/or one block or many blocks in the block diagrams are provided by the instructions executed on the computer or the other programmable data processing device.

In a typical configuration, a computing device includes one or more processors (CPUs), an input/output interface, a network interface, and a memory.

The memory may include a non-permanent memory, a random access memory (RAM), and/or a non-volatile memory in a computer-readable medium, such as a read-only memory (ROM) or a flash RAM. The memory is an example of a computer-readable medium.

The computer-readable medium includes permanent and non-permanent, mobile and non-mobile media, which may implement information storage by any method or technology. The information may be a computer-readable instruction, a data structure, a program module, or other data. Examples of computer storage media include, but are not limited to, a phase change RAM (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disk read-only memory (CD-ROM), a digital versatile disk (DVD) or other optical memories, a magnetic tape cartridge, a magnetic tape storage device or other magnetic storage devices or any other non-transmission media, which may be used to store information accessible by a computing device. As defined herein, the computer-readable medium does not include non-transitory computer-readable media such as modulated data signals and carrier waves.

It is also to be noted that terms “include”, “contain” or any other variants thereof are intended to include nonexclusive inclusions, thereby ensuring that a commodity or system including a series of elements not only includes those elements but also includes other elements which are not clearly listed or further includes elements intrinsic to the commodity or the system. Under the condition of no more restrictions, an element defined by statement “including a/an” does not exclude existence of another element which is the same in a commodity or system including the element. Those skilled in the art should know that the embodiment of the present disclosure may be provided as a method, a system or a computer program product. Therefore, the present disclosure may adopt a form of pure hardware embodiment, pure software embodiment and combined software and hardware embodiment. Moreover, the present disclosure may adopt a form of computer program product implemented on one or more computer-available storage media (including, but not limited to, a disk memory, a Compact Disc Read-Only Memory (CD-ROM) and an optical memory) including computer-available program codes.

The above is only the embodiment of the present disclosure and not intended to limit the present disclosure. Those skilled in the art may make various modifications and variations to the present disclosure. Any modifications, equivalent replacements, improvements and the like made within the spirit and principle of the present disclosure shall fall within the scope of the claims of the present disclosure.

1. A cleaning device, comprising:
a device body, comprising a cleaning module acting on an object to be cleaned;
a humidity detection mechanism, provided in the device body and in contact with the object to be cleaned, to detect a humidity of the object to be cleaned;
a control module, provided in the device body and connected to the humidity detection mechanism, to perform corresponding control processing according to humidity data detected and obtained by the humidity detection mechanism.

2. The device according to claim 1, further comprising:
a drying module, provided in the device body, wherein a contact surface in the device body corresponding to the object to be cleaned is provided with an air outlet corresponding to the drying module;
a prompt module, provided in the device body and connected to the control module;
wherein the control module performing corresponding control processing according to humidity data detected and obtained by the humidity detection mechanism comprises at least one of:
using the prompt module to output corresponding prompt information, wherein the prompt module comprises at least one of a display module, a lighting module and/or an audio module; and
controlling the drying module to stop running.

3-5. (canceled)

6. The device according to claim 1, wherein the humidity detection mechanism comprises:
a first elastic component with one end fixed in the device body; wherein the first elastic component is able to expand and contract according to different surface heights of the object to be cleaned;
a hollow structure provided in the device body, with a first end connected to the other end of the first elastic component and a second end in contact with the object to be cleaned; wherein the second end of the hollow structure extends out of a contact surface between the device body and the object to be cleaned and is provided with a first opening; and
a humidity sensor fixed in the hollow structure and connected to the control module, wherein the humidity sensor is used to detect water vapor entering the hollow structure through the first opening, to obtain the humidity of the object to be cleaned;
wherein the humidity detection mechanism further comprises a ball fixed on the second end of the hollow structure to be in contact with the object to be cleaned.

7-9. (canceled)

10. The device according to claim 1, wherein the humidity detection mechanism comprises:
at least one resistor and at least one electrode piece; wherein the at least one resistor and the at least one electrode piece are alternately connected in series, and the at least one electrode piece is in contact with the object to be cleaned; and
a detection circuit connected in series with the at least one resistor and the at least one electrode piece and connected with the control module, to detect an output voltage of the at least one resistor and determine the humidity of the object to be cleaned according to the output voltage;
wherein the humidity detection mechanism further comprises:
a second elastic component with one end fixed in the device body; wherein the second elastic component is able to expand and contract according to different surface heights of the object to be cleaned; and
an insulating structure provided in the device body and connected to the other end of the second elastic component; wherein the at least one resistor and at least one electrode piece are fixed on the insulating structure.

11. (canceled)

12. The device according to claim 1, wherein the humidity detection mechanism is further to detect temperature;
wherein the control module performing corresponding control processing according to the humidity data detected and obtained by the humidity detection mechanism comprises: based on the humidity data and temperature data detected and obtained by the humidity detection mechanism determining a dryness degree of the object to be cleaned.

13. (canceled)

14. The device according to claim 2, further comprising:
a temperature detection module, provided in the device body at a position between the drying module and the air outlet, and connected to the control module to detect the drying temperature of the air outlet; wherein,
the control module is further to control to increase a working voltage of the drying module if the drying temperature does not reach a preset temperature;
control to maintain the working voltage of the drying module, if the drying temperature reaches the preset temperature; and
control to decrease the working voltage of the drying module, if the drying temperature exceeds the preset temperature.

15-42. (canceled)

43. The device according to claim 1, wherein:
a body;
an air duct, provided in the body and comprising an air duct suction port and an air duct discharge port;
a detection apparatus, comprising a housing and a detection component located in a housing inner cavity; wherein the housing has an air outlet and an air inlet facing a surface to be worked; and the air outlet of the housing is communicated with the air duct;
the air duct is configured as forming a negative pressure in the housing inner cavity, so that the air inlet of the housing sucks an airflow in an area of the surface to be worked;
the detection component is configured as detecting a parameter of the airflow in the housing inner cavity.

44. The device according to claim 43, wherein the housing partially protrudes from the body and extends in a direction towards the surface to be worked; the housing is integrally movably connected to the body, and is configured as moving into the body when encountering resistance;
wherein the housing is configured as moving in a vertical direction relative to the body through a guiding mechanism, and the cleaning device further comprises a first elastic apparatus prepressing between the housing and the body, the housing has a tendency of moving outward the body under an acting of the first elastic apparatus.

45. The device according to claim 44, wherein the detection apparatus comprises a filter cover provided in the housing inner cavity, and the detection component is located in the filter cover; an aperture on the filter cover is configured as a waterproof and breathable type.

46. The device according to claim 44, wherein the housing comprises a lower housing with an open end, and an upper housing located at position of the open end of the lower housing, the upper housing is configured as covering the open end of the lower housing; a gap is provided between an outer wall of filter cover and an inner wall of the lower housing;
wherein the lower housing is configured as moving in the direction towards the upper housing when subjected to a first external force, and/or is configured as rotating relative to the filter cover when subjected to a second external force.

47. The device according to claim 46, wherein the inner wall of the lower housing is provided with scraper strips distributed at intervals; the scraper strips are configured as scraping off a foreign matter on the filter cover during movement.

48. The device according to claim 46, wherein a side wall of the body is provided with a through hole for the lower housing to pass through, an inner wall of the through hole is provided with a step groove, an outer wall of the lower housing is provided with a flange extending radially outward and being supported on the step groove; the upper housing covers a position of the through hole and is configured as having a gap between an end surface of the lower housing being supported on the step groove by the flange.

49. The device according to claim 46, wherein the first external force and the second external force are at least a resistance encountered by the housing when the cleaning device moves; or
an electric actuating apparatus is provided on the upper housing and the lower housing, and the first external force is provided by the electric actuating apparatus.

50. The device according to claim 46, wherein the upper housing and the lower housing are connected together by a thread, and are configured as making the upper housing and the lower housing move relatively by rotating.

51. The device according to claim 46, wherein the filter cover is connected to the upper housing, and the open end of the filter cover is communicated with the air outlet located on the upper housing; and the air inlet is provided at a bottom of the lower housing.

52. The device according to claim 51, wherein the air inlet is a grid, and the grid protrudes from the inner wall of the lower housing.

53. The device according to claim 2, further comprising a motor generating suction and a heating element; wherein,
when the device is in a drying mode, detecting whether the device is in a motion state;
if the device is in the motion state, obtaining the humidity detected and obtained by the humidity sensor;
adjusting a power of the heating element and a power of the motor according to the humidity.

54. The device according to claim 53, the power of the heating element and the power of the motor in the device change in a positive correlation under an influence of the humidity;
adjusting the power of the heating element and the power of the motor according to the humidity comprises:
if the humidity increases, determining a first power of the heating element in the device corresponding to the humidity, increasing the power of the heating element in the device to the first power; determining a second power of the motor in the device corresponding to the humidity, increasing the power of the motor in the device to the second power;
if the humidity decreases, determining a third power of the heating element in the device corresponding to the humidity, and reducing the power of the heating element in the device to the third power;
determining a fourth power of the motor in the device corresponding to the humidity, and reducing the power of the motor in the device to the fourth power.

55. The device according to claim 54, increasing the power of the heating element in the device to the first power comprises:
obtaining a heating upper limit temperature and a current temperature of the air outlet of the heating element in the cleaning machine, and determining whether the current temperature is less than the heating upper limit temperature;
if the current temperature is less than the heating upper limit temperature, increasing the power of the heating element in the cleaning machine to the first power;
wherein, during the process of increasing the power of the heating element in the cleaning machine, if the temperature of the air outlet of the heating element in the device is equal to the heating upper limit temperature, stop the increase.

56. The device according to claim 53, wherein,
if the device is in a stationary state, reducing the power of the heating element in the device to reduce the temperature of the air outlet of the heating element;
determining a target power corresponding to the motor in the cleaning machine, and controlling the motor in the device to run at the target power to increase the wind speed of the air blowing port;
counting a dwell time of the device in the stationary state, and determining whether the dwell time exceeds a preset duration threshold;
if the dwell time exceeds the preset time threshold, turning off the heating element in the device and reducing the target power of the motor.
